(19) United States
(12) Patent Application Publication
(10) Pub. No.: US 2017/0093910 A1
(43) Pub. Date: Mar. 30, 2017

(54) DYNAMIC SECURITY MECHANISMS

(71) Applicant: Acalvio Technologies, Inc., Cupertino, CA (US)

(72) Inventors: Sreenivas Gukal, Santa Clara, CA (US); Rammohan Varadarajan, Cupertino, CA (US)

(73) Assignee: Acalvio Technologies, Inc., Cupertino, CA (US)

(21) Appl. No.: 15/274,600

(22) Filed: Sep. 23, 2016

Related U.S. Application Data
(60) Provisional application No. 62/233,189, filed on Sep. 25, 2015.
(60) Provisional application No. 62/258,332, filed on Nov. 20, 2015.
(60) Provisional application No. 62/286,564, filed on Jan. 25, 2016.

(51) Int. Cl. H04L 29/06

(52) U.S. Cl. CPC H04L 63/1491; H04L 63/1425

(57) ABSTRACT

Provided are systems, methods, and computer-program products for a network device configured to dynamically deploy deception mechanisms to detect threats to a network. In various implementations, the network device can be configured to collect network data from a network, and determine a selection of deceptions mechanisms. The deception mechanisms can represent resources available on the network, and are separate from normal operation of the network. The network device can further determine locations within the network to deploy the deception mechanisms. The network device can further identifying a potential threat to the network. The potential threat may be identified by a deception mechanism. The network device can further determine additional deception mechanisms, and use the additional deception mechanisms to facilitate an action on the network.

### CROSS REFERENCES TO RELATED APPLICATIONS

This application claims the benefit under 35 U.S.C. §119 of U.S. Provisional Application No. 62/233,189, filed on Sep. 25, 2015; U.S. Provisional Application No. 62/258,332, filed on Nov. 20, 2015; and U.S. Provisional Application No. 62/286,564, filed on Jan. 25, 2016, each of which are incorporated herein by reference in its entirety.

### BRIEF SUMMARY

Provided are methods, including computer-implemented methods or methods implemented by a network device, devices including network devices, and computer-program products for a dynamic network threat detection system. In various implementations, a dynamic network threat detection system using deception-based security mechanisms in an intelligent and targeted fashion. The deception-based security mechanisms can serve as attractive targets to network threats, distracting and diverting threats from the actual, production assets of a network. The deception-based security mechanisms can also be used to track and analyze threats, to build a greater understanding of the operation of a threat and the vulnerabilities of a network.

In various implementations, a network security device can implement a dynamic network threat detection system. The network security device can be configured to collect network data from a network being defended by the network security device. The network security device can further be configured to determine a selection of one or more deception mechanisms using the network data. A deception mechanism can represent a resource available on the network. A deception mechanism is normally separate from normal operation of the network. The network device can further be configured to determine, using the network data, one or more locations to deploy the one or more deception mechanisms. The locations include locations within the network. The network device can further be configured to identify a potential threat to the network. The potential threat can be identified using a deception mechanism from the one or more deception mechanisms. The network device can further be configured to determine an additional deception mechanism using information provided by the deception mechanism. The network device can further be configured to use the additional deception mechanism to facilitate an action on the network.

In some implementations, network data from the network can include information about network devices in the network. This information can include an amount network devices, types of network devices, identification information for a network device, a hardware configuration for a network device, or a software configuration for a network device. In some implementations, network data can include information about data included in the network. This information can include a type of the data, a location in the network of the data, an access privilege of the data, or a value of the data. In some implementations, network data can include information about a structure of the network. The structure of the network can include one or more of a location of network infrastructure devices, a configuration of one or more subnets, or a configuration of one or more virtual local area networks. In some implementations, network data can include information about network traffic in the network. In some implementations, network data can include network security information. The network security information can include a current security state of the network.

In some implementations, to identify a potential threat, the network device can determine that a deception mechanism has been accessed. In some implementations, the network device can identify a potential threat by comparing data received from the one or more deception mechanisms to a known network threat. In some implementations, identifying the potential threat can include using additional network data received from the network. The additional network data can include a path through the network of the potential threat, an identifier associated with the potential threat, or a description of the network behavior of the potential threat.

In some implementations the information provided by the deception mechanism includes an identity or a type of the deception mechanism.

In some implementations, the network device can determining an additional security deception mechanism using additional network data received from the network. The additional network data can include a path through the network of the potential threat, an identifier associated with the potential threat, or a description of the network behavior of the potential threat.

In some implementations, the network device can further be configured to determine that the potential threat is an actual threat. In these implementations, the network device can take a corrective action against the actual threat.

In some implementations, the action that is facilitated by an additional deception mechanism can include analyzing a potential threat. Analyzing the potential threat can include allowing the potential threat to proceed. In some implementations, the action can include building a profile of the potential threat. In some implementations, the action can include determining a new deception mechanism using information provided by the additional deception mechanism.

### BRIEF DESCRIPTION OF THE DRAWINGS

Illustrative embodiments are described in detail below with reference to the following figures:

FIG. 1 illustrates an example of a network threat detection and analysis system, in which various implementations of a targeted threat intelligence engine can be used;

FIGS. 2A-2C provide examples of different installation configurations that can be used for different customer networks;

FIG. 3A-3B illustrate examples of customer networks where some of the customer networks' network infrastructure is “in the cloud,” that is, is provided by a cloud services provider;

FIG. 4 illustrates an example of an enterprise network;

FIG. 5 illustrates a general example of an IoT network;

FIG. 6 illustrates an example of a customer network that is a small network, here implemented in a private home;

FIG. 7 illustrates another example of a small network, here implemented in a small business;

FIG. 8 illustrates an example of the basic operation of an industrial control system;

FIG. 9 illustrates an example of a SCADA system, here used for distributed monitoring and control;

FIG. 10 illustrates an example of a distributed control;

FIG. 11 illustrates an example of a PLC implemented in a manufacturing control process

FIG. 12 illustrates an example of a deception center;

FIG. 13 illustrates an example of a network emulator;

FIG. 14 illustrates an example of a deception profiler;

FIG. 15 illustrates an example of a network threat detection system;

FIG. 16 illustrates an example of a process that may be implemented by an attack pattern detector to identify a pattern of behavior as a possible threat;

FIG. 17A-17B illustrate an example of two stages of a process for confirming that the pattern of behavior is an actual threat;

FIG. 18 illustrates examples of the data that may be collected over the course of an incident from processes and monitoring tools analyzing suspect network traffic in a emulated network;

FIG. 19 illustrates an example of the operations of an analytic engine;

FIG. 20 illustrates an example of a network protocol analysis engine;

FIG. 21 illustrates an example of a web-based network protocol analysis engine;

FIG. 22 illustrates an example of a file activity analysis engine;

FIG. 23 illustrates an example of a log file analysis engine;

FIG. 24 illustrates an example of the order or sequence in which analysis engines can be run, as well as a correlation engine for correlating the results from the various analysis engines;

FIG. 25 is an example of an illustration of an adjacency data structure;

FIG. 26A is an example illustrating an attack trajectory data structure for a network;

FIG. 26B is an example illustrating an attack trajectory path that is highlighted in the attack trajectory data structure of FIG. 26A;

FIG. 27 is an example illustrating an attack trajectory path using username to determine a path of an adversary in a network;

FIG. 28 is another example of illustrating an attack trajectory path for a network;

FIG. 29 illustrates an example of a system or identifying similar machines;

FIG. 30 illustrates an example of a machine in a system for identifying similar machines;

FIG. 31 illustrates an example of a similarity engine in a system for identifying a similar item;

FIG. 32 illustrates an example implementation of a sensor implemented in a combination of hardware and software;

FIG. 33 illustrates an example implementation of a deception;

FIGS. 34A-34B illustrate examples of network threat detection systems that use static and/or dynamic security mechanisms to locate, identify, and confirm a threat to a network;

FIG. 35 illustrates an example of a process for confirming a network abnormality as an actual threat;

FIG. 36 illustrates examples of security mechanisms that may be deployed into a network to entrap a potential threat;

FIG. 37 illustrates examples of various data sources that may provide data that is collected by a dynamic threat detection system;

FIG. 38 illustrates an example of an attack pattern generator that uses data science techniques to analyze network data and determine suspected attack patterns from the network data; and

FIG. 39 illustrates an example of a deployment generator that uses data science techniques to determine a selection of security mechanisms to deploy, and placement of the security mechanisms in a network.

### DETAILED DESCRIPTION

Network deception mechanisms, often referred to as “honeypots,” “honey tokens,” and “honey nets,” among others, defend a network from threats by distracting or diverting the threat. Honeypot-type deception mechanisms can be installed in a network for a particular site, such as a business office, to act as decoys in the site's network. Honeypot-type deception mechanisms are typically configured to be indistinguishable from active, production systems in the network. Additionally, such deception mechanisms are typically configured to be attractive to a network threat by having seemingly valuable data and/or by appearing vulnerable to infiltration. Though these deception mechanisms can be indistinguishable from legitimate parts of the site network, deception mechanisms are not part of the normal operation of the network, and would not be accessed during normal, legitimate use of the site network. Because normal users of the site network would not normally use or access a deception mechanism, any use or access to the deception mechanism is suspected to be a threat to the network.

“Normal” operation of a network generally includes network activity that conforms with the intended purpose of a network. For example, normal or legitimate network activity can include the operation of a business, medical facility, government office, education institution, or the ordinary network activity of a private home. Normal network activity can also include the non-business-related, casual activity of users of a network, such as accessing personal email and visiting websites on personal time, or using network resources for personal use. Normal activity can also include the operations of network security devices, such as firewalls, anti-virus tools, intrusion detection systems, intrusion protection systems, email filters, adware blockers, and so on. Normal operations, however, exclude deceptions mechanisms, in that deception mechanisms are not intended to take part in business operations or casual use. As such, network users and network systems do not normally access deceptions mechanisms except perhaps for the most routine network administrative tasks. Access to a deception mechanism, other than entirely routine network administration, may thus indicate a threat to the network.

Threats to a network can include active attacks, where an attacker interacts or engages with systems in the network to steal information or do harm to the network. An attacker may be a person, or may be an automated system. Examples of active attacks include denial of service (DoS) attacks, distributed denial of service (DDoS) attacks, spoofing attacks, “man-in-the-middle” attacks, attacks involving malformed network requests (e.g. Address Resolution Protocol (ARP) poisoning, “ping of death,” etc.), buffer, heap, or stack overflow attacks, and format string attacks, among others. Threats to a network can also include self-driven, self-replicating, and/or self-triggering malicious software. Malicious software can appear innocuous until activated, upon which the malicious software may attempt to steal information from a network and/or do harm to the network. Malicious software is typically designed to spread itself to other systems in a network.

In current implementations, deception-based security mechanisms are generally statically configured or are configured to behave within pre-determined parameters. This means that the appearance and behavior, from the point of view of an entity on the network, may be predictable. Additionally, the location of the deception mechanisms may be fixed or within pre-determined parameters. The deception mechanisms may be changed manually by a human system administrator, or automatically by fixed rules.

Predictable behavior and static locations, however, can make deception-based security mechanism easy to identify. Using various network analysis tools, an intruder on a network can profile a network system that appears to be a deception system, and from the profile determine that the network system is not a normally used, production system. Additionally, the network intruder can establish the location of the deception mechanism from, for example, an Internet Protocol (IP) or Media Access Control (MAC) address. Having identified a deception mechanism, the intruder can simply avoid the system. In some cases, the intruder may even make the location of the deception mechanism public, so that other threats to the network can avoid the deception mechanism.

A more effective network threat detection system may, rather than using static deception mechanisms, use deception mechanisms in a targeted and dynamic fashion, or use a combination of static and dynamic deception mechanisms. Deception mechanisms may initially be deployed based on network data or in response to alerts raised in response to activity in the network. The deception mechanism may be configured to look attractive to an attack, for example by having seemingly valuable data and/or having security flaws that may make it easy to infiltrate the deception mechanism. The deception mechanisms may further be strategically deployed into parts of the network that have legitimately valuable hardware or data resources.

The network threat detection system subsequently receive network data that reflects activity within the network. Some of that network activity will be normal legitimate network activity, some will be activity that appears legitimate but that may not be, and some of the network activity may involve interactions with deception mechanisms. From this information, the network threat detection system may identify a potential threat to the network. In various implementations, the network threat detection system may then deploy additional deception mechanisms, or modify existing deception mechanisms, to attempt attract and/or identify the potential threat. In various implementations, the network threat detection system may further analyze the potential threat by allowing network activity related to the potential threat to continue to affect the deception mechanisms, while isolating the network activity from the rest of the network.

Through deploying additional deception mechanisms and/or modifying existing deception mechanisms, the network threat detection system may be able to confirm a potential threat as an actual threat. The network threat detection system may further be able to identify and/or profile the threat. This information can be used to improve the overall security of the network, and further can be shared with the greater network security community to improve network security around the world.

In various implementations, a network threat detection system can use data science techniques to analyze network data, and from the analysis adjust the deployment of deception mechanisms in a network. For example, the network threat detection system can use clustering to identify network devices that have similar features. A threat that has affected a deception mechanism having a particular set of features may affect network devices that have similar features, and clustering can identify potentially affected network devices. The network threat detection system can then generate deception mechanism with similar features to attempt to attract the attention of the potential threat. Alternatively or additionally, the network threat detection system can check production network devices with similar features to see if the production network devices have been affected by the threat.

As another example, the network threat detection system can use statistical analysis to generate an attack signature. Statistical analysis can be used to determine a probability that activity found in network data is related to a known attack pattern. By comparing a digital signature for particular network data to digital signatures for known attack patterns, the network threat detection system can determine a probability that the particular network data shows evidence of a known attack. A likely (or unlikely) match with a known attack pattern can be used to generate an attack signature for a pattern of network behavior, which can be used to identify similar network behavior in the future.

As another example, the network threat detection system can use a scoring model to determine a priority for a potential threat. A scoring model can be used to assign values to certain physical parts of the network and/or data on the network. The network threat detection system can use the scoring model to determine a probability that the threat is affecting a particular part of the network. The network threat detection system can further configure deception mechanisms that resemble the particular part of the network, to attempt to attract the threat. Alternatively or additionally, the particular part of the network can be inspected to see if the threat has affected that part of the network.

As another example, the network threat detection system can use predictive analysis to determine probable future network behavior. Predictive analysis can use known attack patterns to determine future network behavior that may occur should current network activity progress. This information can be used by the network threat detection system to place deception mechanisms in the probable path of an attack or threat, and thereby divert and/or identify the attack.

As another example, the network threat detection system can relate an attack pattern, identified from a pattern of network behavior, to known attack patterns. The network threat detection system can then assign a correlation coefficient that can reflect the correlation between the attack pattern and the known attack pattern. The network threat detection system can further use the correlation coefficient to identify parts of the network that are likely to be affected by the potential threat. The network threat detection system can further deploy deception mechanisms that resemble these parts of the network, in order to attract or divert the threat from the actual network. Alternatively or additionally, the parts of the network that are likely to be affected by the potential threat can be inspected to see if the network has, in fact, been affected.

Using these and other data science techniques, a network threat detection system dynamically deploy and redeploy deception mechanism to identify and thwart threats to a network. The deception mechanisms can further be used to analyze a threat. The resulting analysis data can be used to generate indicators, which can be used to improve the security of the network.

I. Network Threat Detection and Analysis System

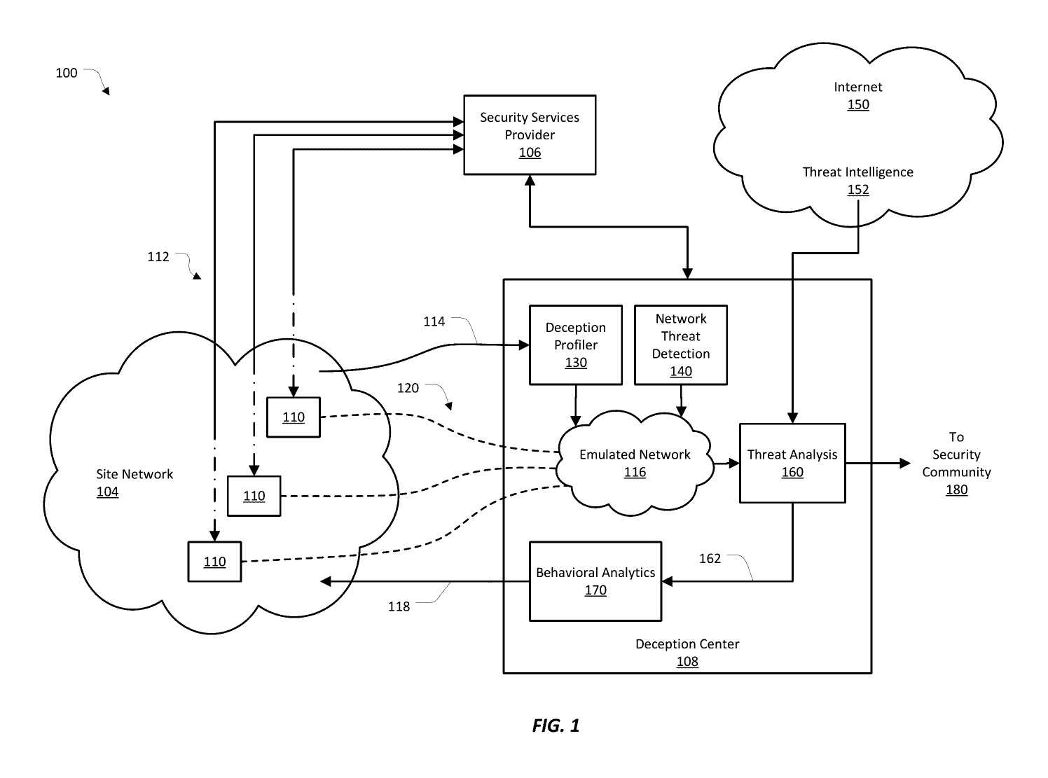

FIG. 1 illustrates an example of a network threat detection and analysis system 100, in which various implementations of a dynamic network threat detection system can be used. The network threat detection and analysis system 100, or, more briefly, network security system 100, provides security for a site network 104 using deceptive security mechanisms, a variety of which may be called “honeypots.” The deceptive security mechanisms may be controlled by and inserted into the site network 104 using a deception center 108 and sensors 110 installed in the site network 104. In some implementations, the deception center 108 and the sensors 110 interact with a security services provider 106 located outside of the site network 104. The deception center 108 may also obtain or exchange data with sources located on the Internet 150.

Security mechanisms designed to deceive, sometimes referred to as “honeypots,” may also be used as traps to divert and/or deflect unauthorized use of a network away from the real network assets. A deception-based security mechanism may be a computer attached to the network, a process running on one or more network systems, and/or some other device connected to the network. A security mechanism may be configured to offer services, real or emulated, to serve as bait for an attack on the network. Deception-based security mechanisms that take the form of data, which may be called “honey tokens,” may be mixed in with real data in devices in the network. Alternatively or additionally, emulated data may also be provided by emulated systems or services.

Deceptive security mechanisms can also be used to detect an attack on the network. Deceptive security mechanisms are generally configured to appear as if they are legitimate parts of a network. These security mechanisms, however, are not, in fact, part of the normal operation of the network. Consequently, normal activity on the network is not likely to access the security mechanisms. Thus any access over the network to the security mechanism is automatically suspect.

The network security system 100 may deploy deceptive security mechanisms in a targeted and dynamic fashion. Using the deception center 108 the system 100 can scan the site network 104 and determine the topology of the site network 104. The deception center 108 may then determine devices to emulate with security mechanisms, including the type and behavior of the device. The security mechanisms may be selected and configured specifically to attract the attention of network attackers. The security mechanisms may also be selected and deployed based on suspicious activity in the network. Security mechanisms may be deployed, removed, modified, or replaced in response to activity in the network, to divert and isolate network activity related to an apparent attack, and to confirm that the network activity is, in fact, part of a real attack.

The site network 104 is a network that may be installed among the buildings of a large business, in the office of a small business, at a school campus, at a hospital, at a government facility, or in a private home. The site network 104 may be described as a local area network (LAN) or a group of LANS. The site network 104 may be one site belonging to an organization that has multiple site networks 104 in one or many geographical locations. In some implementations, the deception center 108 may provide network security to one site network 104, or to multiple site networks 104 belonging to the same entity.

The site network 104 is where the networking devices and users of the an organizations network may be found. The site network 104 may include network infrastructure devices, such as routers, switches hubs, repeaters, wireless base stations, and/or network controllers, among others. The site network 104 may also include computing systems, such as servers, desktop computers, laptop computers, tablet computers, personal digital assistants, and smart phones, among others. The site network 104 may also include other analog and digital electronics that have network interfaces, such as televisions, entertainment systems, thermostats, refrigerators, and so on.

The deception center 108 provides network security for the site network 104 (or multiple site networks for the same organization) by deploying security mechanisms into the site network 104, monitoring the site network 104 through the security mechanisms, detecting and redirecting apparent threats, and analyzing network activity resulting from the apparent threat. To provide security for the site network 104, in various implementations the deception center 108 may communicate with sensors 110 installed in the site network 104, using network tunnels 120. As described further below, the tunnels 120 may allow the deception center 108 to be located in a different sub-network (“subnet”) than the site network 104, on a different network, or remote from the site network 104, with intermediate networks (possibly including the Internet 150) between the deception center 108 and the site network 104.

In some implementations, the network security system 100 includes a security services provider 106. In these implementations, the security services provider 106 may act as a central hub for providing security to multiple site networks, possibly including site networks controlled by different organizations. For example, the security services provider 106 may communicate with multiple deception centers 108 that each provide security for a different site network 104 for the same organization. In some implementations, the security services provider 106 is located outside the site network 104. In some implementations, the security services provider 106 is controlled by a different entity than the entity that controls the site network. For example, the security services provider 106 may be an outside vendor. In some implementations, the security services provider 106 is controlled by the same entity as that controls the site network 104.

In some implementations, when the network security system 100 includes a security services provider 106, the sensors 110 and the deception center 108 may communicate with the security services provider 106 in order to be connected to each other. For example, the sensors 110 may, upon powering on in the site network 104, send information over a network connection 112 to the security services provider 106, identifying themselves and the site network 104 in which they are located. The security services provider 106 may further identify a corresponding deception center 108 for the site network 104. The security services provider 106 may then provide the network location of the deception center 108 to the sensors 110, and may provide the deception center 108 with the network location of the sensors 110. A network location may take the form of, for example, an Internet Protocol (IP) address. With this information, the deception center 108 and the sensors 110 may be able to configure tunnels 120 to communicate with each other.

In some implementations, the network security system 100 does not include a security services provider 106. In these implementations, the sensors 110 and the deception center 108 may be configured to locate each other by, for example, sending packets that each can recognize as coming for the other. Using these packets, the sensors 110 and deception center 108 may be able to learn their respective locations on the network. Alternatively or additionally, a network administrator can configure the sensors 110 with the network location of the deception center 108, and vice versa.

In various implementations, the sensors 110 are a minimal combination of hardware and/or software, sufficient to form a network connection with the site network 104 and a tunnel 120 with the deception center 108. For example, a sensor 110 may be constructed using a low-power processor, a network interface, and a simple operating system. In various implementations, the sensors 110 provide the deception center 108 with visibility into the site network 104, such as for example being able to operate as a node in the site network 104, and/or being able to present or project deceptive security mechanisms into the site network 104, as described further below. Additionally, in various implementations, the sensors 110 may provide a portal through which a suspected attack on the site network 104 can be redirected to the deception center 104, as is also described below.

In various implementations, the deception center 108 may be configured to profile the site network 104, deploy deceptive security mechanisms for the site network 104, detect suspected threats to the site network 104, analyze the suspected threat, and analyze the site network 104 for exposure and/or vulnerability to the supposed threat.

To provide the site network 104, the deception center 104 may include a deception profiler 130. In various implementations, the deception profiler may 130 derive information 114 from the site network 104, and determine, for example, the topology of the site network 104, the network devices included in the site network 104, the software and/or hardware configuration of each network device, and/or how the network is used at any given time. Using this information, the deception profile 130 may determine one or more deceptive security mechanisms to deploy into the site network 104.

In various implementations, the deception profiler may configure an emulated network 116 to emulate one or more computing systems. Using the tunnels 120 and sensors 110, the emulated computing systems may be projected into the site network 104, where they serve as deceptions. The emulated computing systems may include address deceptions, low-interaction deceptions, and/or high-interaction deceptions. In some implementations, the emulated computing systems may be configured to resemble a portion of the network. In these implementations, this network portion may then be projected into the site network 104.

In various implementations, a network threat detection engine 140 may monitor activity in the emulated network 116, and look for attacks on the site network 104. For example, the network threat detection engine 140 may look for unexpected access to the emulated computing systems in the emulated network 116. The network threat detection engine 140 may also use information 114 extracted from the site network 104 to adjust the emulated network 116, in order to make the deceptions more attractive to an attack, and/or in response to network activity that appears to be an attack. Should the network threat detection engine 140 determine that an attack may be taking place, the network threat detection engine 140 may cause network activity related to the attack to be redirected to and contained within the emulated network 116.

In various implementations, the emulated network 116 is a self-contained, isolated, and closely monitored network, in which suspect network activity may be allowed to freely interact with emulated computing systems. In various implementations, questionable emails, files, and/or links may be released into the emulated network 116 to confirm that they are malicious, and/or to see what effect they have. Outside actors can also be allowed to access emulated system, steal data and user credentials, download malware, and conduct any other malicious activity. In this way, the emulated network 116 not only isolated a suspected attack from the site network 104, but can also be used to capture information about an attack. Any activity caused by suspect network activity may be captured in, for example, a history of sent and received network packets, log files, and memory snapshots.

In various implementations, activity captured in the emulated network 116 may be analyzed using a targeted threat analysis engine 160. The threat analysis engine 160 may examine data collected in the emulated network 116 and reconstruct the course of an attack. For example, the threat analysis engine 160 may correlate various events seen during the course of an apparent attack, including both malicious and innocuous events, and determine how an attacker infiltrated and caused harm in the emulated network 116. In some cases, the threat analysis engine 160 may use threat intelligence 152 from the Internet 150 to identify and/or analyze an attack contained in the emulated network 116. The threat analysis engine 160 may also confirm that suspect network activity was not an attack. The threat analysis engine 160 may produce indicators that describe the suspect network activity, including indicating whether the suspect activity was or was not an actual threat. The threat analysis engine 160 may share these indicators with the security community 180, so that other networks can be defended from the attack. The threat analysis engine 160 may also send the indicators to the security services provider 106, so that the security services provider 106 can use the indicators to defend other site networks.

In various implementations, the threat analysis engine 160 may also send threat indicators, or similar data, to a behavioral analytics engine 170. The behavioral analytics engine 170 may be configured to use the indicators to probe 118 the site network 104, and see whether the site network 104 has been exposed to the attack, or is vulnerable to the attack. For example, the behavioral analytics engine 170 may search the site network 104 for computing systems that resemble emulated computing systems in the emulated network 116 that were affected by the attack. In some implementations, the behavioral analytics engine 170 can also repair systems affected by the attack, or identify these systems to a network administrator. In some implementations, the behavioral analytics engine 170 can also reconfigure the site network's 104 security infrastructure to defend against the attack.

Using deceptive security mechanisms, the network security system 100 may thus be able to distract and divert attacks on the site network 104. The network security system 100 may also be able to allow, using the emulated network 116, and attack to proceed, so that as much can be learned about the attack as possible. Information about the attack can then be used to find vulnerabilities in the site network 104. Information about the attack can also be provided to the security community 180, so that the attack can be thwarted elsewhere.

II. Customer Installations

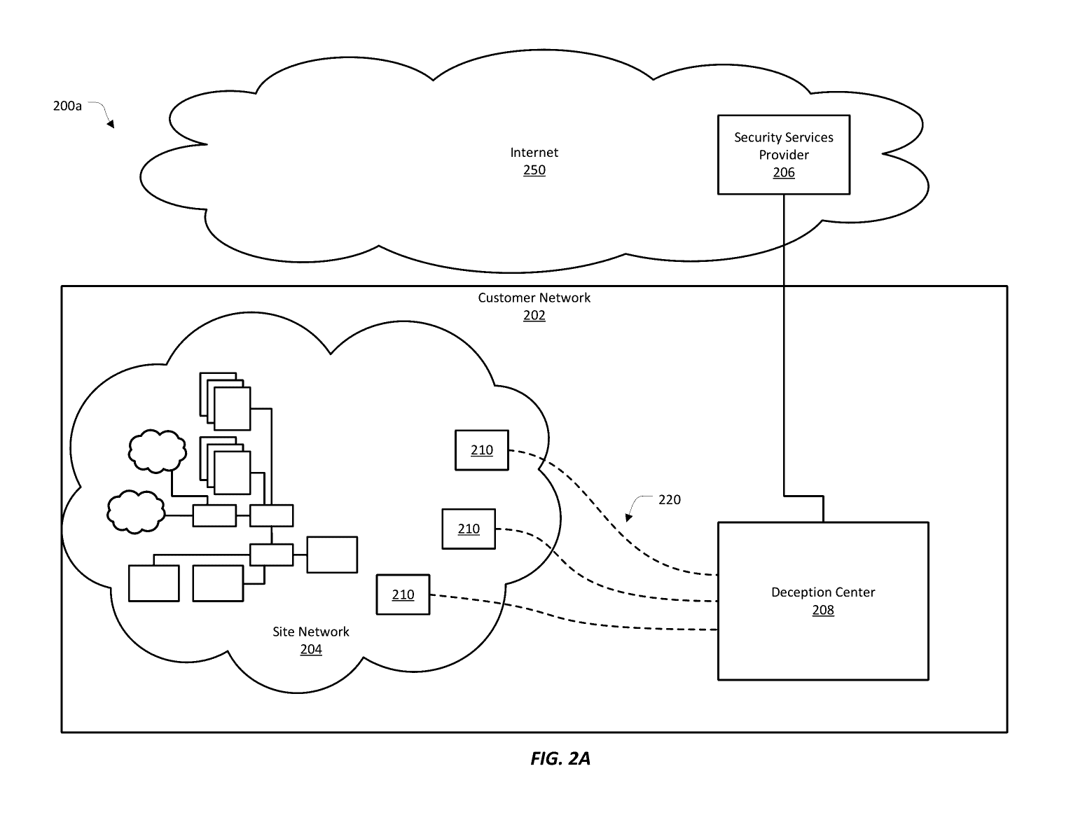

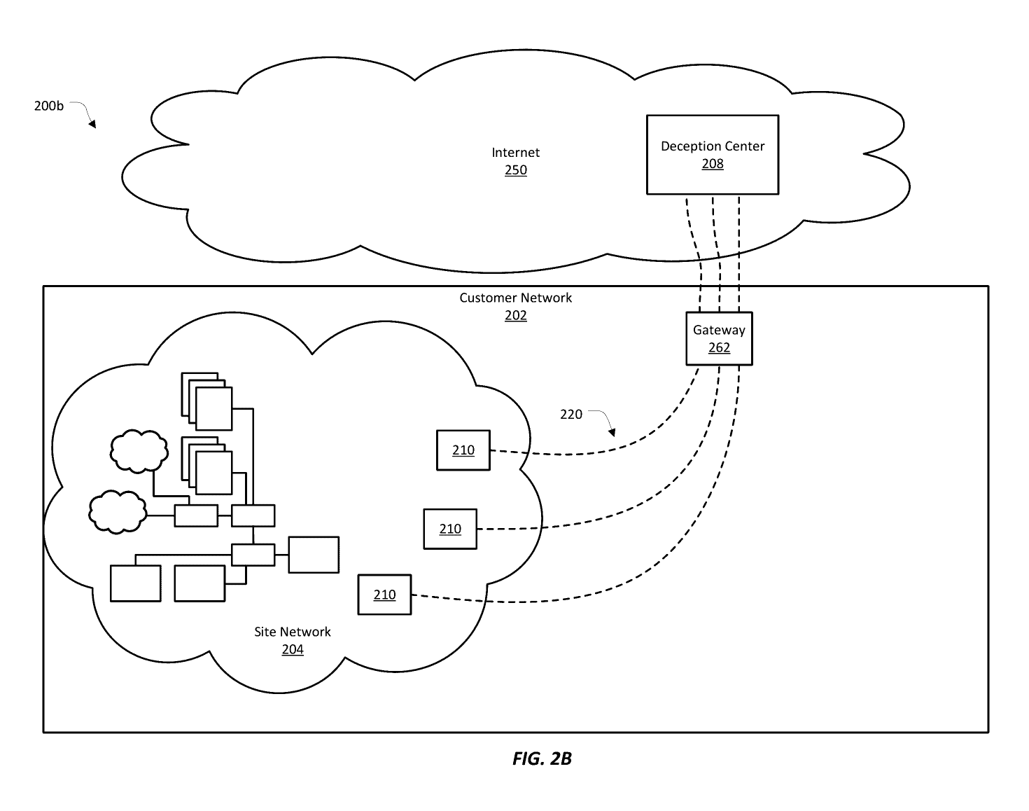

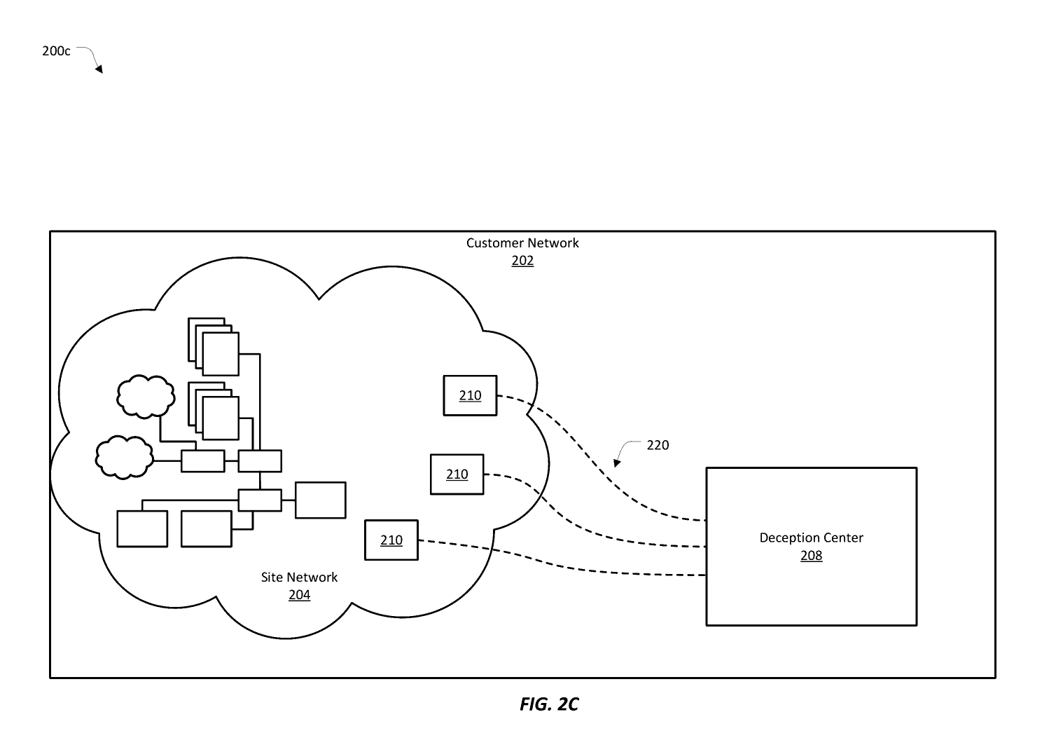

The network threat detection and analysis system described above may be flexibly implemented to accommodate different customer networks. FIGS. 2A-2C provide examples of different installation configurations 200a-200c that can be used for different customer networks 202. A customer network 202 may generally be described as a network or group of networks that is controlled by a common entity, such as a business, a school, or a person. The customer network 202 may include one or more site networks 204. The customer network's 202 site networks 204 may be located in one geographic location, may be behind a common firewall, and/or may be multiple subnets within one network. Alternatively or additionally, a customer network's 202 site networks 204 may be located in different geographic locations, and be connected to each other over various private and public networks, including the Internet 250.

Different customer networks 202 may have different requirements regarding network security. For example, some customer networks 202 may have relatively open connections to outside networks such as the Internet 250, while other customer networks 202 have very restricted access to outside networks. The network security system described in FIG. 1 may be configurable to accommodate these variations.

FIG. 2A illustrates one example of an installation configuration 200a, where a deception center 208 is located within the customer network 202. In this example, being located within the customer network 202 means that the deception center 208 is connected to the customer network 202, and is able to function as a node in the customer network 202. In this example, the deception center 208 may be located in the same building or within the same campus as the site network 204. Alternatively or additionally, the deception center 208 may be located within the customer network 202 but at a different geographic location than the site network 204. The deception center 208 thus may be within the same subnet as the site network 204, or may be connected to a different subnet within the customer network.

In various implementations, the deception center 208 communicates with sensors 210 installed in the site network over network tunnels 220 In this example, the network tunnels 220 may cross one or more intermediate within the customer network 202.

In this example, the deception center 208 is able to communicate with a security services provider 206 that is located outside the customer network 202, such as on the Internet 250. The security services provider 206 may provide configuration and other information for the deception center 208. In some cases, the security services provider 206 may also assist in coordinating the security for the customer network 202 when the customer network 202 includes multiple site networks 204 located in various geographic areas.

FIG. 2B illustrates another example of an installation configuration 200b, where the deception center 208 is located outside the customer network 202. In this example, the deception center 208 may connected to the customer network 202 over the Internet 250. In some implementations, the deception center 208 may be co-located with a security services provider, and/or may be provided by the security services provider.

In this example, the tunnels 220 connect the deception center 208 to the sensors 210 through a gateway 262. A gateway is a point in a network that connects the network to another network. For example, in this example, the gateway 262 connects the customer network 202 to outside networks, such as the Internet 250. The gateway 262 may provide a firewall, which may provide some security for the customer network 202. The tunnels 220 may be able to pass through the firewall using a secure protocol, such as Secure Socket Shell (SSH) and similar protocols. Secure protocols typically require credentials, which may be provided by the operator of the customer network 202.

FIG. 2C illustrates another example of an installation configuration 200c, where the deception center 208 is located inside the customer network 202 but does not have access to outside networks. In some implementations, the customer network 202 may require a high level of network security. In these implementations, the customer network's 202 connections to the other networks may be very restricted. Thus, in this example, the deception center 208 is located within the customer network 202, and does not need to communicate with outside networks. The deception center 208 may use the customer networks 202 internal network to coordinate with and establish tunnels 220 to the sensors 210. Alternatively or additionally, a network administrator may configure the deception center 208 and sensors 210 to enable them to establish the tunnels. 220.

III. Customer Networks

The network threat detection and analysis system can be used for variety of customer networks. As noted above, customer networks can come in wide variety of configurations. For example, a customer network may have some of its network infrastructure “in the cloud.” A customer network can also include a wide variety of devices, including what may be considered “traditional” network equipment, such as servers and routers, and non-traditional, “Internet-of-Things”devices, such as kitchen appliances. Other examples of customer networks include established industrial networks, or a mix of industrial networks and computer networks.

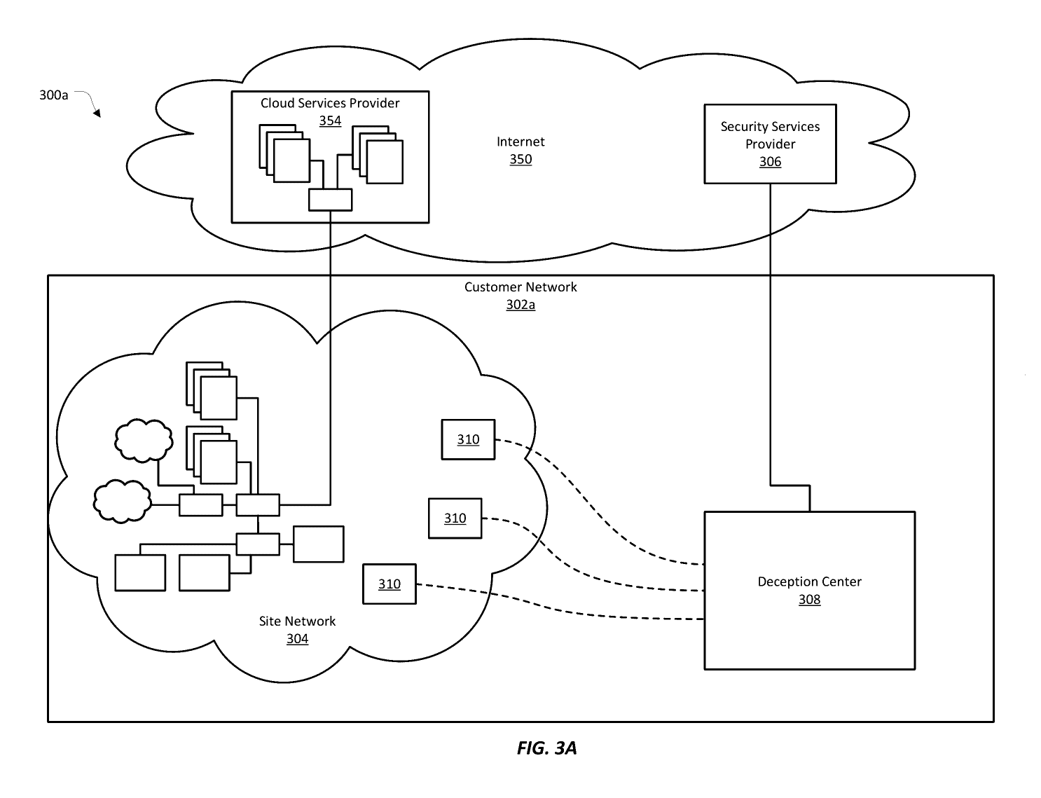

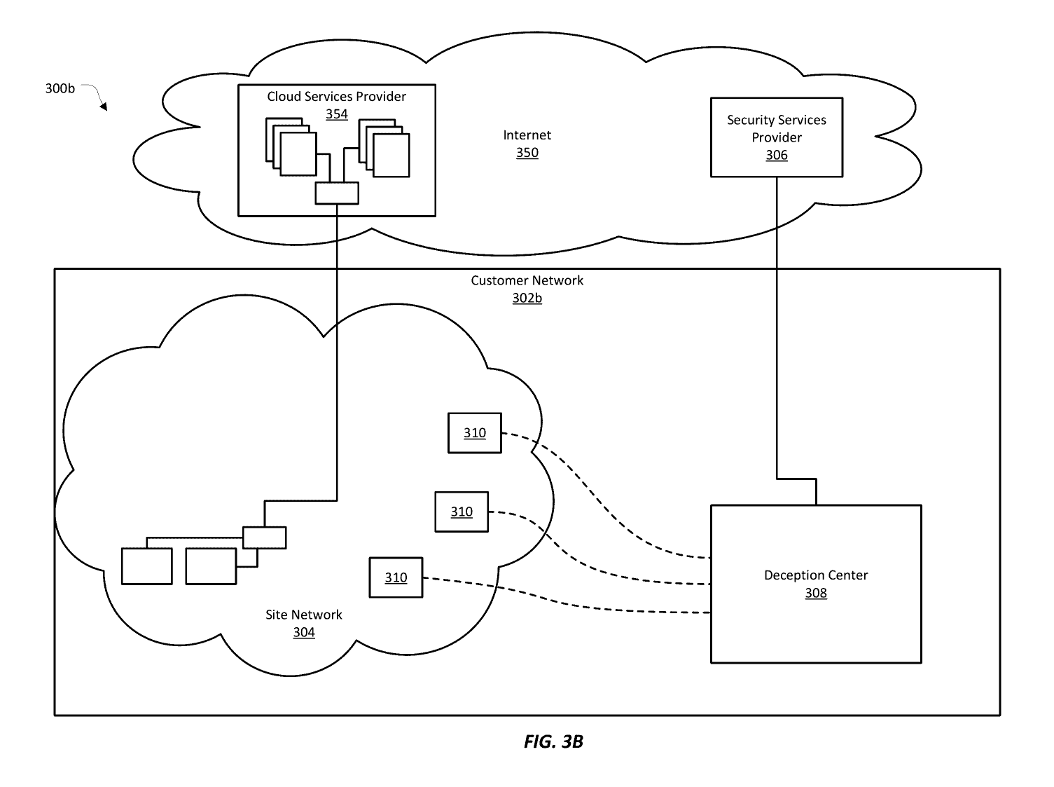

FIG. 3A-3B illustrate examples of customer networks 302a-302b where some of the customer networks' 302a-302b network infrastructure is “in the cloud,” that is, is provided by a cloud services provider 354. These example customer networks 302a-302b may be defended by a network security system that includes a deception center 308 and sensors 310, and may also include an off-site security services provider 306.

A cloud services provider is a company that offers some component of cloud computer—such as Infrastructure as a Service (IaaS), Software as a Service (SaaS) or Platform as Service (PaaS)—to other businesses and individuals. A cloud services provider may have a configurable pool of computing resources, including, for example, networks, servers, storage, applications, and services. These computing resources can be available on demand, and can be rapidly provisioned. While a cloud services provider's resources may be shared between the cloud service provider's customers, from the perspective of each customer, the individual customer may appear to have a private network within the cloud, including for example having dedicated subnets and IP addresses.

In the examples illustrated in FIGS. 3A-3B, the customer networks' 302a-302b network is partially in a site network 304, and partially provided by the cloud services provider 354. In some cases, the site network 304 is the part of the customer networks 302a-302b that is located at a physical site owned or controlled by the customer network 302a-302b. For example, the site network 304 may be a network located in the customer network's 302a-302b office or campus. Alternatively or additionally, the site network 304 may include network equipment owned and/or operated by the customer network 302 that may be located anywhere. For example, the customer networks' 302a-302b operations may consist of a few laptops owned by the customer networks 302a-302b, which are used from the private homes of the lap tops' users, from a co-working space, from a coffee shop, or from some other mobile location.

In various implementations, sensors 310 may be installed in the site network 304. The sensors 310 can be used by the network security system to project deceptions into the site network 304, monitor the site network 304 for attacks, and/or to divert suspect attacks into the deception center 308.

In some implementations, the sensors 310 may also be able to project deceptions into the part of the customer networks 302a-302b network that is provided by the cloud services provider 354. In most cases, it may not be possible to install sensors 310 inside the network of the cloud services provider 354, but in some implementations, this may not be necessary. For example, as discussed further below, the deception center 308 can acquire the subnet address of the network provided by the cloud services provider 354, and use that subnet address the create deceptions. Though these deceptions are projected form the sensors 310 installed in the site network 304, the deceptions may appear to be within the subnet provided by the cloud service provider 354.

In illustrated examples, the deception center 308 is installed inside the customer networks 302a-302b. Though not illustrated here, the deception center 308 can also be installed outside the customer networks 302a-302b, such as for example somewhere on the Internet 350. In some implementations, the deception center 308 may reside at the same location as the security service provider 306. When located outside the customer networks 302a-302b, the deception center 308 may connect to the sensors 310 in the site network 304 over various public and/or private networks.

FIG. 3A illustrates an example of a configuration 300a where the customer network's 302a network infrastructure is located in the cloud and the customer network 302a also has a substantial site network 304. In this example, the customer may have an office where the site network 304 is located, and where the customer's employees access and use the customer network 302a. For example, developers, sales and marketing personnel, human resources and finance employees, may access the customer network 302a from the site network 304. In the illustrated example, the customer may obtain applications and services from the cloud services provider 354. Alternatively or additionally, the cloud services provider 354 may provide data center services for the customer. For example, the cloud services provider 354 may host the customer's repository of data (e.g., music provided by a streaming music service, or video provided by a streaming video provider). In this example, the customer's own customers may be provided data directly from the cloud services provider 354, rather than from the customer network 302a.

FIG. 3B illustrates and example of a configuration 300b where the customer network's 302b network is primarily or sometimes entirely in the cloud. In this example, the customer network's 302b site network 304 may include a few laptops, or one or two desktop servers. These computing devices may be used by the customer's employees to conduct the customer's business, while the cloud service provider 354 provides the majority of the network infrastructure needed by the customer. For example, a very small company may have no office space and no dedicated location, and have as computing resources only the laptops used by its employees. This small company may use the cloud services provider 354 to provide its fixed network infrastructure. The small company may access this network infrastructure by connecting a laptop to any available network connection (e.g, in a co-working space, library, or coffee shop). When no laptops are connected to the cloud services provider 354, the customer network 302 may be existing entirely within the cloud.

In the example provided above, the site network 304 can be found wherever the customer's employees connect to a network and can access the cloud services provider 354. Similarly, the sensors 310 can be co-located with the employees' laptops. For example, whenever an employee connects to a network, she can enable a sensor 310, which can then project deceptions into the network around her. Alternatively or additionally, sensors 310 can be installed in a fixed location (such as the home of an employee of the customer) from which they can access the cloud services provider 354 and project deceptions into the network provided by the cloud services provider 354.

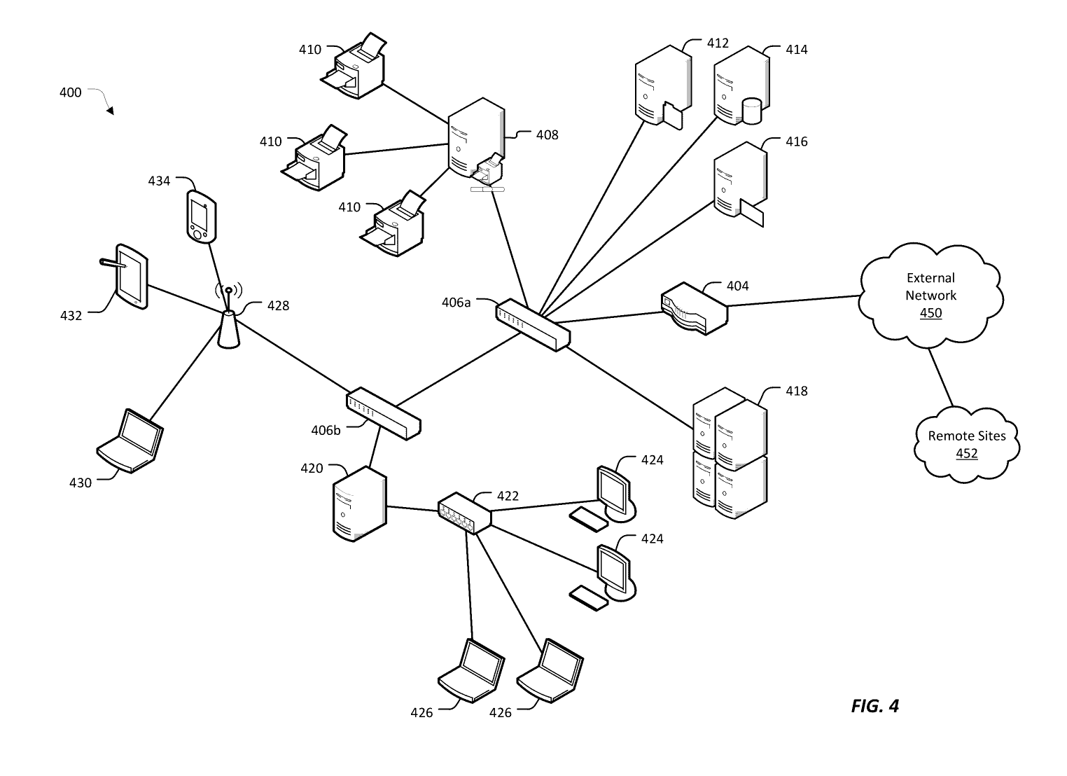

The network threat detection and analysis system can provide network security for a variety of customer networks, which may include a diverse array of devices. FIG. 4 illustrates an example of an enterprise network 400, which is one such network that can be defended by a network threat detection and analysis system. The example enterprise network 400 illustrates examples of various network devices and network clients that may be included in an enterprise network. The enterprise network 400 may include more or fewer network devices and/or network clients, and/or may include network devices, additional networks including remote sites 452, and/or systems not illustrated here. Enterprise networks may include networks installed at a large site, such as a corporate office, a university campus, a hospital, a government office, or a similar entity. An enterprise network may include multiple physical sites. Access to an enterprise networks is typically restricted, and may require authorized users to enter a password or otherwise authenticate before using the network. A network such as illustrated by the example enterprise network 400 may also be found at small sites, such as in a small business.

The enterprise network 400 may be connected to an external network 450. The external network 450 may be a public network, such as the Internet. A public network is a network that has been made accessible to any device that can connect to it. A public network may have unrestricted access, meaning that, for example, no password or other authentication is required to connect to it. The external network 450 may include third-party telecommunication lines, such as phone lines, broadcast coaxial cable, fiber optic cables, satellite communications, cellular communications, and the like. The external network 450 may include any number of intermediate network devices, such as switches, routers, gateways, servers, and/or controllers that are not directly part of the enterprise network 400 but that facilitate communication between the network 400 and other network-connected entities, such as a remote site 452.

Remote sites 452 are networks and/or individual computers that are generally located outside the enterprise network 400, and which may be connected to the enterprise 400 through intermediate networks, but that function as if within the enterprise network 400 and connected directly to it. For example, an employee may connect to the enterprise network 400 while at home, using various secure protocols, and/or by connecting to a Virtual Private Network (VPN) provided by the enterprise network 400. While the employee's computer is connected, the employee's home is a remote site 452. Alternatively or additionally, the enterprise network's 400 owner may have a satellite office with a small internal network. This satellite office's network may have a fixed connection to the enterprise network 400 over various intermediate networks. This satellite office can also be considered a remote site.

The enterprise network 400 may be connected to the external network 450 using a gateway device 404. The gateway device 404 may include a firewall or similar system for preventing unauthorized access while allowing authorized access to the enterprise network 400. Examples of gateway devices include routers, modems (e.g. cable, fiber optic, dial-up, etc.), and the like.

The gateway device 404 may be connected to a switch 406a. The switch 406a provides connectivity between various devices in the enterprise network 400. In this example, the switch 406a connects together the gateway device 404, various servers 408, 412, 414, 416, 418, an another switch 406b. A switch typically has multiple ports, and functions to direct packets received on one port to another port. In some implementations, the gateway device 404 and the switch 406a may be combined into a single device.

Various servers may be connected to the switch 406a. For example, a print server 408 may be connected to the switch 406a. The print server 408 may provide network access to a number of printers 410. Client devices connected to the enterprise network 400 may be able to access one of the printers 410 through the printer server 408.

Other examples of servers connected to the switch 406a include a file server 412, database server 414, and email server 416. The file server 412 may provide storage for and access to data. This data may be accessible to client devices connected to the enterprise network 400. The database server 414 may store one or more databases, and provide services for accessing the databases. The email server 416 may host an email program or service, and may also store email for users on the enterprise network 400.

As yet another example, a server rack 418 may be connected to the switch 406. The server rack 418 may house one or more rack-mounted servers. The server rack 418 may have one connection to the switch 406a, or may have multiple connections to the switch 406a. The servers in the server rack 418 may have various purposes, including providing computing resources, file storage, database storage and access, and email, among others.

An additional switch 406b may also be connected to the first switch 406a. The additional switch 406b may be provided to expand the capacity of the network. A switch typically has a limited number of ports (e.g., 8, 16, 32, 64 or more ports). In most cases, however, a switch can direct traffic to and from another switch, so that by connecting the additional switch 406b to the first switch 406a, the number of available ports can be expanded.

In this example, a server 420 is connected to the additional switch 406b. The server 420 may manage network access for a number of network devices or client devices. For example, the server 420 may provide network authentication, arbitration, prioritization, load balancing, and other management services as needed to manage multiple network devices accessing the enterprise network 400. The server 420 may be connected to a hub 422. The hub 422 may include multiple ports, each of which may provide a wired connection for a network or client device. A hub is typically a simpler device than a switch, and may be used when connecting a small number of network devices together. In some cases, a switch can be substituted for the hub 422. In this example, the hub 422 connects desktop computers 424 and laptop computers 426 to the enterprise network 400. In this example, each of the desktop computers 424 and laptop computers 426 are connected to the hub 422 using a physical cable.

In this example, the additional switch 406b is also connected to a wireless access point 428. The wireless access point 428 provides wireless access to the enterprise network 400 for wireless-enabled network or client devices. Examples of wireless-enabled network and client devices include laptops 430, tablet computers 432, and smart phones 434, among others. In some implementations, the wireless access point 428 may also provide switching and/or routing functionality.

FIG. 4 illustrates one example of what can be considered a “traditional” network, that is, a network that is based on the interconnection of computers. In various implementations, a network threat detection and analysis system can also be used to defend “non-traditional” networks that include devices other than traditional computers, such as for example mechanical, electrical, or electromechanical devices, sensors, actuators, and control systems. Such “non-traditional” networks may be referred to as the Internet of Things (IoT). The Internet of Things encompasses newly-developed, every-day devices designed to be networked (e.g., drones, self-driving automobiles, etc.) as well as common and long-established machinery that has augmented to be connected to a network (e.g., home appliances, traffic signals, etc.).

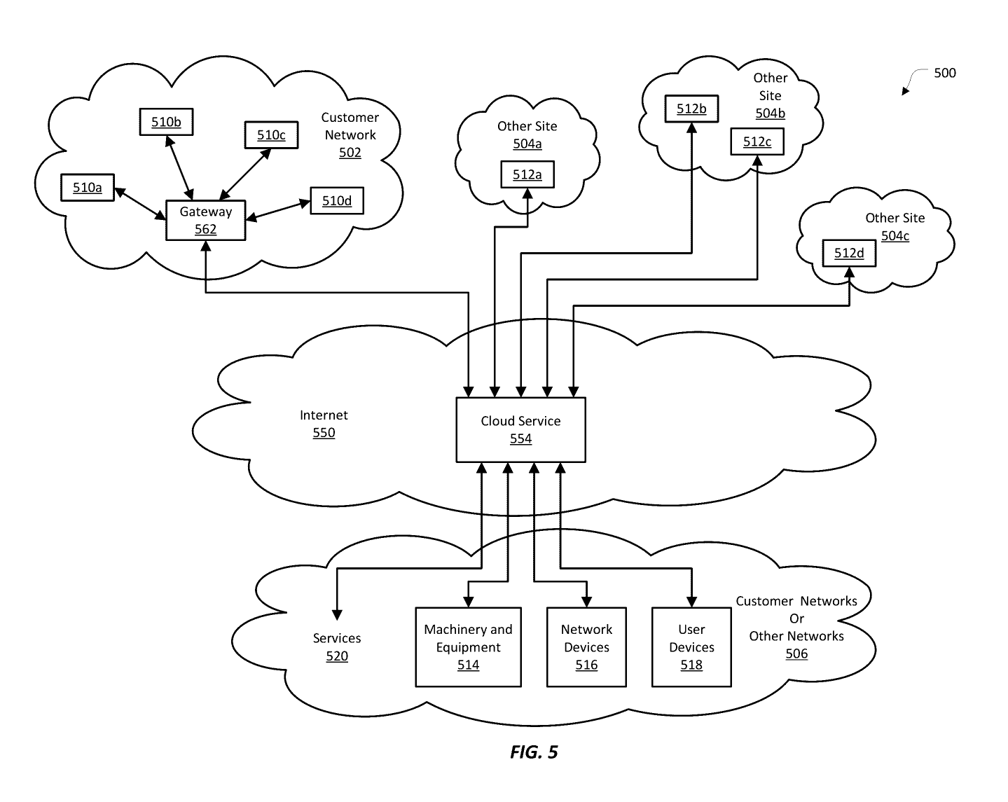

FIG. 5 illustrates a general example of an IoT network 500. The example IoT network 500 can be implemented wherever sensors, actuators, and control systems can be found. For example, the example IoT network 500 can be implemented for buildings, roads and bridges, agriculture, transportation and logistics, utilities, air traffic control, factories, and private homes, among others. In various implementations, the IoT network 500 includes cloud service 554 that collects data from various sensors 510a-510d, 512a-512d, located in various locations. Using the collected data, the cloud service 554 can provide services 520, control of machinery and equipment 514, exchange of data with traditional network devices 516, and/or exchange of data with user devices 518.

A cloud service, such as the illustrated cloud service 554, is a resource provided over the Internet 550. Sometimes synonymous with “cloud computing,” the resource provided by the cloud services is in the “cloud” in that the resource is provided by hardware and/or software at some location remote from the place where the resource is used. Often, the hardware and software of the cloud service is distributed across multiple physical locations. Generally, the resource provided by the cloud service is not directly associated with specific hardware or software resources, such that use of the resource can continue when the hardware or software is changed. The resource provided by the cloud service can often also be shared between multiple users of the cloud service, without affecting each user's use. The resource can often also be provided as needed or on-demand. Often, the resource provided by the cloud service 554 is automated, or otherwise capable of operating with little or no assistance from human operators.

Examples of cloud services include software as a service (SaaS), infrastructure as a service (IaaS), platform as a service (PaaS), desktop as a service (DaaS), managed software as a service (MSaaS), mobile backend as a service (MBaaS), and information technology management as a service (ITMaas). Specific examples of cloud services include data centers, such as those operated by Amazon Web Services and Google Web Services, among others, that provide general networking and software services. Other examples of cloud services include those associated with smartphone applications, or “apps,” such as for example apps that track fitness and health, apps that allow a user to remotely manage her home security system or thermostat, and networked gaming apps, among others. In each of these examples, the company that provides the app may also provide cloud-based storage of application data, cloud-based software and computing resources, and/or networking services. In some cases, the company manages the cloud services provided by the company, including managing physical hardware resources. In other cases, the company leases networking time from a data center provider.

In some cases, the cloud service 554 is part of one integrated system, run by one entity. For example, the cloud service 554 can be part of a traffic control system. In this example, sensors 510a-510d, 512a-512d can be used to monitor traffic and road conditions. In this example, the service 554 can attempt to optimize the flow of traffic and also provide traffic safety. For example, the sensors 510a-510d, 512a-512d can include a sensor 512a on a bridge that monitors ice formation. When the sensor 512a detects that ice has formed on the bridge, the sensor 512a can alert the cloud service 554. The cloud service 554, can respond by interacting with machinery and equipment 514 that manages traffic in the area of the bridge. For example, the cloud service 554 can turn on warning signs, indicating to drivers that the bridge is icy. Generally, the interaction between the sensor 512, the cloud service 554, and the machinery and equipment 514 is automated, requiring little or no management by human operators.

In various implementations, the cloud services 554 collects or receives data from sensors 510a-510d, 512a-512d, distributed across one or more networks. The sensors 510a-510d, 512a-512d include devices capable of “sensing” information, such as air or water temperature, air pressure, weight, motion, humidity, fluid levels, noise levels, and so on. The sensors 510a-510d, 512a-512d can alternatively or additionally include devices capable of receiving input, such as cameras, microphones, touch pads, keyboards, key pads, and so on. In some cases, a group of sensors 510a-510d may be common to one customer network 502. For example, the sensors 510a-510d may be motion sensors, traffic cameras, temperature sensors, and other sensors for monitoring traffic in a city's metro area. In this example, the sensors 510a-510d can be located in one area of the city, or be distribute across the city, and be connected to a common network. In these cases, the sensors 510a-510d can communicate with a gateway device 562, such as a network gateway. The gateway 562 can further communicate with the cloud service 554.

In some cases, in addition to receiving data from sensors 510a-510d in one customer network 502, the cloud service 554 can also receive data from sensors 512a-512d in other sites 504a-504c. These other sites 504a-504c can be part of the same customer network 502 or can be unrelated to the customer network 502. For example, the other sites 504a-504c can each be the metro area of a different city, and the sensors 512a-512d can be monitoring traffic for each individual city.

Generally, communication between the cloud service 554 and the sensors 510a-510d, 512a-512d is bidirectional. For example, the sensors 510a-510d, 512a-512d can send information to the cloud service 554. The cloud service 554 can further provide configuration and control information to the sensors 510a-510d, 512a-512d. For example, the cloud service 554 can enable or disable a sensor 510a-510d, 512a-512d or modify the operation of a sensor 510a-510d, 512a-512d, such as changing the format of the data provided by a sensor 510a-510d, 512a-512d or upgrading the firmware of a sensor 510a-510d, 512a-512d.

In various implementations, the cloud service 554 can operate on the data received from the sensors 510a-510d, 512a-512d, and use this data to interact with services 520 provided by the cloud service 554, or to interact with machinery and equipment 514, network device 516, and/or user devices 518 available to the cloud service 554. Services 520 can include software-based services, such as cloud-based applications, website services, or data management services. Services 520 can alternatively or additionally include media, such as streaming video or music or other entertainment services. Services 520 can also include delivery and/or coordination of physical assets, such as for example package delivery, direction of vehicles for passenger pickup and drop-off, or automate re-ordering and re-stocking of supplies. In various implementations, services 520 may be delivered to and used by the machinery and equipment 514, the network devices 516, and/or the user devices 518.

In various implementations, the machinery and equipment 514 can include physical systems that can be controlled by the cloud service 554. Examples of machinery and equipment 514 include factory equipment, trains, electrical street cars, self-driving cars, traffic lights, gate and door locks, and so on. In various implementations, the cloud service 554 can provide configuration and control of the machinery and equipment 514 in an automated fashion.

The network devices 516 can include traditional networking equipment, such as server computers, data storage devices, routers, switches, gateways, and so on. In various implementations, the cloud service 554 can provide control and management of the network devices 516, such as for example automated upgrading of software, security monitoring, or asset tracking. Alternatively or additionally, in various implementations the cloud service 554 can exchange data with the network devices 516, such as for example providing websites, providing stock trading data, or providing online shopping resources, among others. Alternatively or additionally, the network devices 516 can include computing systems used by the cloud service provider to manage the cloud service 554.

The user devices 518 can include individual personal computers, smart phones, tablet devices, smart watches, fitness trackers, medical devices, and so on that can be associated with an individual user. The cloud service 554 can exchange data with the user devices 518, such as for example provide support for applications installed on the user devices 518, providing websites, providing streaming media, providing directional navigation services, and so on. Alternatively or additionally, the cloud service 554 may enable a user to use a user device 518 to access and/or view other devices, such as the sensors 510a-510d, 512a-512d, the machinery and equipment 514, or the network devices 516.

In various implementations, the services 520, machinery and equipment 514, network devices 516, and user devices 518 may be part of one customer network 506. In some cases, this customer network 506 is the same as the customer network 502 that includes the sensors 510a-510d. In some cases, the services 520, machinery and equipment 514, network devices 516, and user devices 518 are part of the same network, and may instead be part of various other networks 506.

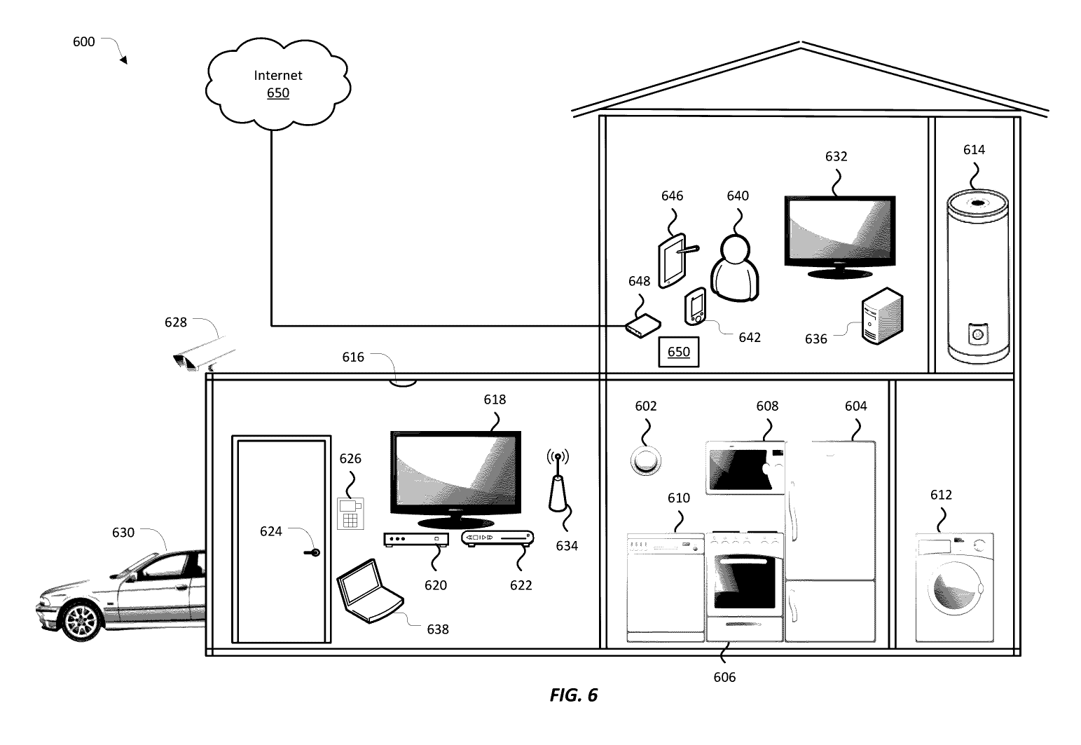

IoT networks can also include small networks of non-traditional devices. FIG. 6 illustrates an example of a customer network that is a small network 600, here implemented in a private home. A network for a home is an example of small network that may have both traditional and non-traditional network devices connected to the network 600, in keeping with an Internet of Things approach. Home networks are also an example of networks that are often implemented with minimal security. The average homeowner is not likely to be a sophisticated network security expert, and may rely on his modem or router to provide at least some basic security. The homeowner, however, is likely able to at least set up a basic home network. A deception-based network security device may be as simple to set up as a home router or base station, yet provide sophisticated security for the network 600.

The example network 600 of FIG. 6 may be a single network, or may include multiple sub-networks. These sub-networks may or may not communicate with each other. For example, the network 600 may include a sub-network that uses the electrical wiring in the house as a communication channel. Devices configured to communicate in this way may connect to the network using electrical outlets, which also provide the devices with power. The sub-network may include a central controller device, which may coordinate the activities of devices connected to the electrical network, including turning devices on and off at particular times. One example of a protocol that uses the electrical wiring as a communication network is X10.

The network 600 may also include wireless and wired networks, built into the home or added to the home solely for providing a communication medium for devices in the house. Examples of wireless, radio-based networks include networks using protocols such as Z-Wave™, Zigbee™ (also known as Institute of Electrical and Electronics Engineers (IEEE) 802.15.4), Bluetooth™, and Wi-Fi (also known as IEEE 802.11), among others. Wireless networks can be set up by installing a wireless base station in the house. Alternatively or additionally, a wireless network can be established by having at least two devices in the house that are able to communicate with each other using the same protocol.

Examples of wired networks include Ethernet (also known as IEEE 802.3), token ring (also known as IEEE 802.5), Fiber Distributed Data Interface (FDDI), and Attached Resource Computer Network (ARCNET), among others. A wired network can be added to the house by running cabling through the walls, ceilings, and/or floors, and placing jacks in various rooms that devices can connect to with additional cables. The wired network can be extended using routers, switches, and/or hubs. In many cases, wired networks may be interconnected with wireless networks, with the interconnected networks operating as one seamless network. For example, an Ethernet network may include a wireless base station that provides a Wi-Fi signal for devices in the house.

As noted above, a small network 600 implemented in a home is one that may include both traditional network devices and non-traditional, everyday electronics and appliances that have also been connected to the network 600. Examples of rooms where one may find non-traditional devices connected to the network are the kitchen and laundry rooms. For example, in the kitchen a refrigerator 604, oven 606, microwave 608, and dishwasher 610 may be connected to the network 600, and in the laundry room a washing machine 612 may be connected to the network 600. By attaching these appliances to the network 600, the homeowner can monitor the activity of each device (e.g., whether the dishes are clean, the current state of a turkey in the oven, or the washing machine cycle) or change the operation of each device without needing to be in the same room or even be at home. The appliances can also be configured to resupply themselves. For example, the refrigerator 604 may detect that a certain product is running low, and may place an order with a grocery delivery service for the product to be restocked.

The network 600 may also include environmental appliances, such as a thermostat 602 and a water heater 614. By having these devices connected to the network 600, the homeowner can monitor the current environment of the house (e.g., the air temperature or the hot water temperature), and adjust the settings of these appliances while at home or away. Furthermore, software on the network 600 or on the Internet 650 may track energy usage for the heating and cooling units and the water heater 614. This software may also track energy usage for the other devices, such as the kitchen and laundry room appliances. The energy usage of each appliance may be available to the homeowner over the network 600.

In the living room, various home electronics may be on the network 600. These electronics may have once been fully analog or may have been standalone devices, but now include a network connection for exchanging data with other devices in the network 600 or with the Internet 650. The home electronics in this example include a television 618, a gaming system 620, and a media device 622 (e.g., a video and/or audio player). Each of these devices may play media hosted, for example, on network attached storage 636 located elsewhere in the network 600, or media hosted on the Internet 650.

The network 600 may also include home safety and security devices, such as a smoke alarm 616, an electronic door lock 624, and a home security system 626. Having these devices on the network may allow the homeowner to track the information monitored and/or sensed by these devices, both when the homeowner is at home and away from the house. For example, the homeowner may be able to view a video feed from a security camera 628. When the safety and security devices detect a problem, they may also inform the homeowner. For example, the smoke detector 616 may send an alert to the homeowner's smartphone when it detects smoke, or the electronic door lock 624 may alert the homeowner when there has been a forced entry. Furthermore, the homeowner may be able to remotely control these devices. For example, the homeowner may be able to remotely open the electronic door lock 624 for a family member who has been locked out. The safety and security devices may also use their connection to the network to call the fire department or police if necessary.

Another non-traditional device that may be found in the network 600 is the family car 630. The car 630 is one of many devices, such as laptop computers 638, tablets 646, and smartphones 642, that connect to the network 600 when at home, and when not at home, may be able to connect to the network 600 over the Internet 650. Connecting to the network 600 over the Internet 650 may provide the homeowner with remote access to his network. The network 600 may be able to provide information to the car 630 and receive information from the car 630 while the car is away. For example, the network 600 may be able to track the location of the car 630 while the car 630 is away.

In the home office and elsewhere around the house, this example network 600 includes some traditional devices connected to the network 600. For example, the home office may include a desktop computer 632 and network attached storage 636. Elsewhere around the house, this example includes a laptop computer 638 and handheld devices such as a tablet computer 646 and a smartphone 642. In this example, a person 640 is also connected to the network 600. The person 640 may be connected to the network 600 wirelessly through personal devices worn by the person 640, such as a smart watch, fitness tracker, or heart rate monitor. The person 640 may alternatively or additionally be connected to the network 600 through a network-enabled medical device, such as a pacemaker, heart monitor, or drug delivery system, which may be worn or implanted.

The desktop computer 632, laptop computer 638, tablet computer 646, and/or smartphone 642 may provide an interface that allows the homeowner to monitor and control the various devices connected to the network. Some of these devices, such as the laptop computer 638, the tablet computer 646, and the smartphone 642 may also leave the house, and provide remote access to the network 600 over the Internet 650. In many cases, however, each device on the network may have its own software for monitoring and controlling only that one device. For example, the thermostat 602 may use one application while the media device 622 uses another, and the wireless network provides yet another. Furthermore, it may be the case that the various sub-networks in the house do not communicate with each other, and/or are viewed and controlled using software that is unique to each sub-network. In many cases, the homeowner may not have one unified and easily understood view of his entire home network 600.

The small network 600 in this example may also include network infrastructure devices, such as a router or switch (not shown) and a wireless base station 634. The wireless base station 634 may provide a wireless network for the house. The router or switch may provide a wired network for the house. The wireless base station 634 may be connected to the router or switch to provide a wireless network that is an extension of the wired network. The router or switch may be connected to a gateway device 648 that connects the network 600 to other networks, including the Internet 650. In some cases, a router or switch may be integrated into the gateway device 648. The gateway device 648 is a cable modem, digital subscriber line (DSL) modem, optical modem, analog modem, or some other device that connects the network 600 to an ISP. The ISP may provide access to the Internet 650. Typically, a home network only has one gateway device 648. In some cases, the network 600 may not be connected to any networks outside of the house. In these cases, information about the network 600 and control of devices in the network 600 may not be available when the homeowner is not connected to the network 600; that is, the homeowner may not have access to his network 600 over the Internet 650.

Typically, the gateway device 648 includes a hardware and/or software firewall. A firewall monitors incoming and outgoing network traffic and, by applying security rules to the network traffic, attempts to keep harmful network traffic out of the network 600. In many cases, a firewall is the only security system protecting the network 600. While a firewall may work for some types of intrusion attempts originating outside the network 600, the firewall may not block all intrusion mechanisms, particularly intrusions mechanisms hidden in legitimate network traffic. Furthermore, while a firewall may block intrusions originating on the Internet 650, the firewall may not detect intrusions originating from within the network 600. For example, an infiltrator may get into the network 600 by connecting to signal from the Wi-Fi base station 634. Alternatively, the infiltrator may connect to the network 600 by physically connecting, for example, to the washing machine 612. The washing machine 612 may have a port that a service technician can connect to service the machine. Alternatively or additionally, the washing machine 612 may have a simple Universal Serial Bus (USB) port. Once an intruder has gained access to the washing machine 612, the intruder may have access to the rest of the network 600.

To provide more security for the network 600, a deception-based network security device 660 can be added to the network 600. In some implementations, the security device 660 is a standalone device that can be added to the network 600 by connecting it to a router or switch. In some implementations, the security device 660 can alternatively or additionally be connected to the network's 600 wireless sub-network by powering on the security device 660 and providing it with Wi-Fi credentials. The security device 660 may have a touchscreen, or a screen and a keypad, for inputting Wi-Fi credentials. Alternatively or additionally, the homeowner may be able to enter network information into the security device by logging into the security device 660 over a Bluetooth™ or Wi-Fi signal using software on a smartphone, tablet, or laptop, or using a web browser. In some implementations, the security device 660 can be connected to a sub-network running over the home's electrical wiring by connecting the security device 660 to a power outlet. In some implementations, the security device 660 may have ports, interfaces, and/or radio antennas for connecting to the various sub-networks that can be included in the network 600. This may be useful, for example, when the sub-networks do not communicate with each other, or do not communicate with each other seamlessly. Once powered on and connected, the security device 660 may self-configure and monitor the security of each sub-network in the network 600 that it is connected to.

In some implementations, the security device 660 may be configured to connect between the gateway device 648 and the network's 600 primary router, and/or between the gateway device 648 and the gateway device's 648 connection to the wall. Connected in one or both of these locations, the security device 648 may be able to control the network's 600 connection with outside networks. For example, the security device can disconnect the network 600 from the Internet 650.

In some implementations, the security device 660, instead of being implemented as a standalone device, may be integrated into one or more of the appliances, home electronics, or computing devices (in this example network 600), or in some other device not illustrated here. For example, the security device 660—or the functionality of the security device 660—may be incorporated into the gateway device 648 or a desktop computer 632 or a laptop computer 638. As another example, the security device 660 can be integrated into a kitchen appliance (e.g., the refrigerator 604 or microwave 608), a home media device (e.g., the television 618 or gaming system 620), or the home's security system 626. In some implementations, the security device 660 may be a printed circuit board that can be added to another device without requiring significant changes to the other device. In some implementations, the security device 660 may be implemented using an Application Specific Integrated Circuit (ASIC) or Field Programmable Gate Array (FPGA) that can be added to the electronics of a device. In some implementations, the security device 660 may be implemented as a software module or modules that can run concurrently with the operating system or firmware of a networked device. In some implementations, the security device 660 may have a physical or virtual security barrier that prevents access to it by the device that it is integrated into. In some implementations, the security device's 660 presence in another device may be hidden from the device into which the security device 660 is integrated.

In various implementations, the security device 660 may scan the network 600 to determine which devices are present in the network 600. Alternatively or additionally, the security device 660 may communicate with a central controller in the network 600 (or multiple central controllers, when there are sub-networks, each with their own central controller) to learn which devices are connected to the network 600. In some implementations, the security device 660 may undergo a learning period, during which the security device 660 learns the normal activity of the network 600, such as what time of day appliances and electronics are used, what they are used for, and/or what data is transferred to and from these devices. During the learning period, the security device 660 may alert the homeowner to any unusual or suspicious activity. The homeowner may indicate that this activity is acceptable, or may indicate that the activity is an intrusion. As described below, the security device 660 may subsequently take preventive action against the intrusion.

Once the security device 660 has learned the topology and/or activity of the network 600, the security device 660 may be able to provide deception-based security for the network 600. In some implementations, the security device 660 may deploy security mechanisms that are configured to emulate devices that could be found in the network 600. In some implementations, the security device 660 may monitor activity on the network 600, including watching the data sent between the various devices on the network 600, and between the devices and the Internet 650. The security device 660 may be looking for activity that is unusual, unexpected, or readily identifiable as suspect. Upon detecting suspicious activity in the network 600, the security device 660 may deploy deceptive security mechanisms.

In some implementations, the deceptive security mechanisms are software processes running on the security device 660 that emulate devices that may be found in the network 600. In some implementations, the security device 660 may be assisted in emulating the security devices by another device on the network 600, such as the desktop computer 632. From the perspective of devices connected to the network 600, the security mechanisms appear just like any other device on the network, including, for example, having an Internet Protocol (IP) address, a Media Access Control (MAC) address, and/or some other identification information, having an identifiable device type, and responding to or transmitting data just as would the device being emulated. The security mechanisms may be emulated by the security device 660 itself; thus, while, from the point of view of the network 600, the network 600 appears to have additional devices, no physical equivalent (other than the security device 660) can be found in the house.

The devices and data emulated by a security mechanism are selected such that the security mechanism is an attractive target for intrusion attempts. Thus, the security mechanism may emulate valuable data, and/or devices that are easily hacked into, and/or devices that provide easy access to the reset of the network 600. Furthermore, the security mechanisms emulate devices that are likely to be found in the network 600, such as a second television, a second thermostat, or another laptop computer. In some implementations, the security device 660 may contact a service on the Internet 650 for assistance in selecting devices to emulate and/or for how to configure emulated devices. The security devices 660 may select and configure security mechanisms to be attractive to intrusions attempts, and to deflect attention away from more valuable or vulnerable network assets. Additionally, the security mechanisms can assist in confirming that an intrusion into the network 600 has actually taken place.

In some implementations, the security device 660 may deploy deceptive security mechanisms in advance of detecting any suspicious activity. For example, having scanned the network, the security device 660 may determine that the network 600 includes only one television 618 and one smoke detector 616. The security device 660 may therefore choose to deploy security mechanisms that emulate a second television and a second smoke detector. With security mechanisms preemptively added to the network, when there is an intrusion attempt, the intruder may target the security mechanisms instead of valuable or vulnerable network devices. The security mechanisms thus may serve as decoys and may deflect an intruder away from the network's 600 real devices.

In some implementations, the security mechanisms deployed by the security device 660 may take into account specific requirements of the network 600 and/or the type of devices that can be emulated. For example, in some cases, the network 600 (or a sub-network) may assign identifiers to each device connected to the network 600, and/or each device may be required to adopt a unique identifier. In these cases, the security device 660 may assign an identifier to deployed security mechanisms that do not interfere with identifiers used by actual devices in the network 600. As another example, in some cases, devices on the network 600 may register themselves with a central controller and/or with a central service on the Internet 650. For example, the thermostat 602 may register with a service on the Internet 650 that monitors energy use for the home. In these cases, the security mechanisms that emulate these types of devices may also register with the central controller or the central service. Doing so may improve the apparent authenticity of the security mechanism, and may avoid conflicts with the central controller or central service. Alternatively or additionally, the security device 660 may determine to deploy security mechanisms that emulate other devices, and avoid registering with the central controller or central service.

In some implementations, the security device 660 may dynamically adjust the security mechanisms that it has deployed. For example, when the homeowner adds devices to the network 600, the security device 660 may remove security mechanisms that conflict with the new devices, or change a security mechanism so that the security mechanism's configuration is not incongruous with the new devices (e.g., the security mechanisms should not have the same MAC address as a new device). As another example, when the network owner removes a device from the network 600, the security device 660 may add a security mechanism that mimics the device that was removed. As another example, the security device may change the activity of a security mechanism, for example, to reflect changes in the normal activity of the home, changes in the weather, the time of year, the occurrence of special events, and so on.

The security device 660 may also dynamically adjust the security mechanisms it has deployed in response to suspicious activity it has detected on the network 600. For example, upon detecting suspicious activity, the security device 660 may change the behavior of a security mechanism or may deploy additional security mechanisms. The changes to the security mechanisms may be directed by the suspicious activity, meaning that if, for example, the suspicious activity appears to be probing for a wireless base station 634, the security device 660 may deploy a decoy wireless base station.

Changes to the security mechanisms are meant not only to attract a possible intrusion, but also to confirm that an intrusion has, in fact occurred. Since the security mechanisms are not part of the normal operation of the network 600, normal occupants of the home are not expected to access the security mechanisms. Thus, in most cases, any access of a security mechanism is suspect. Once the security device 660 has detected an access to a security mechanism, the security device 660 may next attempt to confirm that an intrusion into the network 600 has taken place. An intrusion can be confirmed, for example, by monitoring activity at the security mechanism. For example, login attempts, probing of data emulated by the security mechanism, copying of data from the security mechanism, and attempts to log into another part of the network 600 from the security mechanism indicate a high likelihood that an intrusion has occurred.

Once the security device 660 is able to confirm an intrusion into the network 600, the security device 660 may alert the homeowner. For example, the security device 660 may sound an audible alarm, send an email or text message to the homeowner or some other designated persons, and/or send an alert to an application running on a smartphone or tablet. As another example, the security device 660 may access other network devices and, for example, flash lights, trigger the security system's 626 alarm, and/or display messages on devices that include display screens, such as the television 618 or refrigerator 604. In some implementations, depending on the nature of the intrusion, the security device 660 may alert authorities such as the police or fire department.

In some implementations, the security device 660 may also take preventive actions. For example, when an intrusion appears to have originated outside the network 600, the security device 660 may block the network's 600 access to the Internet 650, thus possibly cutting off the intrusion. As another example, when the intrusion appears to have originated from within the network 600, the security device 660 may isolate any apparently compromised devices, for example by disconnecting them from the network 600. When only its own security mechanisms are compromised, the security device 660 may isolate itself from the rest of the network 600. As another example, when the security device 660 is able to determine that the intrusion very likely included physical intrusion into the house, the security device 660 may alert the authorities. The security device 660 may further lock down the house by, for example, locking any electronic door locks 624.

In some implementations, the security device 660 may be able to enable a homeowner to monitor the network 600 when a suspicious activity has been detected, or at any other time. For example, the homeowner may be provided with a software application that can be installed on a smartphone, tablet, desktop, and/or laptop computer. The software application may receive information from the security device 660 over a wired or wireless connection. Alternatively or additionally, the homeowner may be able to access information about his network through a web browser, where the security device 660 formats webpages for displaying the information. Alternatively or additionally, the security device 660 may itself have a touchscreen or a screen and key pad that provide information about the network 600 to the homeowner.

The information provided to the homeowner may include, for example, a list and/or graphic display of the devices connected to the network 600. The information may further provide a real-time status of each device, such as whether the device is on or off, the current activity of the device, data being transferred to or from the device, and/or the current user of the device, among other things. The list or graphic display may update as devices connect and disconnect from the network 600, such as for example laptops and smartphones connecting to or disconnecting from a wireless sub-network in the network 600. The security device 660 may further alert the homeowner when a device has unexpectedly been disconnected from the network 600. The security device 660 may further alert the homeowner when an unknown device connects to the network 600, such as for example when a device that is not known to the homeowner connects to the Wi-Fi signal.

The security device 660 may also maintain historic information. For example, the security device 660 may provide snapshots of the network 600 taken once a day, once a week, or once a month. The security device 660 may further provide a list of devices that have, for example, connected to the wireless signal in the last hour or day, at what times, and for how long. The security device 660 may also be able to provide identification information for these devices, such as MAC addresses or usernames. As another example, the security device 660 may also maintain usage statistics for each device in the network 600, such as for example the times at which each device was in use, what the device was used for, how much energy the device used, and so on.

The software application or web browser or display interface that provides the homeowner with information about his network 600 may also enable the homeowner to make changes to the network 600 or to devices in the network 600. For example, through the security device 660, the homeowner may be able to turn devices on or off, change the configuration of a device, change a password for a device or for the network, and so on.

In some implementations, the security device 660 may also display currently deployed security mechanisms and their configuration. In some implementations, the security device 660 may also display activity seen at the security mechanisms, such as for example a suspicious access to a security mechanism. In some implementations, the security device 660 may also allow the homeowner to customize the security mechanisms. For example, the homeowner may be able to add or remove security mechanisms, modify data emulated by the security mechanisms, modify the configuration of security mechanism, and/or modify the activity of a security mechanism.

A deception-based network security device 660 thus can provide sophisticated security for a small network. The security device 660 may be simple to add to a network, yet provide comprehensive protection against both external and internal intrusions. Moreover, the security device 660 may be able to monitor multiple sub-networks that are each using different protocols. The security device 660, using deceptive security mechanisms, may be able to detect and confirm intrusions into the network 600. The security device 660 may be able to take preventive actions when an intrusion occurs. The security device 660 may also be able to provide the homeowner with information about his network, and possibly also control over devices in the network.

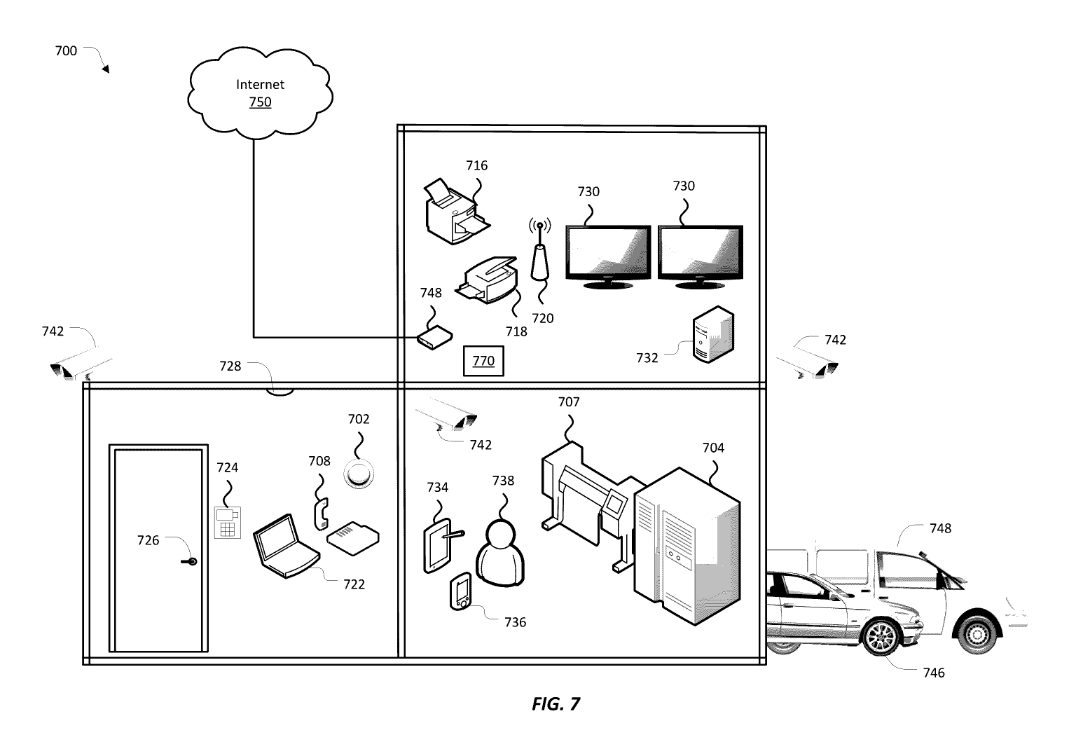

FIG. 7 illustrates another example of a small network 700, here implemented in a small business. A network in a small business may have both traditional and non-traditional devices connected to the network 700. Small business networks are also examples of networks that are often implemented with minimal security. A small business owner may not have the financial or technical resources, time, or expertise to configure a sophisticated security infrastructure for her network 700. The business owner, however, is likely able to at least set up a network 700 for the operation of the business. A deception-based network security device that is at least as simple to set up as the network 700 itself may provide inexpensive and simple yet sophisticated security for the network 700.

The example network 700 may be one, single network, or may include multiple sub-networks. For example, the network 700 may include a wired sub-network, such as an Ethernet network, and a wireless sub-network, such as an 802.11 Wi-Fi network. The wired sub-network may be implemented using cables that have been run through the walls and/or ceilings to the various rooms in the business. The cables may be connected to jacks in the walls that devices can connect to in order to connect to the network 700. The wireless network may be implemented using a wireless base station 720, or several wireless base stations, which provide a wireless signal throughout the business. The network 700 may include other wireless sub-networks, such as a short-distance Bluetooth™ network. In some cases, the sub-networks communicate with one another. For example, the Wi-Fi sub-network may be connected to the wired Ethernet sub-network. In some cases, the various sub-networks in the network 700 may not be configured to or able to communicate with each other.

As noted above, the small business network 700 may include both computers, network infrastructure devices, and other devices not traditionally found in a network. The network 700 may also include electronics, machinery, and systems that have been connected to the network 700 according to an Internet-of-Things approach. Workshop machinery that was once purely analog may now have computer controls. Digital workshop equipment may be network-enabled. By connecting shop equipment and machinery to the network 700, automation and efficiency of the business can be improved and orders, materials, and inventory can be tracked. Having more devices on the network 700, however, may increase the number of vulnerabilities in the network 700. Devices that have only recently become network-enabled may be particularly vulnerable because their security systems have not yet been hardened through use and attack. A deception-based network security device may provide simple-to-install and sophisticated security for a network that may otherwise have only minimal security.

The example small business of FIG. 7 includes a front office. In the front office, the network may include devices for administrative tasks. These devices may include, for example, a laptop 722 and a telephone 708. These devices may be attached to the network 700 in order to, for example, access records related to the business, which may be stored on a server 732 located elsewhere in the building. In the front office, security devices for the building may also be found, including, for example, security system controls 724 and an electronic door lock 726. Having the security devices on the network 700 may enable the business owner to remotely control access to the building. The business owner may also be able to remotely monitor the security of building, such as for example being able to view video streams from security cameras 742. The front office may also be where environmental controls, such as a thermostat 702, are located. Having the thermostat 702 on the network 700 may allow the business owner to remotely control the temperature settings. A network-enabled thermostat 702 may also track energy usage for the heating and cooling systems. The front office may also include safety devices, such as a network-connected smoke alarm 728. A network-connected smoke alarm may be able to inform the business owner that there is a problem in the building be connecting to the business owner's smartphone or computer.

Another workspace in this example small business is a workshop. In the workshop, the network 700 may include production equipment for producing the goods sold by the business. The production equipment may include, for example, manufacturing machines 704 (e.g. a milling machine, a Computer Numerical Control (CNC) machine, a 3D printer, or some other machine tool) and a plotter 706. The production equipment may be controlled by a computer on the network 700, and/or may receive product designs over the network 700 and independently execute the designs. In the workshop, one may also find other devices related to the manufacturing of products, such as radiofrequency identification (RFID) scanners, barcode or Quick Response (QR) code generators, and other devices for tracking inventory, as well as electronic tools, hand tools, and so on.

In the workshop and elsewhere in the building, mobile computing devices and people 738 may also be connected to the network 700. Mobile computing devices include, for example, tablet computers 734 and smartphones 736. These devices may be used to control production equipment, track supplies and inventory, receive and track orders, and/or for other operations of the business. People 738 may be connected to the network through network-connected devices worn or implanted in the people 738, such as for example smart watches, fitness trackers, heart rate monitors, drug delivery systems, pacemakers, and so on.

At a loading dock, the example small business may have a delivery van 748 and a company car 746. When these vehicles are away from the business, they may be connected to the network 700 remotely, for example over the Internet 750. By being able to communicate with the network 700, the vehicles may be able to receive information such as product delivery information (e.g., orders, addresses, and/or delivery times), supply pickup instructions, and so on. The business owner may also be able to track the location of these vehicles from the business location, or over the Internet 750 when away from the business, and/or track who is using the vehicles.

The business may also have a back office. In the back office, the network 700 may include traditional network devices, such as computers 730, a multi-function printer 716, a scanner 718, and a server 732. In this example, the computers 730 may be used to design products for manufacturing in the workshop, as well as for management of the business, including tracking orders, supplies, inventory, and/or human resources records. The multi-function printer 716 and scanner 732 may support the design work and the running of the business. The server 732 may store product designs, orders, supply records, and inventory records, as well as administrative data, such as accounting and human resources data.

The back office may also be where a gateway device 748 is located. The gateway device 748 connects the small business to other networks, including the Internet 750. Typically, the gateway device 748 connects to an ISP, and the ISP provides access to the Internet 750. In some cases, a router may be integrated into the gateway device 748. In some cases, gateway device 748 may be connected to an external router, switch, or hub, not illustrated here. In some cases, the network 700 is not connected to any networks outside of the business's own network 700. In these cases, the network 700 may not have a gateway device 748.

The back office is also where the network 700 may have a deception-based network security device 760. The security device 760 may be a standalone device that may be enabled as soon as it is connected to the network 700. Alternatively or additionally, the security device 760 may be integrated into another device connected to the network 700, such as the gateway device 760, a router, a desktop computer 730, a laptop computer 722, the multi-function printer 716, or the thermostat 702, among others. When integrated into another device, the security device 760 may use the network connection of the other device, or may have its own network connection for connecting to the network 700. The security device 760 may connect to the network 700 using a wired connection or a wireless connection.

Once connected to the network 700, the security device 760 may begin monitoring the network 700 for suspect activity. In some implementations, the security device 760 may scan the network 700 to learn which devices are connected to the network 700. In some cases, the security device 760 may learn the normal activity of the network 700, such as what time the various devices are used, for how long, by whom, for what purpose, and what data is transferred to and from each device, among other things.

In some implementations, having learned the configuration and/or activity of the network 700, the security device 760 may deploy deceptive security mechanisms. These security mechanisms may emulate devices that may be found on the network 700, including having an identifiable device type and/or network identifiers (such as a MAC address and/or IP address), and being able to send and receive network traffic that a device of a certain time would send and receive. For example, for the example small business, the security device 760 may configure a security mechanism to emulate a 3D printer, a wide-body scanner, or an additional security camera. The security device 760 may further avoid configuring a security mechanism to emulate a device that is not likely to be found in the small business, such as a washing machine. The security device 760 may use the deployed security mechanisms to monitor activity on the network 700.

In various implementations, when the security device 760 detects suspect activity, the security device 760 may deploy additional security mechanisms. These additional security mechanisms may be selected based on the nature of suspect activity. For example, when the suspect activity appears to be attempting to break into the shop equipment, the security device 760 may deploy a security mechanism that looks like shop equipment that is easy to hack. In some implementations, the security device 760 may deploy security mechanisms only after detecting suspect activity on the network 700.

The security device 760 selects devices to emulate that are particularly attractive for an infiltration, either because the emulated device appears to have valuable data or because the emulated device appears to be easy to infiltrate, or for some other reason. In some implementations, the security device 760 connects to a service on the Internet 750 for assistance in determining which devices to emulate and/or how to configure the emulated device. Once deployed, the security mechanisms serve as decoys to attract the attention of a possible infiltrator away from valuable network assets. In some implementations, the security device 760 emulates the security mechanisms using software processes. In some implementations, the security device 760 may be assisted in emulating security mechanisms by a computer 730 on the network.

In some implementations, the security device 760 may deploy security mechanisms prior to detecting suspicious activity on the network 700. In these implementations, the security mechanisms may present more attractive targets for a possible, future infiltration, so that if an infiltration occurs, the infiltrator will go after the security mechanisms instead of the actual devices on the network 700.

In various implementations, the security device 760 may also change the security mechanisms that it has deployed. For example, the security device 760 may add or remove security mechanisms as the operation of the business changes, as the activity on the network 700 changes, as devices are added or removed from the network 700, as the time of year changes, and so on.

Besides deflecting a possible network infiltration away from valuable or vulnerable network devices, the security device 760 may use the security mechanisms to confirm that the network 700 has been infiltrated. Because the security mechanisms are not part of actual devices in use by the business, any access to them over the network is suspect. Thus, once the security device 760 detects an access to one of its security mechanisms, the security device 760 may attempt to confirm that this access is, in fact, an unauthorized infiltration of the network 700.

To confirm that a security mechanism has been infiltrated, the security device 760 may monitor activity seen at the security mechanism. The security device 760 may further deploy additional security mechanisms, to see if, for example, it can present an even more attractive target to the possible infiltrator. The security device 760 may further look for certain activity, such as log in attempts to other devices in the network, attempts to examine data on the security mechanism, attempts to move data from the security mechanism to the Internet 750, scanning of the network 700, password breaking attempts, and so on.

Once the security device 760 has confirmed that the network 700 has been infiltrated, the security device 760 may alert the business owner. For example, the security device 760 may sound an audible alarm, email or send text messages to the computers 730 and/or handheld devices 734, 736, send a message to the business's cars 746, 748, flash lights, or trigger the security system's 724 alarm. In some implementations, the security device 760 may also take preventive measures. For example, the security device 760 may disconnect the network 700 from the Internet 750, may disconnect specific devices from the network 700 (e.g., the server 732 or the manufacturing machines 704), may turn some network-connected devices off, and/or may lock the building.

In various implementations, the security device 760 may allow the business owner to monitor her network 700, either when an infiltration is taking place or at any other time. For example, the security device 760 may provide a display of the devices currently connected to the network 700, including flagging any devices connected to the wireless network that do not appear to be part of the business. The security device 760 may further display what each device is currently doing, who is using them, how much energy each device is presently using, and/or how much network bandwidth each device is using. The security device 760 may also be able to store this information and provide historic configuration and/or usage of the network 700.

The security device 760 may have a display it can use to show information to the business owner. Alternatively or additionally, the security device 760 may provide this information to a software application that can run on a desktop or laptop computer, a tablet, or a smartphone. Alternatively or additionally, the security device 760 may format this information for display through a web browser. The business owner may further be able to control devices on the network 700 through an interface provided by the security device 760, including, for example, turning devices on or off, adjusting settings on devices, configuring user accounts, and so on. The business owner may also be able to view any security mechanisms presently deployed, and may be able to re-configure the security mechanisms, turn them off, or turn them on.

IoT networks can also include industrial control systems. Industrial control system is a general term that encompasses several types of control systems, including supervisory control and data acquisition (SCADA) systems, distributed control systems (DCS) and other control system configurations, such as Programmable Logic Controllers (PLCs), often found in the industrial sectors and infrastructures. Industrial control systems are often found in industries such as electrical, water and wastewater, oil and natural gas, chemical, transportation, pharmaceutical, pulp and paper, food and beverage, and discrete manufacturing (e.g., automotive, aerospace, and durable goods). While a large percentage of industrial control systems may be privately owned and operated, federal agencies also operate many industrial processes, such as air traffic control systems and materials handling (e.g., Postal Service mail handling).

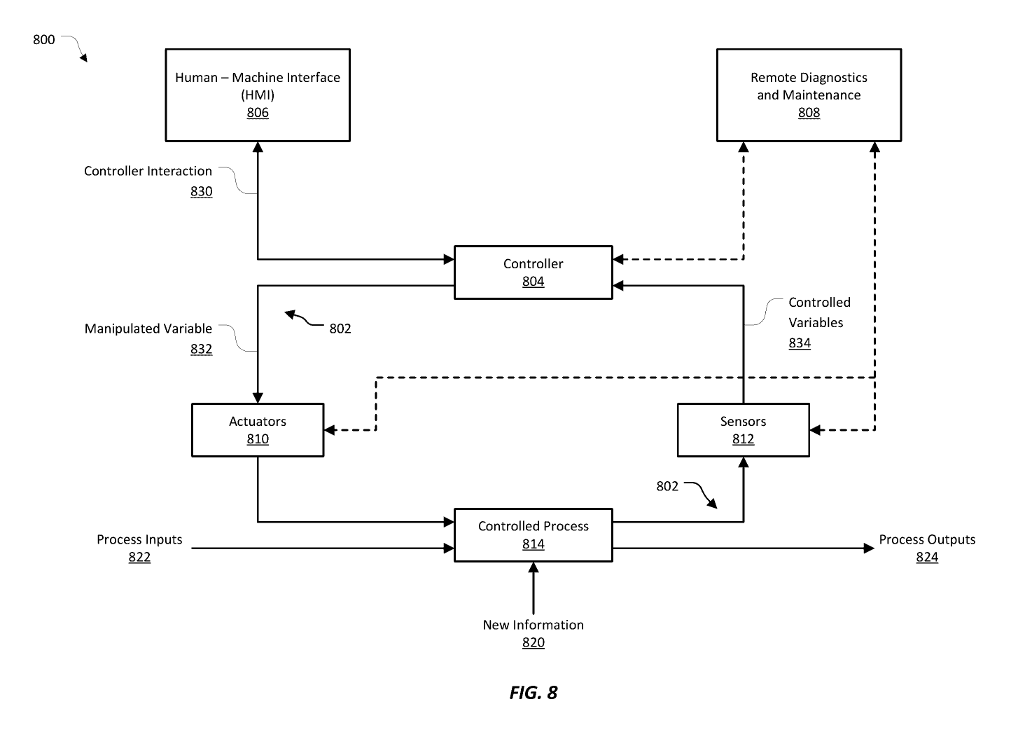

FIG. 8 illustrates an example of the basic operation of an industrial control system 800. Generally, an industrial control system 800 may include a control loop 802, a human-machine interface 806, and remote diagnostics and maintenance 808.

A control loop 802 may consist of sensors 812, controller 804 hardware such as PLCs, actuators 810, and the communication of variables 832, 834. The sensors 812 may be used for measuring variables in the system, while the actuators 810 may include, for example, control valves breakers, switches, and motors. Controlled variables 834 may be transmitted to the controller 804 from the sensors 834. The controller 804 may interpret the controlled variables 834 and generates corresponding manipulated variables 832, based on set points provided by controller interaction 830. The controller 804 may then transmit the manipulated variables 832 to the actuators 810. The actuators 810 may drive a controlled process 814 (e.g., a machine on an assembly line). The controlled process 814 may accept process inputs 822 (e.g., raw materials) and produce process outputs 824 (e.g., finished products). New information 820 provided to the controlled process 814 may result in new sensor 812 signals, which identify the state of the controlled process 814 and which may also transmitted to the controller 804.

The human-machine interface 806 provides operators and engineers with an interface for controller interaction 830. Controller interaction 830 may include monitoring and configuring set points and control algorithms, and adjusting and establishing parameters in the controller 804. The human-machine interface 806 typically also receives information from the controller 804 that allows the human-machine interface 806 to display process status information and historical information about the operation of the control loop 802.

The remote diagnostics and maintenance utilities 808 are typically used to prevent, identify, and recover from abnormal operation or failures. For diagnostics, the remote diagnostics and maintenance utilities 808 may monitor the operation of each of the controller 804, sensors 812, and actuators 810. To recover after a problem, the remote diagnostics and maintenance utilities 808 may provide recovery information and instructions to one or more of the controller 804, sensors 812, and/or actuators 810.

A typical industrial control system contains many control loops, human-machine interfaces, and remote diagnostics and maintenance tools, built using an array of network protocols on layered network architectures. In some cases, multiple control loops are nested and/or cascading, with the set point for one control loop being based on process variables determined by another control loop. Supervisory-level control loops and lower-level control loops typically operate continuously over the duration of a process, with cycle times ranging from milliseconds to minutes.

One type of industrial control system that may include many control loops, human-machine interfaces, and remote diagnostics and maintenance tools is a supervisory control and data acquisition (SCADA) system. SCADA systems are used to control dispersed assets, where centralized data acquisition is typically as important as control of the system. SCADA systems are used in distribution systems such as, for example, water distribution and wastewater collection systems, oil and natural gas pipelines, electrical utility transmission and distribution systems, and rail and other public transportation systems, among others. SCADA systems typically integrate data acquisition systems with data transmission systems and human-machine interface software to provide a centralized monitoring and control system for numerous process inputs and outputs. SCADA systems are typically designed to collect field information, transfer this information to a central computer facility, and to display the information to an operator in a graphic and/or textual manner. Using this displayed information, the operator may, in real time, monitor and control an entire system from a central location. In various implementations, control of any individual sub-system, operation, or task can be automatic, or can be performed by manual commands.

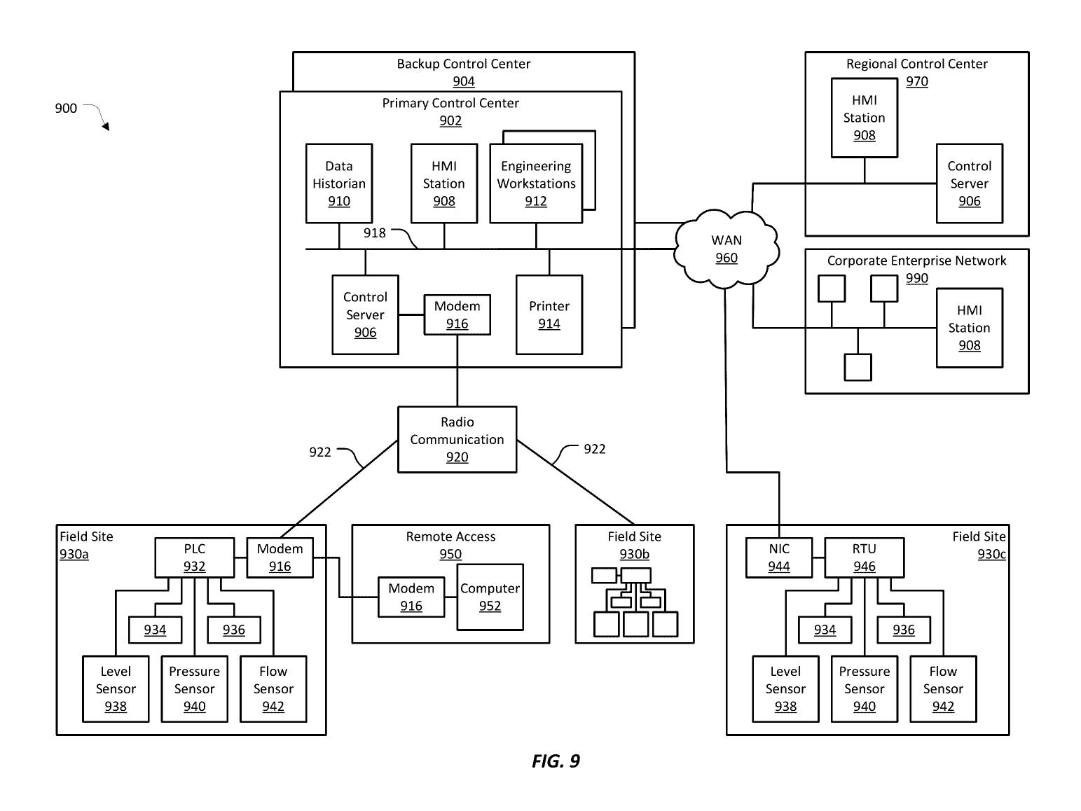

FIG. 9 illustrates an example of a SCADA system 900, here used for distributed monitoring and control. This example SCADA system 900 includes a primary control center 902 and three field sites 930a-930c. A backup control center 904 provides redundancy in case of there is a malfunction at the primary control center 902. The primary control center 902 in this example includes a control server 906—which may also be called a SCADA server or a Master Terminal Unit (MTU)—and a local area network (LAN) 908. The primary control center 902 may also include a human-machine interface station 908, a data historian 910, engineering workstations 912, and various network equipment such as printers 914, each connected to the LAN 908.

The control server 906 typically acts as the master of the SCADA system 900. The control server 906 typically includes supervisory control software that controls lower-level control devices, such as Remote Terminal Units (RTUs) and PLCs, located at the field sites 930a-930c. The software may tell the system 900 what and when to monitor, what parameter ranges are acceptable, and/or what response to initiate when parameters are outside of acceptable values.

The control server 906 of this example may access Remote Terminal Units and/or PLCs at the field sites 930a-930c using a communications infrastructure, which may include radio-based communication devices, telephone lines, cables, and/or satellites. In the illustrated example, the control server 906 is connected to a modem 916, which provides communication with serial-based radio communication 920, such as a radio antenna. Using the radio communication 920, the control server 906 can communicate with field sites 930a-930b using radiofrequency signals 922. Some field sites 930a-930b may have radio transceivers for communicating back to the control server 906.

A human-machine interface station 908 is typically a combination of hardware and software that allows human operators to monitor the state of processes in the SCADA system 900. The human-machine interface station 908 may further allow operators to modify control settings to change a control objective, and/or manually override automatic control operations, such as in the event of an emergency. The human-machine interface station 908 may also allow a control engineer or operator to configure set points or control algorithms and parameters in a controller, such as a Remote Terminal Unit or a PLC. The human-machine interface station 908 may also display process status information, historical information, reports, and other information to operators, administrators, mangers, business partners, and other authorized users. The location, platform, and interface of a human-machine interface station 908 may vary. For example, the human-machine interface station 908 may be a custom, dedicated platform in the primary control center 902, a laptop on a wireless LAN, or a browser on a system connected to the Internet.

The data historian 910 in this example is a database for logging all process information within the SCADA system 900. Information stored in this database can be accessed to support analysis of the system 900, for example for statistical process control or enterprise level planning.

The backup control center 904 may include all or most of the same components that are found in the primary control center 902. In some cases, the backup control center 904 may temporarily take over for components at the primary control center 902 that have failed or have been taken offline for maintenance. In some cases, the backup control center 904 is configured to take over all operations of the primary control center 912, such as when the primary control center 912 experiences a complete failure (e.g., is destroyed in a natural disaster).

The primary control center 902 may collect and log information gathered by the field sites 930a-930c and display this information using the human-machine interface station 908. The primary control center 902 may also generate actions based on detected events. The primary control center 902 may, for example, poll field devices at the field sites 930a-930c for data at defined intervals (e.g., 5 or 60 seconds), and can send new set points to a field device as required. In addition to polling and issuing high-level commands, the primary control center 902 may also watch for priority interrupts coming from the alarm systems at the field sites 930a-930c.

In this example, the primary control center 902 uses point-to-point connections to communication with three field sites 930a-930c, using radio telemetry for two communications with two of the field sites 930a-930b. In this example, the primary control center 902 uses a wide area network (WAN) 960 to communicate with the third field site 930c. In other implementations, the primary control center 902 may use other communication topologies to communicate with field sites. Other communication topologies include rings, stars, meshes, trees, lines or series, and busses or multi-drops, among others. Standard and proprietary communication protocols may be used to transport information between the primary control center 902 and field sites 930a-930c. These protocols may use telemetry techniques such as provided by telephone lines, cables, fiber optics, and/or radiofrequency transmissions such as broadcast, microwave, and/or satellite communications.

The field sites 930a-930c in this example perform local control of actuators and monitor local sensors. For example, a first field site 930a may include a PLC 932. A PLC is a small industrial computer originally designed to perform the logic functions formerly executed by electrical hardware (such as relays, switches, and/or mechanical timers and counters). PLCs have evolved into controllers capable of controlling complex processes, and are used extensively in both SCADA systems and distributed control systems. Other controllers used at the field level include process controllers and Remote Terminal Units, which may provide the same level of control as a PLC but may be designed for specific control applications. In SCADA environments, PLCs are often used as field devices because they are more economical, versatile, flexible, and configurable than special-purpose controllers.

The PLC 932 at a field site, such as the first field site 930a, may control local actuators 934, 936 and monitor local sensors 938, 940, 942. Examples of actuators include valves 934 and pumps 936, among others. Examples of sensors include level sensors 938, pressure sensors 940, and flow sensors 942, among others. Any of the actuators 934, 936 or sensors 938, 940, 942 may be “smart” actuators or sensors, more commonly called intelligent electronic devices (IEDs). Intelligent electronic devices may include intelligence for acquiring data, communicating with other devices, and performing local processing and control. An intelligent electronic device could combine an analog input sensor, analog output, low-level control capabilities, a communication system, and/or program memory in one device. The use of intelligent electronic devices in SCADA systems and distributed control systems may allow for automatic control at the local level. Intelligent electronic devices, such as protective relays, may communicate directly with the control server 906. Alternatively or additionally, a local Remote Terminal Unit may poll intelligent electronic devices to collect data, which it may then pass to the control server 906.

Field sites 930a-930c are often equipped with remote access capability that allows field operators to perform remote diagnostics and repairs. For example, the first remote 930a may include a modem 916 connected to the PLC 932. A remote access 950 site may be able to, using a dial up connection, connect to the modem 916. The remote access 950 site may include its own modem 916 for dialing into to the remote station 930a over a telephone line. At the remote site 950, an operator may use a computer 952 connected to the modem 916 to perform diagnostics and repairs on the first remote site 930a.

The example SCADA system 900 includes a second field site 930b, which may be provisioned in substantially the same way as the first field site 930a, having at least a modem and a PLC or Remote Terminal that controls and monitors some number of actuators and sensors.

The example SCADA system 900 also includes a third field site 930c that includes a network interface card (NIC) 944 for communicating with the system's 900 WAN 960. In this example, the third field site 930c includes a Remote Terminal Unit 946 that is responsible for controlling local actuators 934, 936 and monitoring local sensors 938, 940, 942. A Remote Terminal Unit, also called a remote telemetry unit, is a special-purpose data acquisition and control unit typically designed to support SCADA remote stations. Remote Terminal Units may be field devices equipped with wireless radio interfaces to support remote situations where wire-based communications are unavailable. In some cases, PLCs are implemented as Remote Terminal Units.

The SCADA system 900 of this example also includes a regional control center 970 and a corporate enterprise network 980. The regional control center 970 may provide a higher level of supervisory control. The regional control center 970 may include at least a human-machine interface station 908 and a control server 906 that may have supervisory control over the control server 906 at the primary control center 902. The corporate enterprise network 980 typically has access, through the system's 900 WAN 960, to all the control centers 902, 904 and to the field sites 930a-930c. The corporate enterprise network 980 may include a human-machine interface station 908 so that operators can remotely maintain and troubleshoot operations.

Another type of industrial control system is the distributed control system (DCS). Distributed control systems are typically used to control production systems within the same geographic location for industries such as oil refineries, water and wastewater management, electric power generation plants, chemical manufacturing plants, and pharmaceutical processing facilities, among others. These systems are usually process control or discrete part control systems. Process control systems may be processes that run continuously, such as manufacturing processes for fuel or steam flow in a power plant, for petroleum production in a refinery, or for distillation in a chemical plant. Discrete part control systems have processes that have distinct processing steps, typically with a distinct start and end to each step, such as found in food manufacturing, electrical and mechanical parts assembly, and parts machining. Discrete-based manufacturing industries typically conduct a series of steps on a single item to create an end product.

A distributed control system typically uses a centralized supervisory control loop to mediate a group of localized controllers that share the overall tasks of carrying out an entire production process. By modularizing the production system, a distributed control system may reduce the impact of a single fault on the overall system. A distributed control system is typically interfaced with a corporate network to give business operations a view of the production process.

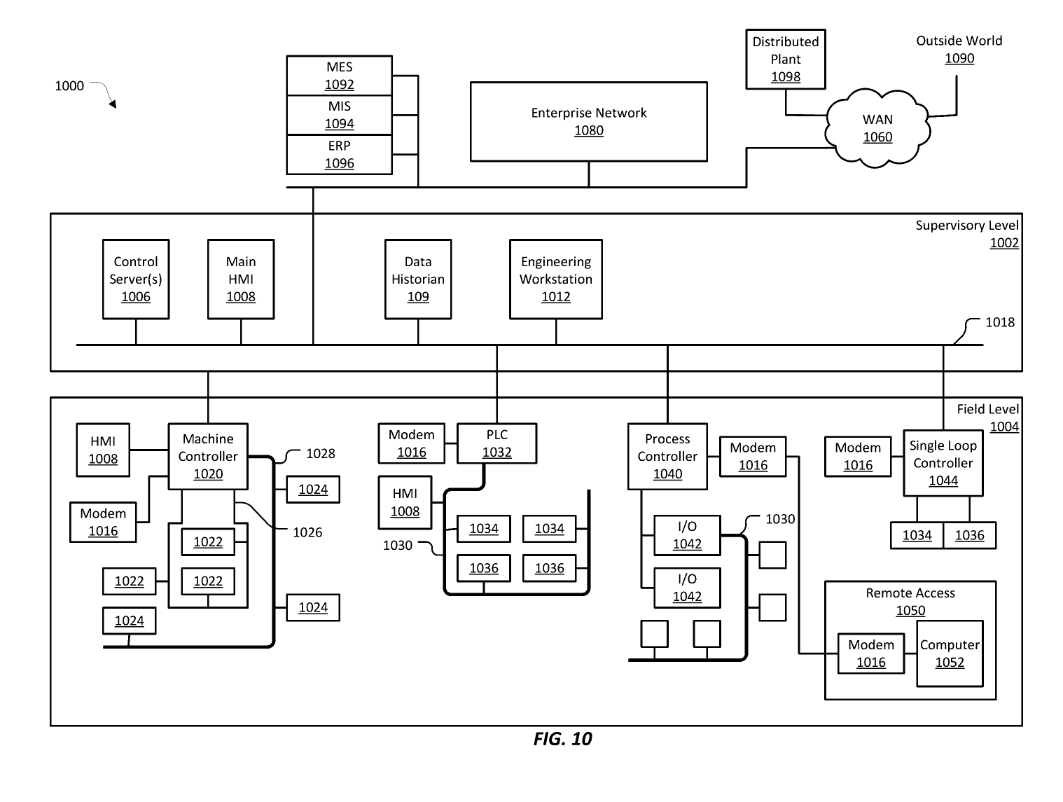

FIG. 10 illustrates an example of a distributed control system 1000. This example distributed control system 1000 encompasses a production facility, including bottom-level production processes at a field level 1004, supervisory control systems at a supervisory level 1002, and a corporate or enterprise layer.

At the supervisory level 1002, a control server 1006, operating as a supervisory controller, may communicate with subordinate systems via a control network 1018. The control server 1006 may send set points to distributed field controllers, and may request data from the distributed field controllers. The supervisory level 1002 may include multiple control servers 1006, with one acting as the primary control server and the rest acting as redundant, back-up control servers. The supervisory level 1002 may also include a main human-machine interface 1008 for use by operators and engineers, a data historian 1010 for logging process information from the system 1000, and engineering workstations 1012.

At the field level 1004, the system 1000 may include various distributed field controllers. In the illustrated example, the distributed control system 1000 includes a machine controller 1020, a PLC 1032, a process controller 1040, and a single loop controller 1044. The distributed field controllers may each control local process actuators, based on control server 1006 commands and sensor feedback from local process sensors.

In this example, the machine controller 1020 drives a motion control network 1026. Using the motion control network 1026, the machine controller 1020 may control a number of servo drives 1022, which may each drive a motor. The machine controller 1020 may also drive a logic control bus 1028 to communicate with various devices 1024. For example, the machine controller 1020 may use the logic control bus 1028 to communicate with pressure sensors, pressure regulators, and/or solenoid valves, among other devices. One or more of the devices 1024 may be an intelligent electronic device. A human-machine interface 1008 may be attached to the machine controller 1020 to provide an operator with local status information about the processes under control of the machine controller 1020, and/or local control of the machine controller 1020. A modem 1016 may also be attached to the machine controller 1020 to provide remote access to the machine controller 1020.

The PLC 1032 in this example system 1000 uses a fieldbus 1030 to communicate with actuators 1034 and sensors 1036 under its control. These actuators 1034 and sensors 1036 may include, for example, direct current (DC) servo drives, alternating current (AC) servo drives, light towers, photo eyes, and/or proximity sensors, among others. A human-machine interface 1008 may also be attached to the fieldbus 1030 to provide operators with local status and control for the PLC 1032. A modem 1016 may also be attached to the PLC 1032 to provide remote access to the PLC 1032.

The process controller 1040 in this example system 1000 also uses a fieldbus 1030 to communicate with actuators and sensors under its control, one or more of which may be intelligent electronic devices. The process controller 1040 may communicate with its fieldbus 1030 through an input/output (I/O) server 1042. An I/O server is a control component typically responsible for collecting, buffering, and/or providing access to process information from control sub-components. An I/O server may be used for interfacing with third-party control components. Actuators and sensors under control of the process controller 1040 may include, for example, pressure regulators, pressure sensors, temperature sensors, servo valves, and/or solenoid valves, among others. The process controller 1040 may be connected to a modem 1016 so that a remote access 1050 site may access the process controller 1040. The remote access 1050 site may include a computer 1052 for use by an operator to monitor and control the process controller 1040. The computer 1052 may be connected to a local modem 1016 for dialing in to the modem 1016 connected to the process controller 1040.

The illustrated example system 1000 also includes a single loop controller 1044. In this example, the single loop controller 1044 interfaces with actuators 1034 and sensors 1036 with point-to-point connections, instead of a fieldbus. Point-to-point connections require a dedicated connection for each actuator 1034 and each sensor 1036. Fieldbus networks, in contrast, do not need point-to-point connections between a controller and individual field sensors and actuators. In some implementations, a fieldbus allows greater functionality beyond control, including field device diagnostics. A fieldbus can accomplish control algorithms within the fieldbus, thereby avoiding signal routing back to a PLC for every control operation. Standard industrial communication protocols are often used on control networks and fieldbus networks.

The single loop controller 1044 in this example is also connected to a modem 1016, for remote access to the single loop controller.

In addition to the supervisory level 1002 and field level 1004 control loops, the distributed control system 1000 may also include intermediate levels of control. For example, in the case of a distributed control system controlling a discrete part manufacturing facility, there could be an intermediate level supervisor for each cell within the plant. This intermediate level supervisor could encompass a manufacturing cell containing a machine controller that processes a part, and a robot controller that handles raw stock and final products. Additionally, the distributed control system could include several of these cells that manage field-level controllers under the main distributed control system supervisory control loop.

In various implementations, the distributed control system may include a corporate or enterprise layer, where an enterprise network 1080 may connect to the example production facility. The enterprise network 1080 may be, for example, located at a corporate office co-located with the facility, and connected to the control network 1018 in the supervisory level 1002. The enterprise network 1080 may provide engineers and managers with control and visibility into the facility. The enterprise network 1080 may further include Manufacturing Execution Systems (MES) 1092, control systems for managing and monitoring work-in-process on a factory floor. An MES can track manufacturing information in real time, receiving up-to-the-minute data from robots, machine monitors and employees. The enterprise network 1080 may also include Management Information Systems (MIS) 1094, software and hardware applications that implement, for example, decision support systems, resource and people management applications, project management, and database retrieval applications, as well as basic business functions such as order entry and accounting. The enterprise network 1080 may further include Enterprise Resource Planning (ERP) systems 1096, business process management software that allows an organization to use a system of integrated applications to manage the business and automate many back office functions related to technology, services, and human resources.

The enterprise network 1080 may further be connected to a WAN 1060. Through the WAN 1060, the enterprise network 1080 may connect to a distributed plan 1098, which may include control loops and supervisory functions similar to the illustrated facility, but which may be at a different geographic location. The WAN 1060 may also connect the enterprise network to the outside world 1090, that is, to the Internet and/or various private and public networks. In some cases, the WAN 1060 may itself include the Internet, so that the enterprise network 1080 accesses the distributed plant 1098 over the Internet.

As described above, SCADA systems and distributed control systems use Programmable Logic Controllers (PLCs) as the control components of an overall hierarchical system. PLCs can provide local management of processes through feedback control, as described above. In a SCADA implementation, a PLC can provide the same functionality as a Remote Terminal Unit. When used in a distributed control system, PLCs can be implemented as local controllers within a supervisory scheme. PLCs can have user-programmable memory for storing instructions, where the instructions implement specific functions such as I/O control, logic, timing, counting, proportional-integral-derivative (PID) control, communication, arithmetic, and data and file processing.

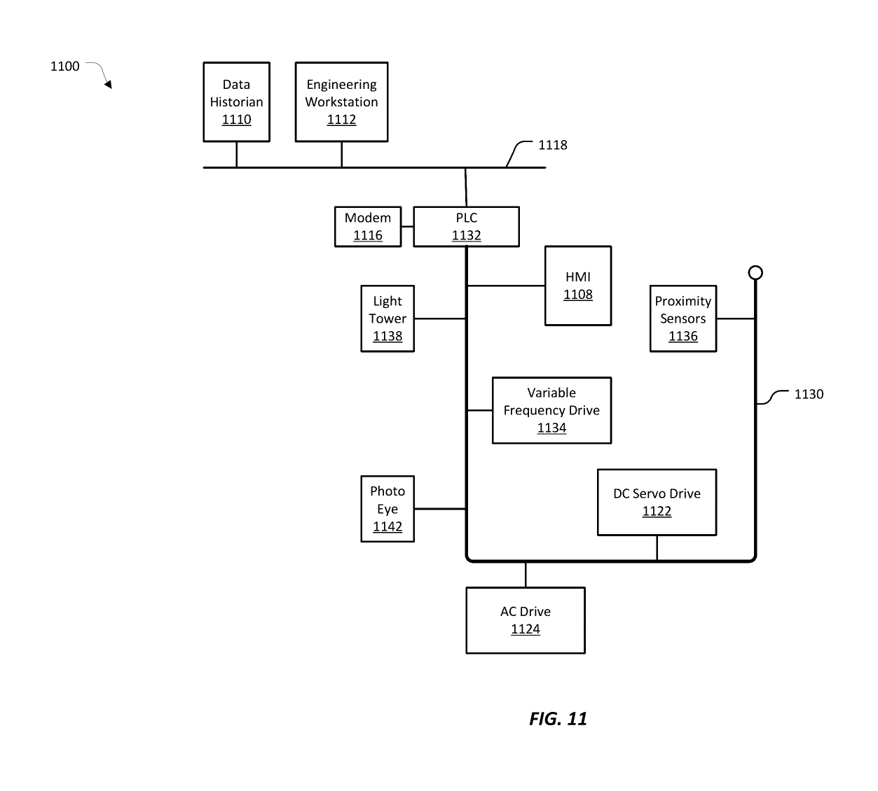

FIG. 11 illustrates an example of a PLC 1132 implemented in a manufacturing control process. The PLC 1132 in this example monitors and controls various devices over fieldbus network 1130. The PLC 1132 may be connected to a LAN 1118. An engineering workstation 1112 may also be connected to the LAN 1118, and may include a programming interface that provides access to the PLC 1132. A data historian 1110 on the LAN 1118 may store data produced by the PLC 1132.

The PLC 1132 in this example may control a number of devices attached to its fieldbus network 1130. These devices may include actuators, such as a DC servo drive 1122, an AC drive 1124, a variable frequency drive 1134, and/or a light tower 1138. The PLC 1132 may also monitor sensors connected to the fieldbus network 1130, such as proximity sensors 1136, and/or a photo eye 1142. A human-machine interface 1108 may also be connected to the fieldbus network 1130, and may provide local monitoring and control of the Programmable Logic Controller 1132.

Most industrial control systems were developed years ago, long before public and private networks, desktop computing, or the Internet were a common part of business operations. These well-established industrial control systems were designed to meet performance, reliability, safety, and flexibility requirements. In most cases, they were physically isolated from outside networks and based on proprietary hardware, software, and communication protocols that included basic error detection and correction capabilities, but lacked secure communication capabilities. While there was concern for reliability, maintainability, and availability when addressing statistical performance and failure, the need for cyber security measures within these systems was not anticipated. At the time, security for industrial control systems mean physically securing access to the network and the consoles that controlled the systems.

Internet-based technologies have since become part of modern industrial control systems. Widely available, low-cost IP devices have replaced proprietary solutions, which increases the possibility of cyber security vulnerabilities and incidents. Industrial control systems have adopted Internet-based solutions to promote corporate connectivity and remote access capabilities, and are being designed and implemented using industry standard computers, operating systems (OS) and network protocols. As a result, these systems may to resemble computer networks. This integration supports new networking capabilities, but provides less isolation for industrial control systems from the outside world than predecessor systems. Networked industrial control systems may be exposed to similar threats as are seen in computer networks, and an increased likelihood that an industrial control system can be compromised.

Industrial control system vendors have begun to open up their proprietary protocols and publish their protocol specifications to enable third-party manufacturers to build compatible accessories. Organizations are also transitioning from proprietary systems to less expensive, standardized technologies such as Microsoft Windows and Unix-like operating systems as well as common networking protocols such as TCP/IP to reduce costs and improve performance. Another standard contributing to this evolution of open systems is Open Platform Communications (OPC), a protocol that enables interaction between control systems and PC-based application programs. The transition to using these open protocol standards provides economic and technical benefits, but also increases the susceptibility of industrial control systems to cyber incidents. These standardized protocols and technologies have commonly known vulnerabilities, which are susceptible to sophisticated and effective exploitation tools that are widely available and relatively easy to use.

Industrial control systems and corporate networking systems are often interconnected as a result of several changes in information management practices, operational, and business needs. The demand for remote access has encouraged many organizations to establish connections to the industrial control system that enable of industrial control systems engineers and support personnel to monitor and control the system from points outside the control network. Many organizations have also added connections between corporate networks and industrial control systems networks to allow the organization's decision makers to obtain access to critical data about the status of their operational systems and to send instructions for the manufacture or distribution of product.

In early implementations this might have been done with custom applications software or via an OPC server/gateway, but, in the past ten years this has been accomplished with TCP/IP networking and standardized IP applications like File Transfer Protocol (FTP) or Extensible Markup Language (XML) data exchanges. Often, these connections were implemented without a full understanding of the corresponding security risks. In addition, corporate networks are often connected to strategic partner networks and to the Internet. Control systems also make more use of WANs and the Internet to transmit data to their remote or local stations and individual devices. This integration of control system networks with public and corporate networks increases the accessibility of control system vulnerabilities. These vulnerabilities can expose all levels of the industrial control system network architecture to complexity-induced error, adversaries and a variety of cyber threats, including worms and other malware.

Many industrial control system vendors have delivered systems with dial-up modems that provide remote access to ease the burdens of maintenance for the technical field support personnel. Remote access can be accomplished, for example, using a telephone number, and sometimes an access control credential (e.g., valid ID, and/or a password). Remote access may provide support staff with administrative-level access to a system. Adversaries with war dialers—simple personal computer programs that dial consecutive phone numbers looking for modems—and password cracking software could gain access to systems through these remote access capabilities. Passwords used for remote access are often common to all implementations of a particular vendor's systems and may have not been changed by the end user. These types of connections can leave a system highly vulnerable because people entering systems through vendor-installed modems are may be granted high levels of system access.

Organizations often inadvertently leave access links such as dial-up modems open for remote diagnostics, maintenance, and monitoring. Also, control systems increasingly utilize wireless communications systems, which can be vulnerable. Access links not protected with authentication and/or encryption have the increased risk of adversaries using these unsecured connections to access remotely controlled systems. This could lead to an adversary compromising the integrity of the data in transit as well as the availability of the system, both of which can result in an impact to public and plant safety. Data encryption may be a solution, but may not be the appropriate solution in all cases.

Many of the interconnections between corporate networks and industrial control systems require the integration of systems with different communications standards. The result is often an infrastructure that is engineered to move data successfully between two unique systems. Because of the complexity of integrating disparate systems, control engineers often fail to address the added burden of accounting for security risks. Control engineers may have little training in security and often network security personnel are not involved in security design. As a result, access controls designed to protect control systems from unauthorized access through corporate networks may be minimal. Protocols, such as TCP/IP and others have characteristics that often go unchecked, and this may counter any security that can be done at the network or the application levels.

Public information regarding industrial control system design, maintenance, interconnection, and communication may be readily available over the Internet to support competition in product choices as well as to enable the use of open standards. Industrial control system vendors also sell toolkits to help develop software that implements the various standards used in industrial control system environments. There are also many former employees, vendors, contractors, and other end users of the same industrial control system equipment worldwide who have inside knowledge about the operation of control systems and processes.

Information and resources are available to potential adversaries and intruders of all calibers around the world. With the available information, it is quite possible for an individual with very little knowledge of control systems to gain unauthorized access to a control system with the use of automated attack and data mining tools and a factory-set default password. Many times, these default passwords are never changed.

IV. Deception Center

The various customer networks described above may have some network security systems, or may have little network security. Each may be better protected by a network threat detection and analysis system.

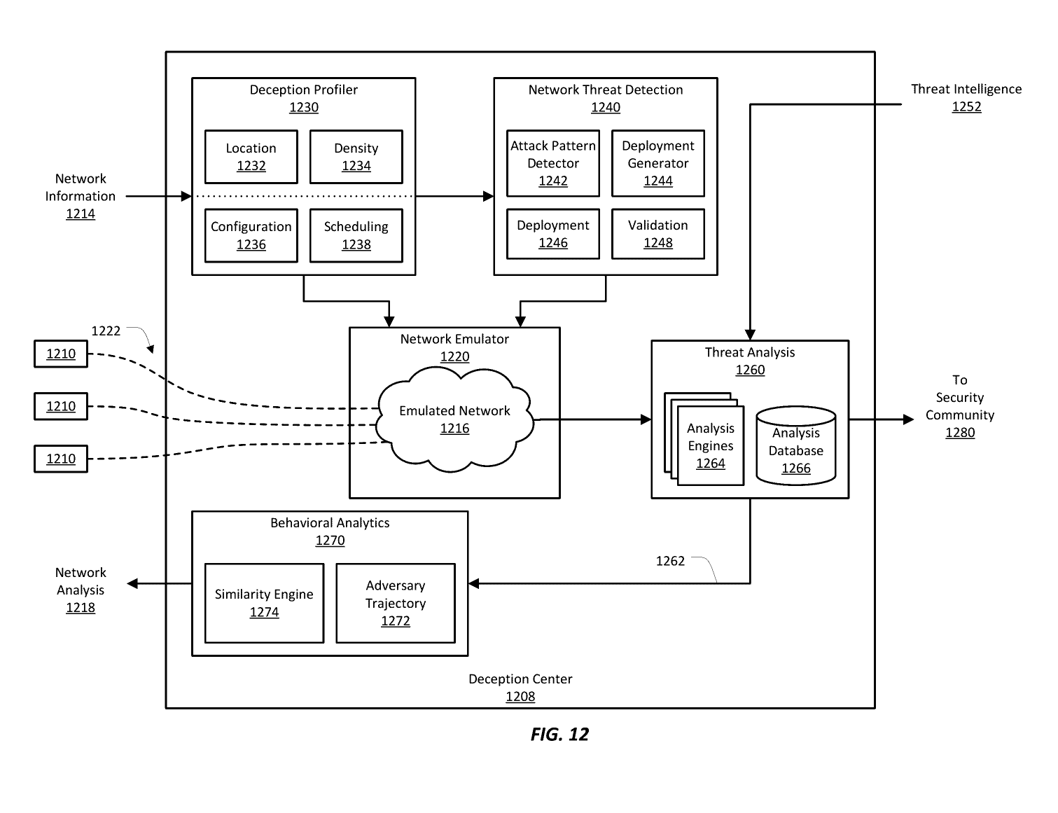

As discussed above, a network threat and analysis system may include a deception center that is configured to provide network threat detection, analysis of network threats, and defense against network threats. FIG. 12 illustrates an example of a deception center 1208. In this example, the deception center 1208 includes at least five major components: a network emulator 1220, a deception profiler 1230, a network threat detection engine 1240, a threat analysis engine 1260, and a behavioral analytics engine 1270. In various implementations, each of these components may be implemented using hardware, software, or a combination of hardware and software. In some implementations, one or more of the components may be combined. In some implementations, one or more of the components may be broken down into multiple components. In some implementations, the deception center 1208 may be implemented as a single appliance. In some implementations, the deception center 1208 may be implemented using a combination of computing systems. For example, one or more of the five example components may be implemented in a separate server. Alternatively or additionally, one or more of the components can be implemented as software processes. Alternatively or additionally, one or more of the components can be combined into one software process.

The network emulator 1220 may be a system configured to host an emulated network 1216. The emulated network 1216 may include one or more emulated network devices. An emulated network device is a hardware and/or software component configured to mimic some or all of the behavior of a network device that may be found in a site network. For example, an emulated network device may include at least a distinct MAC address and IP address. The emulated network devices in the emulated network 1216 may be used as deception mechanism in a site network. The emulated network devices may include, for example, address deception mechanisms, low-interaction deception mechanisms, and/or high-interaction deception mechanisms. In various implementations, the emulated network 1216 may be quickly reconfigured. For example, new emulated network devices can be launched or existing emulated network devices can be removed. Alternatively or additionally, emulated network devices can be reconfigured. For example, an address deception can be escalated to a low-interaction deception, and/or a low-interaction deception can be escalated to a high-interaction deception. In some implementations, the emulated network 1216 may be configured to act and respond as a fully functional network. In these implementations, the emulated network 1216 may be referred to as a high-interaction network.

The emulated network 1216 may be connected to one or more sensors 1210 installed in the site network over network tunnels 1222. The emulated network devices can be projected over the network tunnels 1222 and through the sensors 1210 into the site network, where they emulated network devices can function as deception mechanisms. The network emulator 1220 is described in further detail below.

The deception profiler 1230 may be configured to analyze the site network to determine which deception mechanisms to deploy into the site network, where to deploy them, and/or when to deploy them. The deception profiler 1230 may receive network information 1214 from the site network. This network information 1214 may include information such as subnet addresses, IP addresses in use, an identity and/or configuration of devices in the site network, and/or profiles of usage patterns of the devices in the site network. Using this information, the deception profiler 1230 may configure one or more deception mechanisms. For example, the deception profiler 1230 may instruct the network emulator 1220 to reconfigure the emulated network 1216.

The deception profiler 1230 in this example includes a location engine 1232, a density engine 1234, a configuration engine 1236, and a schedule engine 1238. The location engine 1232 may determine where in the site network to deploy deception mechanisms. The density engine 1234 may determine how many deception mechanisms to deploy. The configuration engine 1236 may determine how each deception mechanism is to be configured, and may provide configurations to the network emulator 1220. The scheduling engine 1238 may determine when a deception mechanism should be deployed and/or activated. The components of the deception profiler 1230 are described in further detail below.

The network threat detection engine 1240 may be configured to monitor the site network and watch for possible attacks. For example, the network threat detection engine 1240 may detect an access to a deception mechanism. The network threat detection engine 1240 may further attempt to confirm that suspicious activity in the site network is an actual attack. To do so, in various implementations, the network threat detection engine 1240 may instruct the network emulator 1220 to reconfigure the emulated network 1216 to create deceptions that are more attractive to an attacker and/or to contain the possible attacker to the emulated network 1216.

In this example, the network threat detection engine 1240 includes an attack pattern detector 1242, a deployment generator 1244, a deployment engine 1246, and a validation engine 1248. The attack pattern detector 1242 may receive network information 1214 from various network devices in the site network, and analyze the network information 1214 to determine whether a network abnormality has occurred or is occurring. The deployment generator 1244 may analyzes suspected attack patterns from the attack pattern detector 1242 to determine what should be done to confirm that an attack has occurred or is in progress. The deployment engine 1246 may implement a deployment strategy generated by the deployment generator 1244. The deployment strategy may include instructing the network emulator 1220 to add, remove, and/or modify emulated network devices in the emulated network 1216, and/or to modify the deception mechanisms projected into the site network. The validation engine 1248 may analyze the deployment strategy and feedback data received from the site network and/or the emulated network 1216 to confirm whether an attack has occurred. The network threat detection engine 1240 is described in further detail below.

The threat analysis engine 1260 may receive data collected from the emulated network during the course of an incident that has been allowed to proceed within the emulated network 1216. Generally, when a suspected threat to the site network has been detected, the components of the deception center 1208 may redirect and contain suspect network traffic related to the attack to the emulated network 1216. Once contained to the emulated network 1216, the suspected attacked may be allowed to proceed. By allowing the suspected attack to proceed, information can be learned about the suspected attack, such as the manner of the attack, the motivation for the attack, network vulnerabilities that allow the attack to proceed, and so on. As the attack is allowed to proceed, information is collected by the emulated network 1216, such as log files, memory snapshots, packets, and any other information that may be generated by suspect network traffic and interacting with suspect network traffic.

In various implementations, the threat analysis engine 1260 may include one or more analysis engines 1264 for analyzing different types of data collected in the network emulator. To analyze the data, in some implementations the threat analysis engine 1260 may receive threat intelligence 1252 from, for example, the network security community. The threat intelligence 1252 may include, for example, descriptions of current (e.g. for a given day or hour or minute) known network threats. The threat analysis engine 1260 may also include an analysis database 1266 for storing data collected in the emulated network 1216 and/or analysis results from the analysis engines 1264.

In various implementations, the threat analysis engine 1260 may produce indicators 1262 that describe a particular incident that was analyzed using the emulated network 1216. These indicators 1262 may include, for example, digital signatures of malicious files, IP addresses of malicious sites, and/or descriptions of the course of events in the incident. In some implementations, the indicators may be provided to the network security community 1280. The indicators 1262 may also be provided to the behavioral analytics engine 1270. The threat analysis engine 1260 is described in further detail below.

The behavioral analytics engine 1270 includes two engines that may be used to analyze a site network for an attack or suspected attack: an adversary trajectory engine 1272 and a similarity engine 1274.

The adversary trajectory engine 1272 may analyze the various ways in which an attack may have occurred in a site network. Using this information, and possibly also the indicators 1262, the adversary trajectory engine 1272 may trace the possible path of a specific incident in the site network. This path may point to network devices in the site network that could have been affected by the incident. These network devices can be checked to determine whether they have, in fact, been affected.

The similarity engine 1274 may use the indicators 1262 to identify similar machines. For example, given emulated network devices in the emulated network 1216, the similarity engine 1274 may determine query items from, for example, the indicators 1262, and use the query items to identify similar network devices in the site network. Alternatively or additionally, the similarity engine 1274 may receive query items generated from network devices in the site network, and may use those query items to find similar network devices in the site network.

The adversary trajectory engine 1272 and the similarity engine 1274 are each described in further detail below.

Using the adversary trajectory engine 1272 and/or the similarity engine 1274, the behavioral analytics engine 1270 may produce a network analysis 1218. The network analysis 1218 may indicate, for example, whether the site network has been exposed to a particular attack, which (if any) network devices may have been affected by the attack, how the network devices were affected by the attack, and/or how the site network's security can be improved. The network analysis 1218 can be used to scrub the effects of an attack from the site network, and/or to increase the security of the site network.

V. Network Emulator

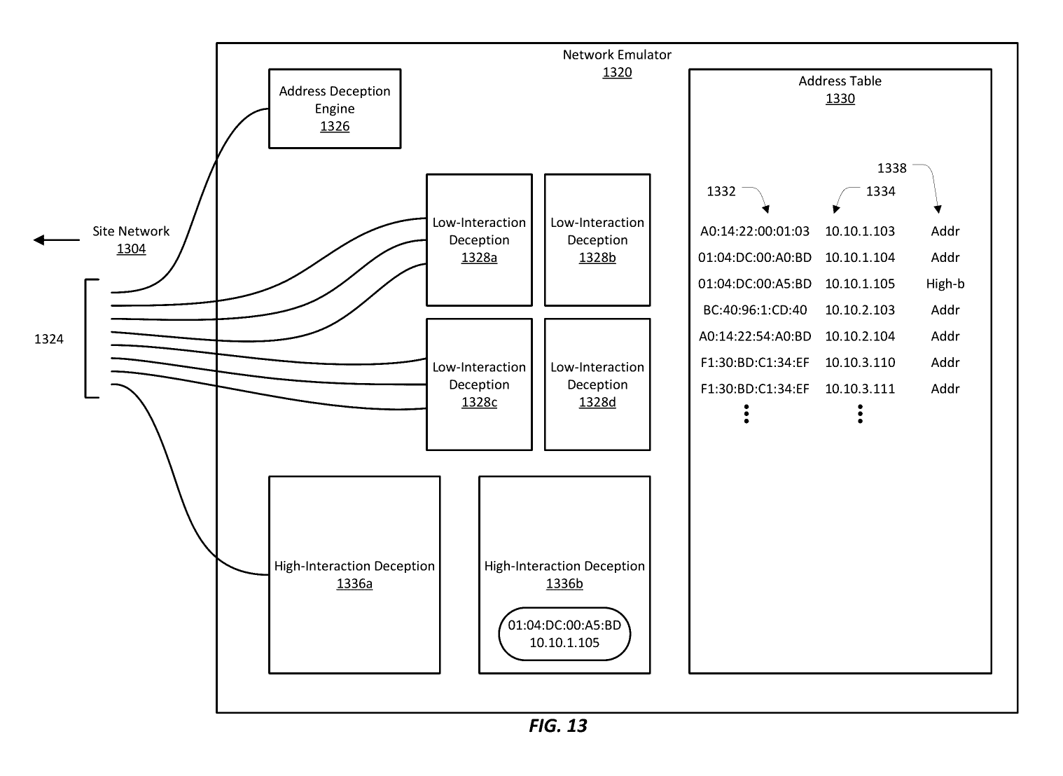

FIG. 13 illustrates an example of a network emulator 1320. A deception center may be provided with a network emulator 1320 so that the network emulator 1320 can host deception mechanisms, which may be projected into a site network. Alternatively or additionally, the network emulator 1320 may itself be a deception mechanism, in the form of an emulated network, which can be used to contain a suspected attack on a site network. In some implementations, the network emulator 1320 may also be referred to as a high-interaction network. For example, when the network emulator 1320 has been configured to fully interact with suspect network traffic, the network emulator 1320 may be functioning as a high-interaction network.

In various implementations, the illustrated network emulator 1320 may include three types of deception mechanisms: an address deception engine 1326, low-interaction deception mechanisms 1328a-1328d, and high-interaction deception mechanisms 1336a-1336b. Low interaction deceptions and high-interaction deceptions may also be referred to as interactive deceptions. The network emulator 1320 may also include an address table 1330 that stores MAC 1332 and IP 1334 addresses. The network emulator 1320 may have multiple connections 1324 to a site network 1304. The multiple connections 1324 may connect the network emulator 1320 to the site network 1304 over multiple various communication mediums (e.g., cables, radio signals, optical cables, etc.). Alternatively or additionally, one or more of the multiple connections 1324 may be individual network conversations carried over one communication medium. Examples of network conversations include Transmission Control Protocol (TCP) sockets and exchanges of User Datagram Protocol (UDP) datagrams, among others.

The network emulator 1320 may be configured to emulate one or more network devices. Network devices may include network hardware, such as routers, switches, hubs, repeaters, and gateway devices, among others. Network devices can also include computing systems connected to the network, such as servers, desktop computers, laptop computers, netbooks, tablet computers, personal digital assistants, and smart phones, among others. Network device can also include other electronic devices with network interfaces, such as televisions, gaming devices, thermostats, refrigerators, and so on. Network devices can also be virtual, such as virtual machines. In various implementations, the network emulator 1320 may be implemented by one or more network devices. In some implementations, the network emulator 1320 may be implemented by a network device dedicated to providing security services for the site network 1304.

Deception mechanisms in the network emulator 1320 may each represent one or more emulated network devices. To aid the deceptions mechanisms in convincingly representing a network device, each deception mechanism may be assigned a realistic looking MAC address 1332. A MAC address, which may also be referred to as a physical address, is a unique identifier assigned to network interface of a network device. MAC addresses 1332 assigned to the deception mechanisms may be, for example, given recognizable Organizationally Unique Identifiers (OUIs), rather than fully random values, to increase the believability of the deception mechanisms. MAC addresses 1332 for the deception mechanisms may be programmed into the address table 1330 by a network administrator. Alternatively or additionally, MAC addresses 1332 may be provided by a configuration file, which may be provided by a network administrator and/or which may be downloaded from a security services provider on the Internet. Alternatively or additionally, an automated system within the network emulator 1320 may examine the site network 1304, and develop a profile describing the type and number of devices in the site network 1304. The network emulator 1320 may then generate MAC addresses 1332 based on the profile.

The network emulator 1320 may associate each MAC address 1332 with an IP address 1334, and store the associated IP addresses 1334 with their MAC addresses 1332 in the address table 1330. IP addresses are numerical strings that identify a network device on a network. IP addresses may be used in some contexts within network communications, while MAC addresses may be used in others. For example, MAC addresses are often not used once a packet leaves a local subnet. Furthermore, IP addresses, unlike MAC addresses, may be transient. For example, each time a laptop computer connects to the same network, it may be assigned a different IP address.

IP addresses are typically managed and assigned by a server running the Dynamic Host Configuration Protocol (DHCP). The network emulator 1320 may request IP addresses 1334 from a DHCP server operating in the site network 1304, and store these IP addresses 1334 in the address table 1330. By requesting IP addresses 1334 from the DHCP server in the site network 1304, the network emulator 1320 is able to obtain IP addresses 1334 that are within the domain of the site network 1304.

Additionally, the site network 1304 may have multiple broadcast domains. A broadcast domain is a logical division within a network, in which all the nodes can reach each other using broadcast packets. As an example, quite often all the network devices connected to the same repeater or switch are within the same broadcast domain. As a further example, routers frequently form the boundaries of a broadcast domain. When the site network 1304 has multiple broadcast domains, the network emulator 1320 may have deception mechanisms for each of one or more of the broadcast domains. For example, in the example of FIG. 13, the network emulator 1320 has obtained IP addresses in three broadcast domains: 10.10.1, 10.10.2, and 10.10.3.

The network emulator 1320 may also periodically request new IP addresses 1334, to mimic network devices disconnecting and reconnecting to the site network 1304. IP addresses 1334 may be refreshed intelligently. For example, the IP address 1334 for a MAC address 1332 that may be associated with a server may not be changed very frequently, if at all, since servers may be rarely taken offline, or may be assigned fixed IP addresses. As another example, a MAC address 1332 that may be associated with network interface cards typically found in laptop computers may be changed every morning, to simulate the laptop's owner arriving at work.

The address table 1330 may store the MAC addresses 1332 and associated IP addresses 1334, as well to which deception mechanism each MAC 1332 and IP 1334 address is currently assigned 1338. Initially, in various implementations, all the MAC 1332 and IP 1334 addresses may be assigned 1338 to the address deception engine 1326. In some implementations, a MAC 1332 and IP 1334 address may initially be assigned 1338 to a high-interaction deception 1336b, such as for example when the high-interaction deception 1336b is static. Other than for static deceptions, as discussed in further detail below, the MAC 1332 and IP 1334 addresses may be assigned 1338 to different deception mechanisms as engagement with a possible attacker escalates.

The address deception engine 1326 is deception mechanism that can emulate one or more address deceptions. An address deception includes at least MAC address 1332 and an associated IP address 1334. The address deception engine 1326 may have a local table or memory in which it stores address to which it may respond. The network emulator 1320 may assign one or more of the MAC 1332 and IP 1334 address pairs to the address deception engine 1326 by adding the MAC 1332 and IP 1334 addresses to the address deception engine's 1326 local table.

The address deception engine 1326 may respond to queries for MAC and/or IP address information. For example, the address deception engine 1326 may implement an address resolution protocol (ARP). An address resolution protocol may enable the address deception engine 1326 to respond to queries, where the queries include an IP address. In this example, when the address deception engine 1326 is queried for an IP address that is in the address deception engine's 1326 local table, the address deception engine 1326 may respond with a MAC address that is associated with the IP address.

Address queries may occur, for example, when an attacker is mapping a network and looking for possible points to attack. For example, an attacker may generate queries for all IP addresses in a broadcast domain (e.g., assuming a 32-bit netmask, IP addresses 10.10.1.0, 10.10.1.1, 10.10.1.2, and so on until 10.10.1.254). Devices that respond not only tell the attacker that the device exists, but may also provide the attacker with the device's MAC address. Once the attacker has a device's MAC address, the attacker may direct network traffic at the device, using the device's MAC address as the destination address.

When the network emulator 1320 receives suspect network traffic addressed to an address deception, the network emulator 1320 may initiate a low-interaction deception mechanism 1328a-1328d, to respond to the network traffic. Network traffic that may initiate an escalation to a low-interaction deception include, for example, TCP packets and UDP packets. The low-interaction deceptions 1328a-1328d are emulated systems that may be capable of receiving network traffic for multiple MAC and IP address pairs. The low-interaction deceptions 1328a-1328d may have a basic installation of an operating system, and typically have a full suite of services that may be offered by real system with the same operating system. In most implementations, the services are fully functional processes, and respond as would the same services running on a real network device. In some implementations, the services may be emulated. In some implementations the low-interaction deceptions 1328a-1328d may be implemented using one or more computers, servers, blade computers, or some other type of computing system hardware. In some implementations, the low-interaction deceptions 1328a-1328d may be implemented using virtual machines.

The network emulator 1320 may include multiple low-interaction deceptions 1328a-1328d, with each low-interaction deception 1328a-1328d running a different operating system. The network devices in the site network 1304 may be running a variety of different operating systems, such as Red Hat® Linux, Ubuntu® Linux, Windows 7, Windows 10, OS X®, and so on. To mimic network devices that may be found in the site network 1304, the network emulator 1320 may have low-interaction deceptions 1328a-1328d for some or all of the operating systems in use in the site network 1304. In this way, the low-interaction deceptions 1328a-1328d may resemble a typical system that can be found in the site network 1304.

The site network 1304, however, may further have multiple variations of the same operating system. For example, various network devices may have the same version of Linux but have different patch levels or installed packages. In most implementations, the network emulator 1320 may not have a low-interaction deception 1328a-1328d for each variation of each operating system, since to do so could potentially require a very large number of low-interaction deceptions 1328a-1328d. Instead, one low-interaction deception 1328a-1328d, executing one version of an operation system, can emulate multiple network devices by being able to receive network traffic addresses to different addresses, where each of these network devices appear to have at least the same version of the operating system.

Should an attacker connect to a low-interaction deception 1328a-1328d, however, the attacker may be able to determine that he has connected to a decoy. For example, the attacker may notice that many network devices (that is, the network devices emulated by one low-interaction deception 1328a-1328d) have identical operating systems and services. This may indicate to the attacker that he has found a decoy. The network emulator 1320 thus, in most cases, will not allow connections to low-interaction deceptions 1328a-1328d to complete. As discussed further below, the network emulator 1320 may redirect the connections to a high-interaction deception 1336a-1336b instead.

The network emulator 1320 may keep the low-interaction deceptions 1328a-1328d on standby, so that they are available as soon as suspect network traffic is received for any of the MAC 1332 or IP addresses 1334 being used for address deceptions. Alternatively or additionally, the configuration for a low-interaction deception 1328a-1328d may be kept ready, and a low-interaction deceptions 1328a-1328d may be launched when it is needed.

Because these addresses 1332, 1334 were generated for decoy network devices, network traffic should ordinarily not be addressed to these addresses 1332, 1334. Not all network traffic for these addresses 1332, 1334, however, is suspect. For example, as discussed below, network traffic that appears to be for a port scan may not be, by itself, an attack on the site network. Thus the network emulator 1320 may intelligently determine when received network traffic warrants escalating to a high-interaction deception 1336a-1336b. Such intelligence may include algorithms based on observations of network traffic behavior. Alternatively or additionally, the intelligence may include observation of the site network 1304 and, for example, data science-based algorithms that relate the activity seen in the site network 1304 to possible attacks. Once the network emulator 1320 identifies some particular network traffic received by a low-interaction deception 1328a-1328d as suspect, the network emulator 1320 may initiate a high-interaction deception 1336a-1336b to receive the suspect network traffic.

The high-interaction deceptions 1336a-1336b are emulated systems configured to respond to network traffic for a specific MAC 1332 and IP 1334 addresses. In some implementations, the high-interaction deceptions 1336a-1336b can be implemented using one or more computers, servers, or other computing system hardware. In some implementations, the high-interaction deceptions 1336a-1336b may be implemented using virtual machines.

In various implementations, the high-interaction deceptions 1336a-1336b may execute a specific installation of an operating system, including patches, packages, and other variations on the operating system that a network device in the site network 1304 may have. The specific configuration of the operating system may be based on a real network device in the site network 1304. Alternatively or additionally, the configuration of the operating system may be based on randomized list of available options. Generally, as discussed below, a high-interaction deception 1336a-1336b may be configured with the same basic operation system that is executing on a low-interaction deception 1328a-1328d, with variation added to enhance the believability of the high-interaction deception 1336a-1336b.

In some implementations, one or more high-interaction deceptions 1336a-1336b may be kept on standby. Initiating a standby high-interaction deceptions 1336a-1336b for use may involve booting and configuring an operating system. In some implementations, a standby high-interaction deception 1336a-1336b may already have an operating system running, and initiating the high-interaction deception 1336a-1336b only requires configuring the operating system. Initiating a high-interaction deceptions 1336a-1336b may also include starting various services that may be offered by a computing system running the particular operating system. In some implementations, a high-interaction deception 1336a-1336b may also be initiated with data including various log files that are typically generated when a network device is in use. Pre-initializing the high-interaction deception may help the high-interaction deception 1336a-1336b look like it has been an active system, rather than a system that has just been started.

Once an attack on the site network 1304 has, for one reason or another, ended, a high-interaction deception 1336a-1336b used to engage the attacker can be decommissioned, and the MAC 1332 and IP 1334 addresses it was using can be reassigned to the address deception engine 1326 or one of the low-interaction deceptions 1328a-1328d. Processing resources used by the high-interaction deception 1336a-1336b can thus be freed for other uses.

In some implementations, the network emulator 1320 may include a static high-interaction deception 1336b. The network emulator 1320 may include a static high-interaction deception 1336b, for example, to emulate a server that is always available on the site network 1304. For example, the static high-interaction deception 1336b may be configured with open ports and/or data that appear valuable. A static high-interaction deception 1336b may be available at any time, and be assigned a fixed MAC address 1332. Interaction with this MAC address 1332 (or an associated IP address 1334) may escalate from the address deception engine 1326 directly to the static high-interaction deception 1336b, without making use of a low-interaction 1328a-1328d deception.

In some implementations, an alternate method to implement low-interaction and high-interaction deceptions is to use a network address translation (NAT) mechanism. Network address translation enables a network device to translate network addresses to different network addresses. For example, a network address translation mechanism may present the one or more IP addresses 1334, and associated MAC addresses 1332, from the address table 1330 to the site network 1304, while other MAC and/or IP addresses are used by the high-interaction deceptions 1336a-1336b running in the network emulator 1320. Furthermore, the network address translation mechanism may present many addresses 1332, 1334 to the site network 1304, and map those many addresses to just a few high-interaction deceptions 1336a-1336b. A network address translation mechanism thus enables the network emulator 1320 to emulate many decoy systems without requiring a high-interaction deception 1336a-1336b for each decoy.

Once a possible attacker attempts to access an address presented by the network address translation mechanism, however, the attacker may discover that the address is only a deception. For example, should the attacker log in to the device represented by a MAC 1332 and IP 1334 combination, the attacker would be logged into a high-interaction deception 1336a-1336b running behind the network address translation. The high-interaction deception 1336a-1336b may likely have a different IP and/or MAC address than was presented to the attacker. The attacker may thus discover that he has been deceived, and stop his attack. A network address translation mechanism may thus server to divert and distract an attacker, but the low-interaction and high-interaction deceptions described above may be more effective for keeping the attacker engaged.

VI. Deception Profiler

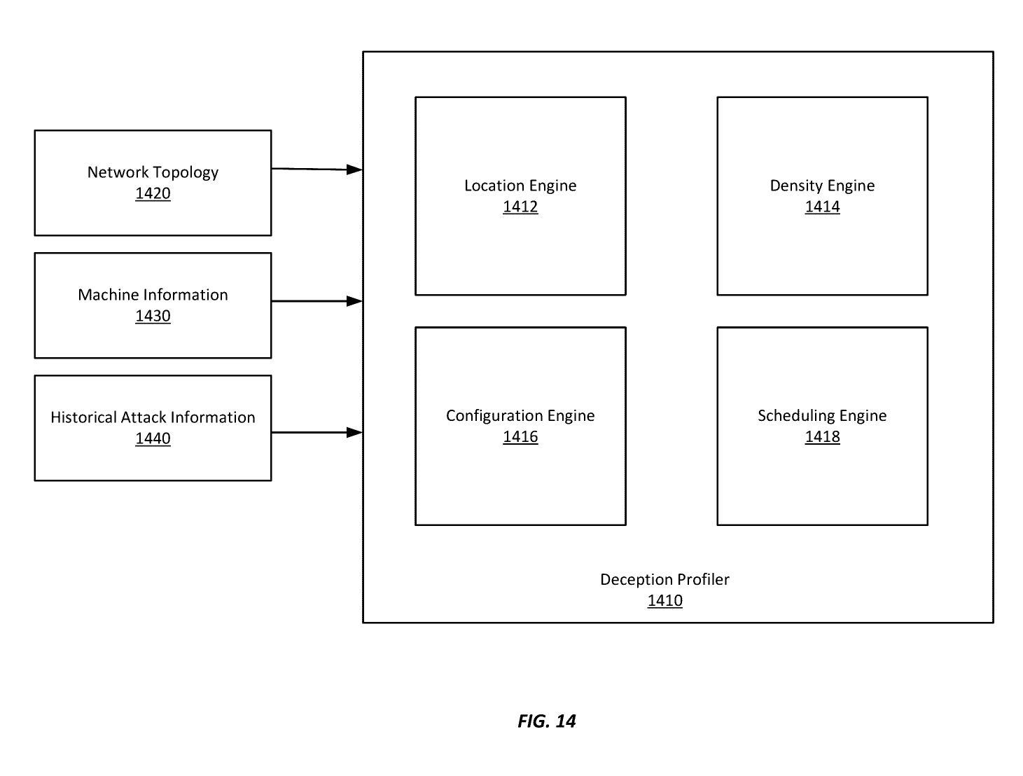

In some implementations, a deception center can manage the selection and deployment of one or more deception mechanisms. FIG. 14 illustrates an example of a deception profiler 1410, which may select and manage the deployment of deception mechanisms into a site network. In various implementations, the deception profiler 1410 may be able to communicate with the site network. For example, the deception profiler 1410 can be connected to the site network through a software tunnel. The software tunnel can connect the deception profiler 1410 to a sensor that is located on the site network. In such an example, the software tunnel can allow the deception profiler 1410 to create deception mechanisms that can be projected into the site network. By being projected onto the site network, the projected deception mechanisms can be visible to an attacker scanning the site network even though the projected deception mechanisms and the deception profiler 1410 would not be directly connected to the site network. In some implementations, the deception profiler 1410 can cause deception mechanisms to be deployed directly into the site network. For example, the deception profiler 1410 can configure a server in the site network to deploy a virtual machine that mimics a machine or a network device on the network.

The deception profiler 1410 can include at least one or more of a location engine 1412, a density engine 1414, a configuration engine 1416, a scheduling engine 1418. Though illustrated as separate engines here, in some implementations, one or more of these engines can be implemented in a single engine. The density engine 1414 can determine how many deception mechanisms to deploy for the site network. The configuration engine 1416 can determine a configurations for each of the deception mechanisms. A configuration for a deception mechanism can include a MAC address, an Internet Protocol (IP) address, an operating system type, a version for the operating system, one or more types of network services, or some other information that can be used to identify and/or profile a network device on a network. The location engine 1412 can determine where in the site network to deploy deception mechanisms (e.g., in a network, in a subnetwork, in a trunk, on one or more machines in the network, or in some other suitable location in a network). A trunk is a single transmission channel between two points that can carry communications for different networks. For example, a Virtual Local Area Network (VLAN) trunk can carry communications for multiple VLANS.

In some implementations, the deception mechanisms can be deployed directly in a site network, meaning that a deception mechanism can be initiated on a server or system in the site network. In other implementations, the deception mechanisms can be deployed in another network, and be projected into the site network. For example, the deception mechanisms can be configured in an emulated network, from which they can be projected into the site network.

The scheduling engine 1418 can determine when the deception mechanisms should be deployed. For example, the scheduling engine 1418 can determine a connect time and/or a disconnect time. The connect time can indicate when to connect a deception mechanism to the site network. The disconnect time can indicate when to disconnect a deception mechanism from the site network.

In some implementations, the deception profiler 1410 can receive information associated with the site network to use with the engines described above. For example, the deception profiler 1410 can receive a network topology 1420. The network topology 1420 can include network information associated with one or more network devices in the site network. For example, the network information can include number of subnetworks that are in the site network and the network devices that are in each subnetwork. The network information can also include a description for a subnetwork. Examples of types of descriptions include human resource, finance, privileged users, source code, user data, and data-backup systems. The network information can also include information associated with a difficulty level of deploying a deception mechanism for a subnetwork. The difficulty level can be based on the number of deception mechanisms in the network. For example, a larger number of deception mechanisms in a network can cause a higher difficulty level. In some examples, the number of deception mechanisms is relevant because the deception mechanisms must be maintained. For example, a list of deception mechanisms with their configurations and locations can be maintained. In addition, a need to refresh, alter, restart, or in some way remove a complication from a deception mechanism can arise when the deception mechanism is compromised.

The network information can also include a number and distribution of assets in a subnetwork in relation to the site network. The number and distribution of assets can be separated by category. Examples of categories can include server type (e.g., email server, DHCP server, database server, or others), device type (e.g., privilege user device, end-user device, security operations center device, an active directory device, or other type of device), and asset type (e.g., ordinary asset, critical asset, or other type of asset). In some implementations, the network topology 1420 can be determined using an active directory. In other embodiments, the network topology 1420 can be determined using a network discovery tool.

The deception profiler 1410 can also receive machine information 1430. The machine information 1430 can be associated with one or more machines (e.g., servers, desktop computers, laptop computers, hand-held devices, etc.) in the site network. The machine information 1430 for a machine can include one or more of a MAC address, an IP address, the machine's operating system type, a version of the operating system, one or more types of network services, or some other information for the specific machine.

The deception profiler 1410 can also receive historical attack information 1440. The source of the historical attack information 1440 can depend on the type of system implemented in the network. For example, historical attack information 1440 can be received from a security operations center (SOC), a computer security incident response team (CSIRT), an intrusion detection system (IDS), an intrusion prevention system (IPS), and/or some other network security tool or system. The SOC can be a centralized unit that monitors, assesses, and defends a network. The SOC can perform real-time monitoring and management of a network, including aggregating logs, aggregating data, and/or coordinating responses and remediation. The SOC can also report attacks and perform post-attack analysis. Post-attack analysis can include forensics and investigation to determine a source of an attacker. The CSIRT is a system that receives reports of security breaches (such as for example from the threat intelligence community), conducts an analysis of the reports, and may react to similar attacks. The IDS is a system that monitors network and system activities for malicious activities. The IPS also monitors network and system activities for malicious activity, and also actively prevents or blocks intrusions that are detected.

Other data sources for the historical attack information 1440 can include existing deception mechanism attack information, threat feeds, vulnerabilities, and privilege user management data. In some implementations, the existing deception mechanism attack information can be associated with attacks detected on one or more network devices in the site network. In other implementations, the existing deception mechanism attack information can be associated with one or more networks other than the site network. In some implementations, the historical attack information 1440 can include a distribution of attacks on a type of mechanism (e.g., a honeypot) using threat intelligence feeds of historical attack data. In other implementations, the historical attack information 1440 can include a distribution of threat intelligence for an industry. In some implementations, the deception profiler 1410 can receive a distribution of historical attacks for a data source. In other implementations, the deception profiler 1410 can determine a distribution of historical attacks for a data source.

As described above, the deception profiler 1410 can include the location engine 1412. In some embodiments, the location engine 1412 can identify a network, a subnetwork, a trunk, one or more machines, or a portion of a network as a location to deploy deception mechanisms. The location engine 1412 can identify a location to deploy a deception mechanism by computing a subnetwork importance score. The subnetwork importance score can use the network topology 1420, or a function of the network topology 1420, to compare subnetworks. In these cases, the location engine 1412 can compare asset densities, as described below, that are associated with subnetworks to identify the location with the highest score. For example, the location engine 1412 can identify a subnetwork that includes the most critical assets. In some embodiments, the subnetwork importance score can further use machine information associated with the network. For example, the subnetwork importance score can use the types of assets in a subnetwork.

In other implementations, the location engine 1412 can identify a location using a distribution of historical attacks on the network. For example, the location engine 1412 can identify a subnetwork that includes the most historical attacks on the network as a location for deploying a number of deception mechanisms.

In some implementations, the location engine 1412 can update the location of one or more deception mechanisms. For example, the location can be updated when an attack occurs on the site network. In such an example, when an attack occurs on the network, the deception profiler 1410 can determine the location where the attack occurred. In such examples, the deception profiler 1410 can detect a request to access a deception mechanism. In other implementations, the deception mechanism can send a notification to the deception profiler 1410 that a request has been received by the deception mechanism. In response to the request, the deception profiler 1410 can determine a location of the accessed deception mechanism in order to update the location of one or more of the deployed deception mechanisms using the location of the accessed deception mechanism.

In some implementations, the location engine 1412 can update the location of one or more deception mechanisms when a certain number of attacks occur on the network. For example, the location engine 1412 can determine a probability distribution of the attacks on the network. The probability distribution can statistically represent the number of attacks on a network over a time period. In some implementations, the probability distribution can include one or more types of attacks on the network. The location engine 1412 can use the probability distribution of the attacks on the network to determine a location that includes more attacks. For example, the location engine 1412 can determine that more attacks have occurred on a particular part of a network than another. In such an example, the location engine can determine to analyze the network to determine a number of deception mechanisms to deploy.

As described above, the deception profiler 1410 can include the density engine 1414. The density engine 1414 can determine the number of deception mechanisms to deploy for a site network using at least one or more of the network topology 1420, the machine information 1430, the historical attack information 1440, or a combination of this information. In some implementations, the density engine 1414 can analyze each subnetwork of the site network individually. In other implementations, the density engine 1414 can analyze a subnetwork identified by the location engine 1412. In some implementations, the density engine 1414 can use the network topology 1420, the machine information 1430, and/or the historical attack information 1440 to determine densities, summary statistics, or a combination of information.

In some implementations, the density engine 1414 can determine one or more asset densities. An asset density can be associated with a number of assets connected to the site network. In some implementations, an asset can be a critical asset. For example, the asset density can be a total number of critical assets in a portion of a site network (e.g., a subnetwork, a trunk, one or more machines, or other suitable location in the site network) divided by a total number of critical assets in the site network. The criticality of an asset can be measured in terms of information security. For example, a critical asset can include a machine that stores network data or a privileged user account that has broad access to the site network. In some implementations, a critical asset can be user-defined. In other implementations, a critical asset can be industry specific. In some implementations, an asset density can be a total number of assets (whether critical or not) in a portion of a site network (e.g., a subnetwork, a trunk, one or more machines, or other suitable location in the site network) divided by a total number of assets in the site network.

The density engine 1414 can also determine one or more summary statistics. A summary statistic can be associated with a number of historical attacks on the site network. In some implementations, the summary statistic can include a mean, median, or mode of a probability distribution of the number of historical attacks on the network. In some implementations, the probability distribution can be received by the deception profiler 1410. In other implementations, the deception profiler 1410 can determine the probability distribution. Because a summary statistic of a probability distribution is used, the probability distribution can be in a parametric form (e.g., normal distribution), a nonparametric form, or any other form that can be summarized using a mean, median, or mode.

Using the asset densities, the summary statistic, and/or some other information, the density engine 1414 can compute a mixture density model that is used to determine how many deception mechanisms to deploy. In particular the number of deception mechanisms to deploy in the network can be determined by the following equation:

$${N}_{i} = {w}_{1} * {p}_{i}^{c} ( s ) * {N}_{s} + {w}_{2} * {p}_{i} ( s ) * {N}_{s} + ( \frac{{w}_{4} * {p}_{t} ( h ) * {N}_{{h}_{t}} + {w}_{5} * {p}_{t} ( ids ) * {N}_{{ids}_{t}} + {w}_{6} * {p}_{t} ( ips ) * {N}_{{ips}_{t}}}{{N}_{s}} )$$

The above equation can be described as follows.
Nᵢ is the number of deception mechanisms to deploy in a subnetwork i;
Nₛ is the total number of subnetworks;
Nₕ_{ₜ} is the total number of historical attacks over time t as provided by an SOC or CSIRT;
N_{ids}_{ₜ} is the total number of historical attacks over time t as provided by an IDS;
Nᵢₚₛ_{ₜ} is the total number of historical attacks over time t as provided by an IPS;
w={w₁, w₂, w₃, . . . , wₙ} is a set of weights;

$${p}_{i}^{c} ( s ) = \frac{{a}_{{c}_{i}}}{{\sum }_{i = 1}^{{N}_{s}} {a}_{{c}_{i}}}$$

is the probability of placing a deception mechanism; in a subnetwork i based on critical assets, where a_{ci} is the number of critical assets;

$${p}_{i} ( s ) = \frac{{a}_{i}}{{\sum }_{i = 1}^{{N}_{s}} {a}_{i}}$$

is the probability of placing a deception mechanism in a subnetwork i based on a valuation of the assets in the subnetwork;

$${p}_{t} ( h ) = \frac{f ( {μ}_{h} )}{{N}_{{h}_{t}}}$$

is the probability of an attack over a time t based on SOC or CISRT information;

$${p}_{t} ( ids ) = \frac{f ( {μ}_{ids} )}{{N}_{{ids}_{t}}}$$

is the probability of an attack over a time t based on IDS information;

$${p}_{t} ( ips ) = \frac{f ( {μ}_{ips} )}{{N}_{{ips}_{t}}}$$

is the probability of an attack over a time t based on IPS information;
μ is a summary statistic of a probability distribution of historical attacks over a time t, where the average can be a mean, a median, or a mode; and
ƒ(x) is a math function, such as logarithm or square root.

In the above equations, it is assumed that all of the above data sources are available. If a data source is unavailable, a term associated with the data source can be dropped from the equation.

The equation above illustrates that the number of deception mechanisms to deploy in a portion of a site network (e.g., a subnetwork, a trunk, one or more machines, or other suitable location in the site network) can depend on information associated with that portion of the site network. For example, when there are more assets are on the portion of the site network, the number of deception mechanisms can increase. In another example, an increased number of attacks on one part of the network can increase the number of deception mechanisms in all portions of the site network, possibly in equal proportion to the number of attacks. In other examples, the probability distributions can be associated with a probability of an attack in a portion of a site network. In such examples, an increased number of attacks in the portion of the site network can increase the number of deception mechanisms to deploy in that portion of the site network.

The scheduling engine 1418 can determine a time to deploy a deception mechanism. In some implementations, the scheduling engine 1418 can use the historical attack information 1440 to determine the time. In other implementations, the scheduling engine 1418 can use the machine information 1430. In particular, the scheduling engine 1418 can analyze at least one or more of a connect time, a disconnect time, or a combination of times for a network devices in the network. The scheduling engine 1418 can determine a connect time and a disconnect time for a deception mechanism so as to blend a visible, or active, time of the deception mechanism with the active times of machines in the site network. The visible, or active, time of a deception mechanism can be the time that the deception mechanism is connected to the network. In some implementations, the visible time can include time that there is a threshold of activity on the network. For example, the scheduling engine 1418 can determine to connect a deception mechanism to the network before a network becomes particularly busy, and disconnect the deception mechanism after the network is has stopped being as busy.

While the connect time and disconnect time for the one or more machines on the network can be associated with an actual connect and disconnect from the network, the connect time and disconnect time for a deception mechanism can indicate when to have the deception mechanism appear to connect to and disconnect from the network. In some implementations, the deception mechanism can appear to connect and disconnect by becoming visible and invisible to a machine on the network. In other implementations, a deception mechanism can be connected to another network such that the deception mechanism is visible on the network. In such an implementation, the deception mechanism can remain connected to the other network when the deception mechanism appears to disconnect from the network.

VII. Network Threat Detection

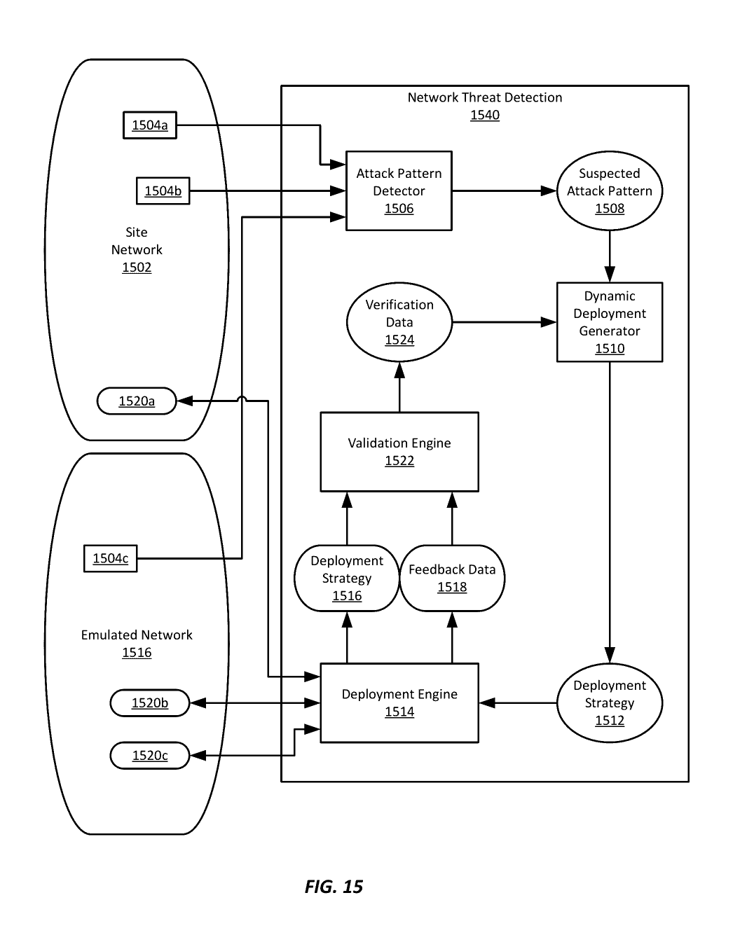

FIG. 15 illustrates an example of a network threat detection system 1540 that may be included in various implementations of a deception center. The threat detection system 1540 can use dynamic security mechanisms to locate, identify, and confirm a threat to a site network. The various components of the network threat detection system 1540 may be implemented as discreet hardware components, as software components executing on different computing systems, as software components executing on one computing system, or as a combination of hardware components and software components in one or multiple computing systems.

The threat detection system 1540 may be monitoring a site network 1502. The site network 1502 may include various interconnected network devices, including both computers and network infrastructure equipment, as well as home appliances and electronics, tools and manufacturing equipment, and other non-traditional network devices. An attack pattern detector 1506 may collect data 1504a-1504c from the site network 1502 and/or an emulated network 1516. This collected data 1504a-1504c may come from various sources, such as servers, computers devices, and network infrastructure devices in the site network 1502, and from previously-deployed deception mechanisms in the site network 1502 or in the emulated network 1516. The collected data 1504a-1504c may be structured or unstructured. The collected data 1504a-1504c may be continuously updated.

The attack pattern generator 1506 may monitor and/or analyze the collected data 1504a-1504c to determine whether a network abnormality has occurred or is occurring. In many cases, a network abnormality may fall within acceptable network usage. In other cases, the network abnormality may indicate a potential network threat. One example of a network abnormality is an access detected at a deception mechanism in the site network 1502. In some implementations, emulated network devices in the emulated network 1516 may be projected into the site network 1502 as deception mechanisms. Because the emulated network devices are not part of the normal business of the site network 1502, any access to them is automatically suspect. In various implementations, the attack pattern detector 1506 may identify or isolate the pattern of network behavior that describes the network abnormality. This pattern of behavior may be provided as a suspected attack pattern 1508 to a dynamic deployment generator 1510.

The dynamic deployment generator 1510 may analyze the suspected attack pattern 1508 and determine what should be done to confirm that an attack occurred or is in progress. The dynamic deployment generator 1510 may have access to various deceptive security mechanisms, which emulate devices that may be found in the site network 1502. The dynamic deployment generator 1510 may determine which of these security mechanisms are most likely to be attractive to the potential threat. The dynamic deployment generator 1510 may further determine how and where to use or deploy one or more security mechanisms. In some cases, the security mechanisms may be deployed into an emulated network 1516, while in other cases the security mechanisms may be deployed into the site network 1502. For example, when the suspected attack pattern 1508 indicates that a production server may have been accessed for illegitimate reasons, the dynamic deployment generator 1510 may initiate an emulated server in the emulated network 1516 that appears to be particularly vulnerable and/or to have valuable data. The emulated server may further be projected into the site network 1502 to attract the attention of the possible attacker. As another example, when the suspected attack pattern 1508 indicates that a deception mechanism has been logged into, the dynamic deployment generator 1510 may initiate emulated network devices in the emulated network 1516 that mimic production servers in the site network 1502. In this example, should the user who logged into the deception mechanism attempt to log into a production server, the user may instead be logged into an emulated version of the production server. In this example, the user's activity may be contained to the emulated network 1516.

In some implementations, the dynamic deployment generator 1510 may contact an external service, possibly located in on the Internet, for assistance in determining which security mechanisms to deploy and where to deploy them. For example, the dynamic deployment generator 1510 may contact an external security services provider. The dynamic deployment generator 1510 may produce a deployment strategy 1512 that includes one or more security mechanisms to deploy, as well as how and where those security mechanisms should be deployed.

The deployment strategy 1512 may be provided to a deployment engine 1514. The deployment engine may deploy security mechanisms 1520a-1520c into an emulated network 1516 and/or into the site into the site network 1502. In various implementations, the emulated network 1516 may emulate one or more network devices, possibly configured to resemble a real configuration of inter-connected routers and/or switches and network devices in a subnetwork. The emulated network devices may be, for example, address deception mechanisms, low-interaction deception mechanisms, and/or high-interaction deception mechanisms. In various implementations, the security mechanisms 1520b-1520c deployed into the emulated network 1516 can be projected into the site network 1516. In these implementations, the security mechanisms 1520b-1520c may function as actual nodes in the site network 1502. In various implementations, the emulated network 1516 may be hosted by a network emulator.

In various implementations, the deployment strategy 1512 may indicate where in network topology of the emulated network 1516 and/or the site network 1502 the security mechanisms 1520a-1520c are to be deployed. For example the deployment strategy 1512 may indicate that a certain number of security mechanisms 1520b-1520c should be deployed into the subnetwork where an attack appears to be occurring. These security mechanisms 1520b-1520c may be deployed into the emulated network 1516, from which they may be projected into the site network 1502 Alternatively or additionally, the deployment strategy 1512 may call for placing a security mechanisms 1520a at a node in the site network 1502 where it are most likely to attract the attention of the potential threat. Once deployed, the security mechanisms 1520a-1520c may begin collecting data about activity related to them. For example, the security mechanisms 1520a-1520c may record each time that they are accessed, what was accessed, and, with sufficient information, who accessed them. The security mechanisms 1520a-1520c may provide this data to the deployment engine 1514.

In various implementations, the deployment strategy 1512 may alternatively or additionally indicate that one or more deceptions should be escalated. For example, the suspected attack patter 1508 may indicate that a MAC or IP address for an address deception was scanned, and the deployment strategy 1512 may then indicate that the address deception should be escalated to a low-interaction deception. As another example, the suspected attack pattern 1508 may indicate that a connection attempt to a low-interaction deception was seen, and the deployment strategy 1512 may then indicate that the low-interaction deception should be escalated to a high-interaction deception.

The deployment engine 1514 may provide a deployment strategy 1516 and feedback data 1518 from the security mechanisms 1520a-1520c to a validation engine 1522. The validation engine 1522 may analyze the deployment strategy 1516 and the feedback data 1518 from the security mechanisms 1520a-1520c to determine whether an actual attack has occurred or is in progress. In some cases, the network abnormality that triggered the deployment of the security mechanisms may be legitimate activity. For example, a network bot (e.g., an automated system) may be executing a routine walk of the network. In this example, the network bot may be accessing each IP address available in the site network 1502, and thus may also access a security mechanism deployed to resemble a network device that is using a specific IP address. In other cases, however, a network abnormality may be a port scanner that is attempting to collect IP addresses for illegitimate purposes. The validation engine 1522 may use the feedback data 1518 to confirm that the activity is malicious. The validation engine 1522 may provide verification data 1524. The verification data 1524 may, in some cases, confirm that an attack has occurred or is occurring. In other cases, the verification data 1524 may indicate that no attack has happened, or that more information is needed.

The verification data 1524 may be provided to the dynamic deployment generator 1510. The dynamic deployment generator 1510 may use the verification data 1524 to dynamically adjust the deployment strategy 1512. These adjustments may be directed towards establishing more attractive traps for the potential threat, and/or towards obtaining more information about the potential threat. For example, the dynamic deployment generator 1510 may call for dynamically adjusting or changing the nature of an already deployed security mechanism 1520a-1520c. Alternatively or additionally, the dynamic deployment generator 1510 may determine that a security mechanism 1520a-1520c can be disabled or removed from the site network 1502. Alternatively or additionally, the dynamic deployment generator 1510 may cause different security mechanisms to be deployed. These changes may be reflected in the deployment strategy 1512, and may be implemented by the deployment engine 1514.

In some implementations, the adjustments to the deployment strategy 1512 may be directed towards containing an apparent threat within the emulated network 1516. For example, the verification data 1524 may indicate that an unexpected access has occurred at a deception mechanism 1520a deployed into the site network 1502. Using this information, the deployment strategy 1512 may include deploying deception mechanisms 1520b-1520c into the emulated network 1516 that mimic production systems in the site network 1502. Should an apparent attacker attempt a lateral movement from the deception mechanism 1520a where he was detected to a production system, the apparent attacker may instead be logged into a deception mechanism 1520b-1520c that mimics that production server. The apparent attacker may not be aware that his activity has been contained to the emulated network 1516. Using this deployment strategy 1512, the apparent attacker may be kept away from production systems.

The threat detection system 1540 may, using the components and data described above, determine that a network abnormality is an acceptable and legitimate use of the site network 1502, or that the network abnormality is an actual threat to the site network 1502. In some implementations, the threat detection system 1540 may also be able to take action to stop a perceived threat.

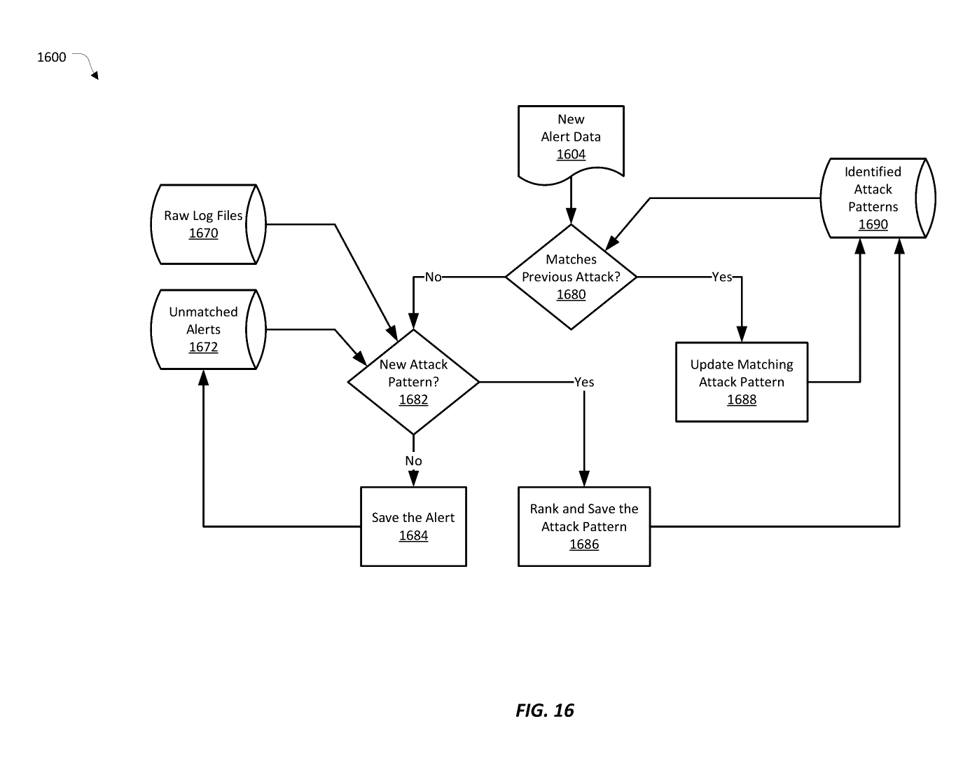

FIG. 16 illustrates an example of a process 1606 that may be implemented by an attack pattern detector to identify a pattern of behavior as a possible threat. The process 1606 may be implemented in hardware, software, or a combination of hardware and software. The attack pattern detector may include one or more integrated memory systems for storing data, or may be connected to external memory systems.

The process 1606 may receive new alert data 1604. The new alert data 1604 may include information about a network abnormality that may be a threat to the network. The new alert data 1604 may include information such as a possible identity of the source of the threat, what the nature of the threat appears to be, when the threat began or occurred, and/or where the threat occurred in the site network.

The new alert data 1604 may be examined, at step 1680, to determine whether the information provided by the new alert data 1604 matches a pervious attack. The new alert data 1604 may match a previous attack when the pattern of behavior indicated by the new alert data 1604 matches a pattern of behavior that is known to be a network threat. Previously identified attack patterns 1690 may be provided at step 1680 to make this determination. Alternatively or additionally, the new alert data 1604 may be related to a previously identified attack pattern 1690, and/or may describe behavior that is an extension of a known attack pattern.

When the new alert data 1604 matches an identified attack pattern 1690, and/or is related to an identified attack pattern, at step 1688, the matching attack pattern may be updated. Updating the matching attack pattern may include, for example, changing a ranking of the attack pattern. A ranking may indicate the seriousness of the attack pattern. For example, a more serious attack pattern may be more likely to be a real attack, and/or a higher ranking may indicate a greater need to address the attack. Alternatively or additionally, updating the matching attack pattern may include adding a location where the pattern of behavior was seen. Alternatively or additionally, updating the matching attack pattern may include, for example, describing variations on the attack pattern, alterations to the attack pattern, additional sources of this type of pattern, and so on.

When the new alert data 1604, at step 1680, does not match an identified attack pattern 1690, the process 1606 next attempts, at step 1682, to determine whether the new alert data 1604 describes a pattern of behavior that may be a new and previously unidentified threat to the network. To make this determination, various data may be provided at step 1682, such as, for example, raw log files 1670 and previously unmatched alerts 1672. Raw log files 1670 may provide additional information about the new alert data 1604 that can be used by the process 1606 to further determine whether an attack may be occurring. The previously unmatched alerts 1672 may be patterns of behavior that has previously been determined to not be an attack. The new alert data 1604 may be matched against these previously unmatched alerts 1672 to determine that the new alert data 1604 describes behavior already determined to not be an attack. Alternatively, the new alert data 1604 may indicate that a previous unmatched alert 1672 may, in fact, describe an actual attack.

Using the raw logs 1670, unmatched alerts 1672, and possibly other data, the process 1606 examine, for example, the seriousness of the behavior described by the new alert data 1604, the nature of the behavior, the source of the behavior, and so on. When it is determined, at step 1682, that the new alert data 1604 does not indicate a new attack pattern, the new alert data may be saved, at step 1684, with previously unmatched alerts 1672. When it is determined that the new alert data 1604 does, in fact, describe a new attack pattern, the new alert data may be saved, at step 1686, along with previously identified attack patterns 1690. In some cases, at step 1686, additional information may be stored with the new attack pattern data. For example, the new attack pattern may be given a rank, indicating the degree of seriousness, level of threat, and/or degree of immediacy.

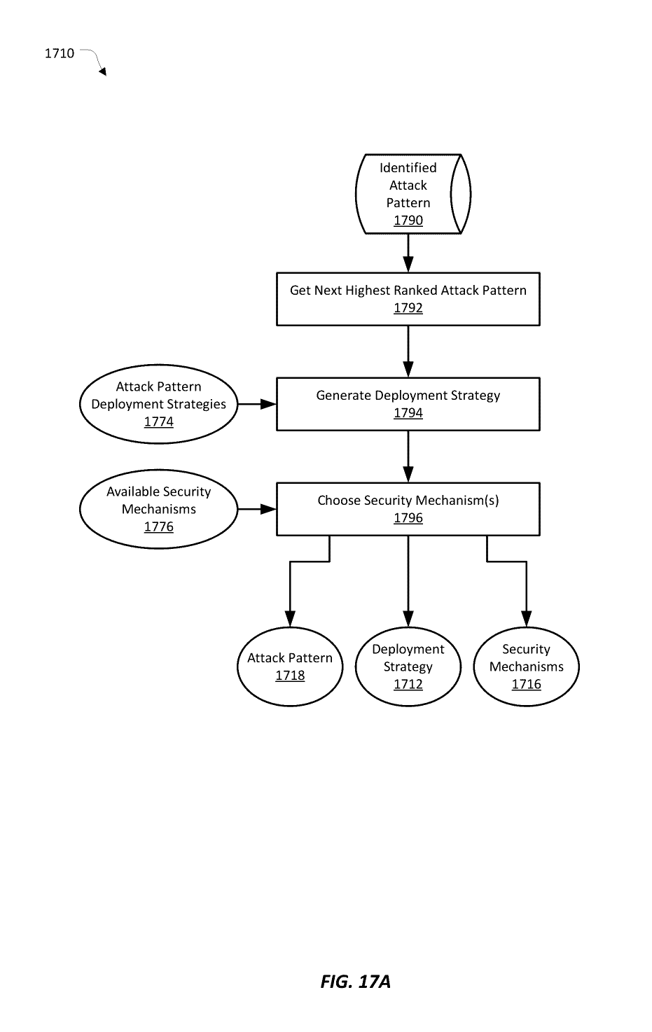

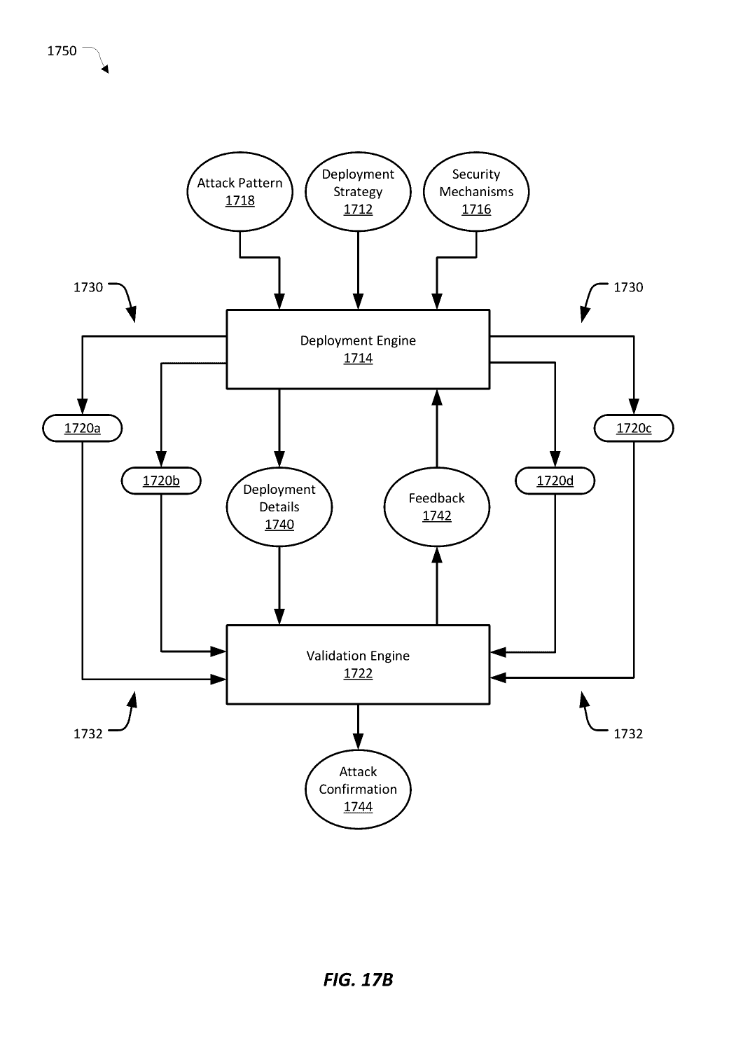

The process 1606 of FIG. 16 may identify a pattern of behavior that could be a threat to the network. The pattern, however, may only be a potential threat. FIG. 17A-17B illustrate an example of two stages of a process 1710, 1750 for confirming that the pattern of behavior is an actual threat. The process 1710 may be a first stage in an overall process for confirming a pattern as a threat, while the process 1750 may be a second stage. The process 1710 of FIG. 17A may be executed, for example, by a dynamic deployment generator. The process 1710 may be implemented in hardware, software, or a combination of hardware and software.

An identified attack pattern 1790 may be provided to the process 1710. The identified attack pattern 1790 may be produced, for example, by the process 1600 of FIG. 16. Additionally, in some cases, the process 1600 may identify multiple attack patterns simultaneously or successively, all of which may be provided to the process 1710 of FIG. 17A, or some of which may be provided while the rest are set aside for later processing. The process 1710 may, at step 1792, get the next highest ranked attack pattern. The ranking may indicate a seriousness, importance, urgency, or otherwise indicate an order in which the attack patterns should be addressed.

For the next highest ranked attack pattern, at step 1794, the process 1710 generates a dynamic deployment strategy. Pre-defined attack pattern deployment strategies 1774 may be provided at step 1794. The pre-defined attack pattern deployment strategies may include strategies that were effective against the same or similar attack patterns, or that were designed with certain attack patterns in mind. Alternatively or additionally, the process 1710 may, at step 1794 dynamically generate a deployment strategy based on prior attack pattern deployment strategies 1774, and/or the behavior described by the attack pattern. The process 1710 may not produce a deployment strategy exactly tailored for the attack pattern, and may instead produce a deployment strategy that is expected to be effective. Additionally, the process 1710 may produce more than one deployment strategy. Each of these deployment strategies may be ranked in various ways, such as their likelihood to be most attractive to the attack pattern, their impact on the network, how quickly they can be deployed, or resources required for their deployment. Each deployment strategy may be tried sequentially, or several deployment strategies, may be tried at the same time.

One example of a deployment strategy is a strategy for a port scanner attack. When the identified attack pattern 1790 indicates port scanning of a server, a deployment strategy may call for deploying one or more security mechanisms that emulate services provided by the server. One or more corresponding ports on the server may then be opened. A true port scanner attack may then attempt to access the emulated services through an open port. Alternatively or additionally, security mechanisms may be deployed outside of the server. These security mechanisms may also emulate services provided by the server, and attract the attention of the port scanner without the port scanner being able to enter the server.

Another example of a deployment strategy is a strategy for a network scanner attack. In this example, when the identified attack pattern 1790 indicates scanning of, for example, a subnet, a deployment strategy may call for deploying one or more emulated servers into the subnet. These emulated servers may resemble production servers in the subnet, and so may provide the same ports and servers as the production servers. The emulated servers, however, will monitor for network scanning activity.

Another example of a deployment strategy is a strategy for a database attack. When the attack pattern 1790 indicates unauthorized querying or copying of a database, the deployment strategy may include security mechanisms that mimic parts of the database, such as additional views or tables with artificial or artificially tainted data. The security mechanisms may report being accessed or copied, either of which indicates an attack on the database.

At step 1796, the process 1710 may select one or more security mechanisms from available security mechanisms 1776 that are called for by the deployment strategy or strategies generated at step 1796. Additionally or alternatively, at step 1796 the process 1710 may dynamically generate a security mechanism, and/or modify a security mechanism from among the available security mechanisms 1716.

The process 1710 may produce an attack pattern 1718, one or more deployment strategies 1712, and one or more security mechanisms 1716. The attack pattern 1718 may be the attack pattern that was selected at step 1792, and that is being confirmed as an actual threat. The deployment strategy or strategies 1712 may be one or more deployment strategies generated at step 1794. The security mechanisms 1716 may be the security mechanisms chosen at step 1796.

The outputs of the process 1710 may be provided to a second stage for confirming that a pattern of behavior is an actual threat. FIG. 17B illustrates an example of a process 1750 that may be used for the second stage. The process 1750 may be implemented in hardware, software, or a combination of hardware and software.

The process 1750 may receive an attack pattern 1718, one or more deployment strategies 1712, and one or more security mechanisms 1716. The attack pattern 1718, deployment strategies 1712, and security mechanisms 1716 may be provided by a first stage of the process to confirm an attack pattern as an actual threat, such as the process 1710 illustrated in FIG. 17A. In FIG. 17B, the attack pattern 1718 describes a pattern of behavior that is being verified to determine whether it is an actual attack. The deployment strategies 1712 describe one or more plans for verifying that the pattern is a threat, including a selection of one or more dynamic security mechanisms and a plan for where in the network to deploy them. The security mechanisms 1716 may be the processes and/or data that are to be deployed.

A deployment engine 1714 may receive the attack pattern 1718, deployment strategies 1712, and security mechanisms 1716, and may deploy 1730 one or more security mechanisms 1716, using one or more of the deployment strategies 1712. As noted above, the deployment engine 1714 may try different deployment strategies sequentially, or may try several deployment strategies concurrently. The deployment engine 1714 may also be configured to dynamically react to changing conditions in the network. For example, the attack pattern 1716 may describe a user whose credentials are suspect. In this example, the deployment engine 1714 may automatically deploy security mechanisms 1716 when the suspect user logs in. Furthermore, the deployment engine 1714 may also be configured to remove the security mechanisms 1716 when the user logs out. As another example, the deployment engine 1714 may launch additional security mechanisms configured to contain the suspect user within an emulated network. The deployment engine 1714 may provide deployment details 1740 to a validation engine 1722, where the deployment details 1740 may include, for example, the attack pattern 1718 and the deployment strategy 1716.

In some implementations, the validation engine 1722 may attempt to determine whether the attack pattern 1718 is, in fact, a real attack. Deployed security mechanisms 1720a-1720d may provide data 1732 about activity around them or related to them to the validation engine 1722. This data 1732 may indicate, for example, no activity, suspect activity, or confirmed activity. In some cases, the data 1732 may indicate that the deployment strategy may be more effective if adjusted. The validation engine 1722 may provide this feedback 1742 to the deployment engine. The deployment engine 1714 may take actions such as a real-time, dynamic modification of a deployed security mechanism 1720a-1720d, removing a deployed security mechanism 1720a-1720d, and/or deploying different security mechanisms.

In some cases, data from deployed security mechanisms 1720a-1720d may also be provided to one or more other systems. These other systems may be able to provide additional information about the attack pattern 1718. In some cases, these other systems may be able to address the threat, for example by blocking access to the network, revoking authentication, or terminating processes.

Ultimately, the validation engine 1722 may provide an attack confirmation 1744. An attack confirmation 1744 may confirm that the attack pattern 1718 is an actual attack. An attack confirmation 1744 may be brought to the attention of a human network administrator. Alternatively or additionally, an attack confirmation 1744 may be sent to network security systems that may be able to address the threat. In some cases, the validation engine 1722 may instead determine that the attack pattern 1718 was not an actual attack. Yet, in other cases, the validation engine 1722 may not come to a conclusion, in which case the attack pattern 1718 may be marked for continuing observation.

In some implementations, the network security system described above may also be configured to react to an attack confirmation 1744 by attempting corrective action against the attack. For example, the system may block the IP address that appears to be the source of the attack, or attempt to trace the attack to the source. Alternatively or additionally, the system may provide tainted data to the attacker, thereby possibly disabling the attacker's own system. Alternatively or additionally, the system may provide traceable data to the attacker. Traceable data may enable the system or others to track the attacker's movements in the network. In some implementations, tracking data may provide up-to-date information that may be used to dynamically change or modify an existing deployment strategy, or to deploy a new deployment strategy. Alternatively or additionally, the system may make information about the attacker public, such as for example in the anti-virus community, on anti-hacker forums, or through mass media outlets.

VIII. Threat Analysis

In various implementations, a deception center may be provided with a targeted threat analysis engine to analyze suspect network traffic. When suspect network traffic is received by a emulated network in the deception center, the emulated network may record results from conducting static, dynamic, and/or network analysis of the suspect traffic. The emulated network may be configured to record data over the course of an incident. An “incident” is an attack or suspected attack on a network. The emulated network may be configured to record data for an incident from the time a suspected attack is detected until the suspected attack is terminated.

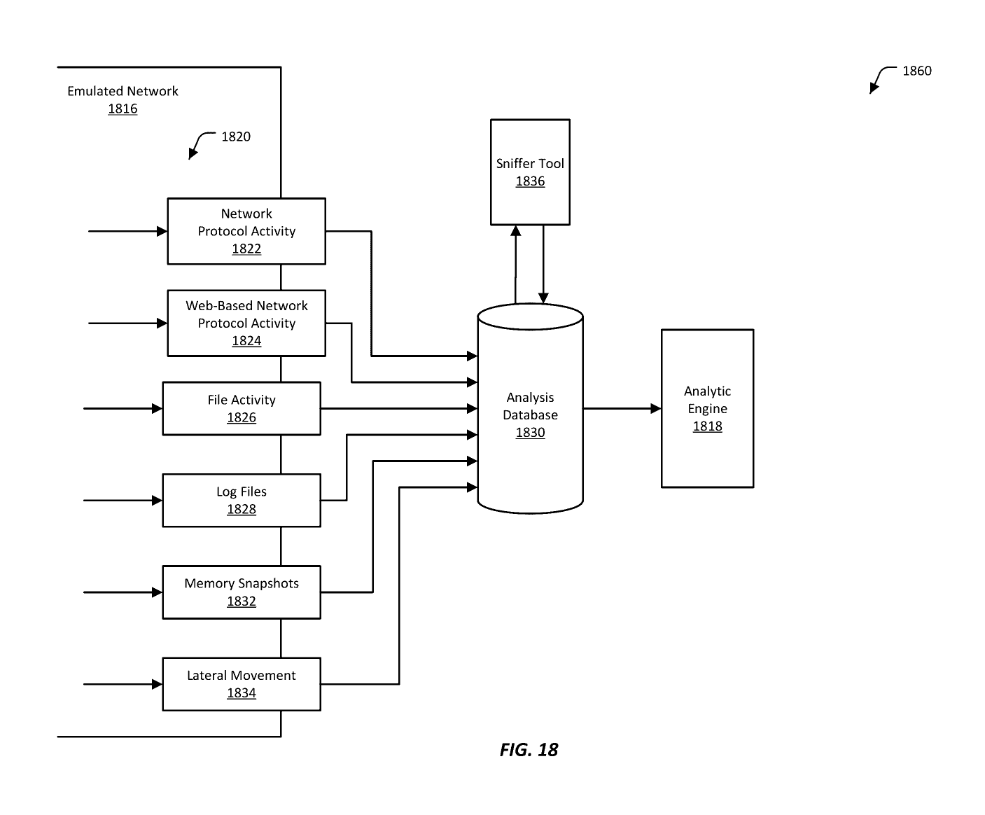

FIG. 18 illustrates examples of the data 1820 that may be collected over the course of an incident from processes and monitoring tools analyzing suspect network traffic in a emulated network 1816. FIG. 18 further illustrates that, in some implementations, the threat intelligence engine may include an analysis database 1840 that serves as a repository for the data 1820 collected in the emulated network 1816. In some implementations, the threat intelligence engine may include a sniffer tool 1834, for prioritizing and filtering the data collected in the analysis database. The threat intelligence engine may provide data from the analysis database to the analytic engine 1818, where the data can be analyzed.

In various implementations, the data 1820 collected from the emulated network 1816 may include network protocol activity 1822, web-based network protocol activity 1824, file activity 1826, log files 1828, memory snapshots 1830, and captured lateral movement 1832. These types of data 1820 are provided as examples of the type of data that may be collected, and other types of data may be collected, based on what data is available and what data is desired.

Network protocol activity 1822 may include network traffic related to various networking protocols. Network traffic associated with network protocol activity 1822 may include network traffic coming into a customer network and/or network traffic going out of the customer network. This network traffic can include, for example, email, DNS requests for servers other than web servers, SMB traffic originating inside the customer network and accessing servers outside the customer network or originating outside the customer network and accessing servers inside the customer network, and/or FTP traffic that is unrelated to webpage content, among other things. Network protocol activity 1822 may be captured by, for example, network packet monitoring tools or in log files.

Web-based network protocol activity 1824 may include network traffic associated with accessing websites. The websites being accessed may be located on web servers located outside the customer network; that is, external web sites being accessed by a user inside the customer network. The websites being accessed may alternatively or additionally include websites hosted by the customer network itself, and being accessed by a user either inside or outside the customer network. Web-based network traffic may include, for example, DNS packets requesting the IP address of a website, Hyper-Text Transfer Protocol (HTTP) packets for transferring webpages, file transfer protocol (FTP) packets for transferring webpage content, such as image files, and/or packets exchanging user authentication information. Web-based network protocol activity 1824 may be captured by, for example, network packet monitoring tools or in log files.

In various implementations, web-based network protocol activity 1824 may be included within the network protocol activity 1822.

File activity 1826 may include information learned from static analysis of files found in the content of suspect network traffic. File activity 1826 can include, for example, the output of virus scans, a description of contents of files, components such as macros and scripts extracted from files, results from opening files, and/or results from deconstructing files (e.g., compiling or decompressing the file), among other things. File activity 1826 may be captured by processes executing the static analysis. File activity 1826 may also be captured by the testing device executing the static analysis, which may produce, for example, the output of virus scanners, de-compilers, emulators, and so on.

Log files 1828 include log files produced during dynamic analysis of the contents of suspect network traffic. These log files may be generated, for example, by the emulated system that is the release point for the contents of the suspect network traffic. These log files may include, for example, log files that are typically generated by an operating system. These log files capture information such as operating system kernel activity, user-level application programming interface activity, user log in attempts, and commands entered by a user, among many others. The log files 1828 may also include the output of processes specifically monitoring calls made from the release point to other devices in the emulated network 1816. These log files may capture information such as downloading of files from outside the customer network, uploading files from the customer network to an outside server, creating, deleting, copying, modifying, moving, decrypting, encrypting, decompressing, and/or compressing files, and network traffic to other devices, such as login attempts and port scanning. In various implementations, log files deemed interesting (which may include all log files generated by devices emulated in the emulated network 1816) are provided to the analysis database 1840.

Memory snapshots 1830 may be taken at various times over the course of an incident. For example, the emulated network 1816 may take before and after snapshots of emulated memory structures in the emulated network 1816. For example, real servers, workstations, routers, and other network devices typically include some memory. In some implementations, the emulated network 1816, when emulating these devices, may also emulate any memory that they include. The emulated network 1816 may further produce snapshots of each memory before suspect network traffic is analyzed, as well as after. A memory snapshot is a copy of the contents of a memory. In some implementations, the emulated network 1816 may alternatively or additionally produce memory snapshots of the test devices being used to create the emulated network 1816. As discussed above, the emulated network 1816 is built from physical equipment, such as a rack of servers, which has its own memory. This memory may be captured in snapshots at various intervals, particularly during the analysis of suspect network traffic. Alternatively or additionally, the emulated network 1816 may take memory snapshots 1830 during the course of dynamic analysis of files. For example, the emulated network may take a memory snapshot 1830 during the execution of a file. This memory snapshot may provide some insight into the contents of the file.

Lateral movement 1832 is, as described above, the movement of an attack from one network device to another. Lateral movement 1832 may be captured, for example, as a trace of activity among multiple devices emulated in the emulated network 1816. In some implementations, lateral movement 1832 may be extracted from network protocol activity 1822, web-based network protocol activity 1824, file activity 1826, and/or log files 1828. For example, file activity 1826 may show downloading of malware and log files 1828 may capture login attempts. Lateral movement 1832 data may put this information together and provide a cohesive description of an attack.

As noted above, the data 1820 extracted from the emulated network 1816 may be accumulated in an analysis database 1840. In some implementations, the threat intelligence engine may include a sniffer tool 1834. In these implementations, the sniffer tool 1834 may prioritize and filter the data stored in the analysis database 1840. For example, the sniffer tool 1834 may generate alerts upon finding particularly suspect information (e.g., by finding a digital signature for the information on a blacklist). As another example, the sniffer tool 1834 may identify data known to be safe (e.g., because a digital signature for the data or a domain extracted from the data can be found on a whitelist), and remove this data from the analysis database 1840. As another example, the sniffer tool 1834 may extract files out of network packets. As another example, the sniffer tool 1834 may generate digital signatures for files, packets, or other data in the analysis database 1834. As another example, the sniffer tool 1834 may trim routine information from log files, so that the log files record primarily suspect activity. As another example, the sniffer tool 1834 may organize related information together, such as for example putting together network traffic and log files related to lateral movement. In some implementations, the sniffer tool 1834 may thus serve to reduce the volume of data that may need to be analyzed.

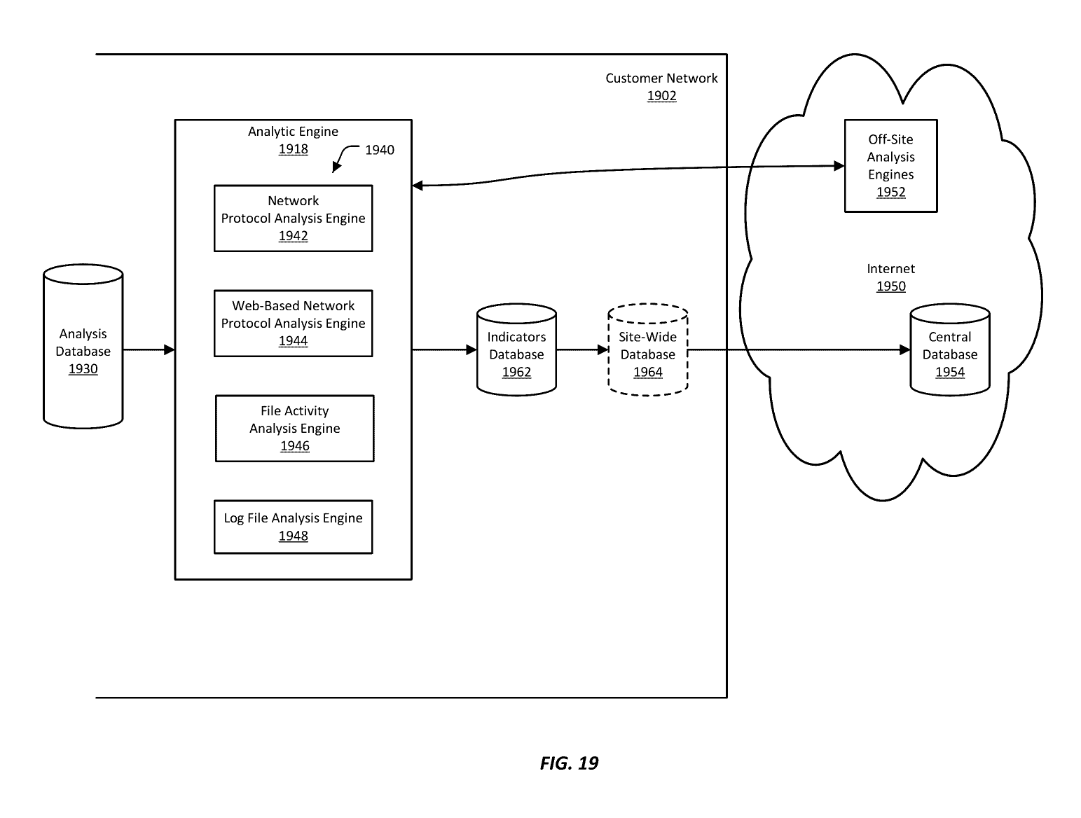

The contents of the analysis data base 1840 may be provided to the analytic engine 1818 for detail analysis. FIG. 19 illustrates an example of the operations of an analytic engine 1918. In various implementations, the analytic engine 1918 may include multiple analysis engines 1940. Each analysis engine 1940 may analyze a different type of data stored in an analysis database 1940. Generally, each analysis engine 1940 may apply one or more of heuristic algorithms, probabilistic algorithms, machine learning algorithms, and/or pattern matching algorithms, in addition to emulators, to detect whether data (e.g., files, email, network packets, etc.) from the analysis database 1940 is malicious. Each analysis engine 1940 may further include sub-modules and plugins, which are also able to apply heuristic, probabilistic, machine learning, and/or pattern matching algorithms, as well as emulators, to determine whether some data is malicious. In various implementations, the analysis engines 1940 may be configured to operate in parallel, such that the analytic engine 1918 is able to analyze many types of data at the same time. In some implementations, the analytic engine 1918 may have additional analysis engines 1940 not illustrated here. In some implementations, the analytic engine 1918 may have fewer analysis engines 1940, depending on what is required for a particular implementation.

In this example, the analytic engine 1918 includes a network protocol analysis engine 1942, a web-based network protocol analysis engine 1944, a file activity analysis engine 1946, and a log file analysis engine 1948. As discussed in further detail below, each of these analysis engines 1940 processes a different type of data from the analysis database 1940. The network protocol analysis engine 1942 processes results from network and dynamic analysis of network traffic. The web-based network protocol analysis engine 1944 processes results from network analysis of network traffic related to access of websites. The file activity analysis engine 1946 processes data captured during static analysis of the content of suspect network traffic. The log file analysis engine 1948 processes log file data. In some implementations, the analysis engines 1940 may, also work together to analyze data from the analysis database 1940. For example, file activity analyzed by the file activity analysis engine 1946 may be correlated against network activity analyzed by the web-based network protocol analysis engine 1944 and the network protocol analysis engine 1942 to produce a network history of lateral movement of an attack. As further example, information provided by the network analysis may be searched for, by the log file analysis engine 1948, to provide an activity trace of lateral movement. In some implementations, the various analysis engines 1940 may be combined into fewer analysis engines, or may be divided into additional sub-engines. For example, in some implementations, the network protocol analysis engine 1942 may also analyze web-based network traffic.

In various implementations, analysis engines 1940 may each produce indicators that describe the data that each analyzes, which may be stored in an indicators database 1962. Indicators describe the suspect network associated with data analyzed by the analysis engines 1940. For example, the network protocol engine 1942 may produce indicators that the describe the source and destination of HTTP-based packets, a description of the webpages associated with the packets, as well as any malicious content downloaded as a result of the HTTP packets. As another example, the network protocol analysis engine 1942 may produce indicators describing SMB packets that uploaded files that should not have left the customer network 1902. As another example, the file activity analysis engine 1946 may provide indicators describing files storing credentials that where modified. As another example, the log file analysis engine 1948 may produce indicators that describe repeated, and thus suspect, login attempts.

In various implementations, the analysis engines 1940 produce static, file, and network indicators that describe and/or identify an threat posed by suspect network traffic, or lack of a threat, if no threat is found. For example, in some implementations, a threat associated with specific suspect network traffic may be identifiable by a name, which is included in an indicator. The indicators may further include information such as timestamps, indicating a start and/or end of the attack, and/or a weight, indicating the severity of the attack, and/or contextual information about the attack, such as the type of network exchanges made during the attack. In some implementations, suspect network traffic that is harmless may also be provided with indicators. In these implementations, the indicators may include a weight value that indicates that the network traffic is harmless.

In some implementations, the analytic engine 1918 may also provide data from the analysis database 1940 to off-site analysis engines 1952, located outside the customer network 1902. Off-site analysis engines 1952 are additional analysis engines that are hosted by a central service located on the Internet 1950. The central service may have analysis engines that the analytic engine 1918 does not have, or does not yet have. For example, central server may have off-site analysis engines 1952 that are more up-to-date, and/or may have off-site analysis engines 1952 that are newer. In some cases, newer off-site analysis engines 1952 may be in a testing phase, prior to being provided to the customer network 1902. The off-site analysis engines 1952 may provide indicators back to the analytic engine 1918. The analytic engine 1918 may add these indicators to the indicators database 1962.

In some implementations, the indicators database 1962 may further provide indicators to a site-wide database 1964. As noted above, the customer network 1902 may include a site-wide database 1964 when the customer network 1902 includes more than one site network. Each site network may be provided with their own threat intelligence engine. Each threat intelligence engine may provide indicators for their analytic engines to the site-wide database 1964.

In some implementations, the indicators database 1962 may provide indicators to a central database 1954, located on the Internet 1950. In implementations that include a site-wide database 1964, the site-wide database 1964 may provide indicators for all of the customer network 1902 to the central database 1954. The central database 1954 is a central repository for indicators that describe suspect network traffic. The central database 1954 may collect indicators from multiple customer networks. The central database 1954 may also share indicators between customer networks. Sharing indictors between customer networks may make all of the customer networks more secure. For example, another customer network may have seen an attack that the illustrated customer network 1902 has not yet experienced. The customer network 1902 may use indicators from the other customer network to improve its network security infrastructure, and thereby possibly improving is defenses against the same attack.

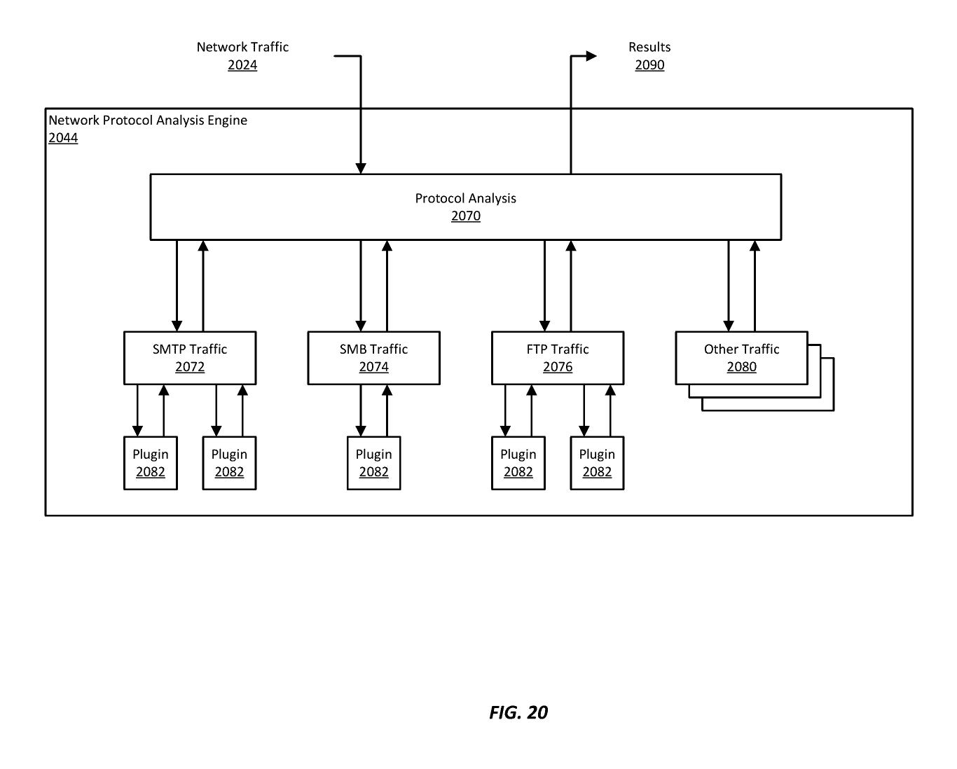

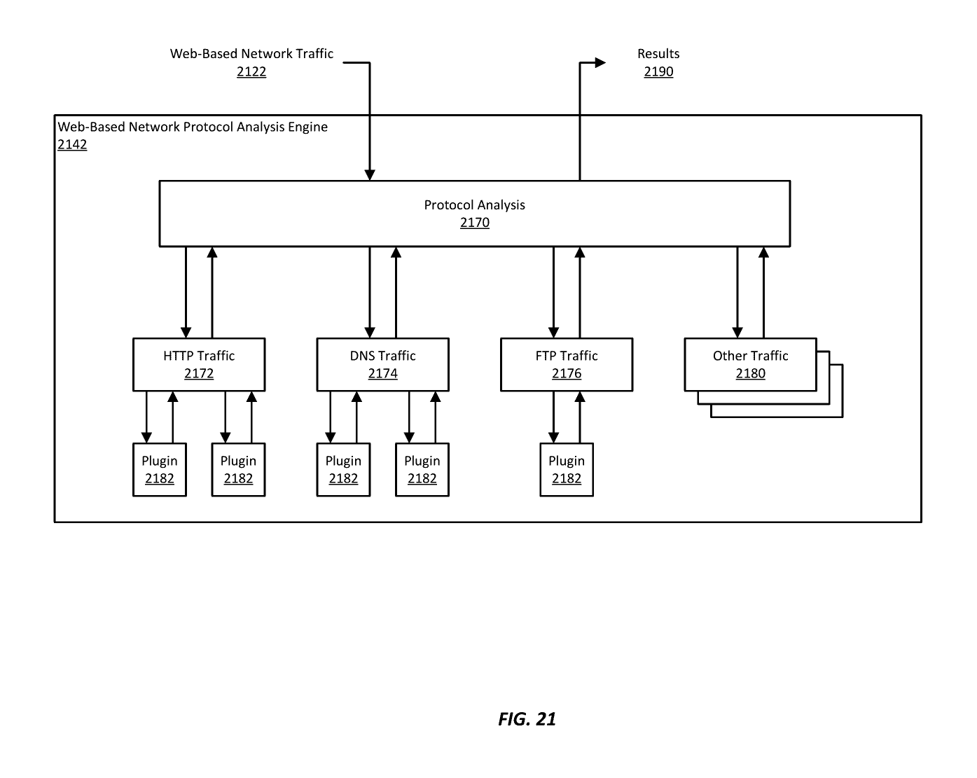

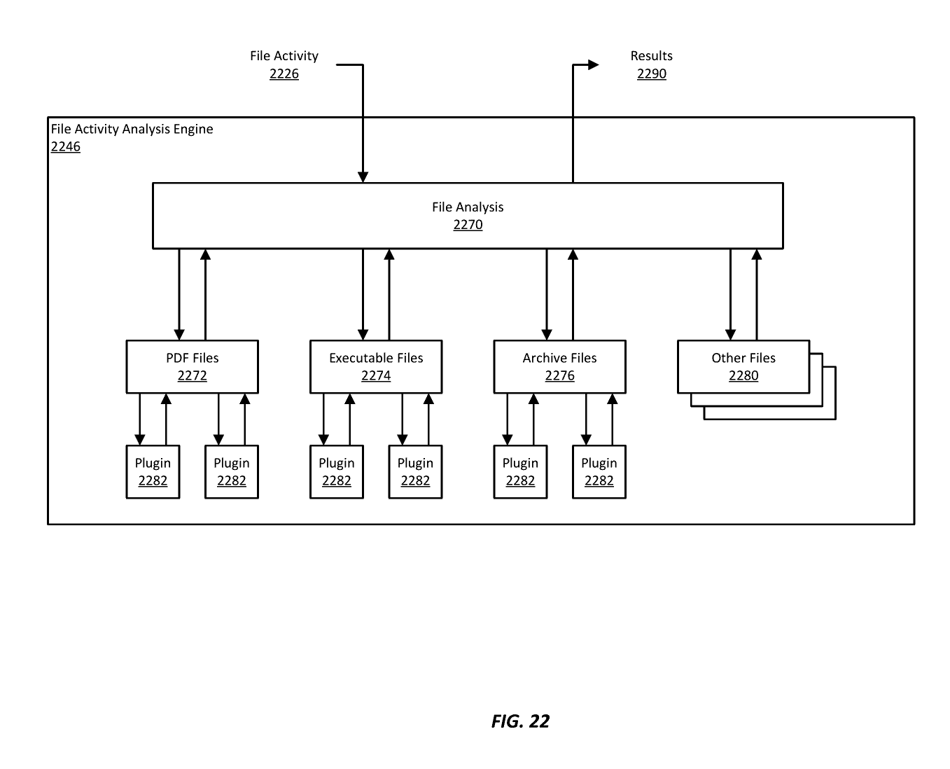

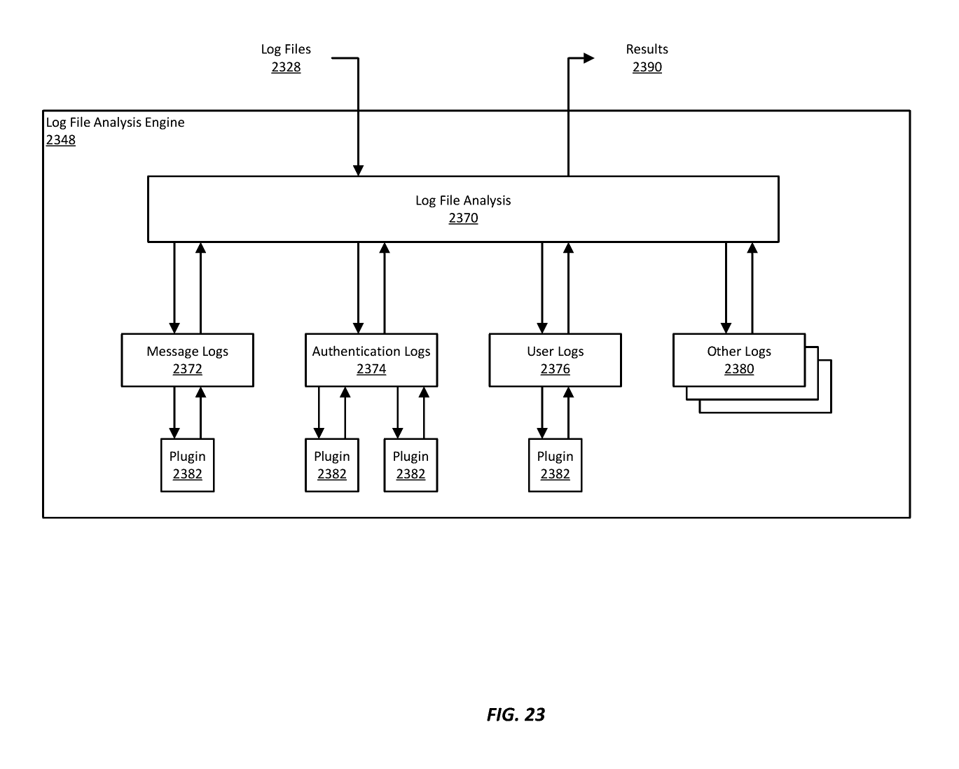

FIGS. 20-23 illustrate examples of the structure and processes of the analysis engines 1940 illustrated in the example of FIG. 19. FIG. 20 illustrates an example of a network protocol analysis engine 2044; FIG. 21 illustrates an example of a web-based network protocol analysis engine 2142; FIG. 22 illustrates an example of a file activity analysis engine 2246; and FIG. 23 illustrates an example of a log file analysis engine 2348.

FIG. 20 illustrates an example of a network protocol analysis engine 2044. The network protocol analysis engine 2044 may analyze network traffic associated with network protocols, in some cases including web-based network protocols. Analyzing non-web-based network traffic separately from web-based network traffic may be beneficial because non-web-based network traffic may use network protocols unrelated to web-based network traffic. Additionally, non-web-based network traffic may be received at different rates, may be used differently, and may harbor different kinds of threats. In various implementations, however, web-based network traffic is analyzed by the network protocol analysis engine 2044, along with non-web-based network traffic. In these implementations, the network protocol analysis engine 2044 can provide comprehensive analysis of the network traffic.

This example network protocol analysis engine 2044 is also arranged modularly and hierarchically. A protocol analysis 2070 receives other network traffic 2024, and may conduct a first stage analysis of the network traffic 2024. For example, the protocol analysis 2070 may identify a network protocol associated with a packet or stream of packets. The protocol analysis 2070 may then invoke a sub-module designed to analyze packets for the identified network protocol. In this example, the network protocol analysis engine 2044 includes sub-modules for Simple Mail Transfer Protocol (SMTP) traffic 2072 (e.g., email), Server Message Block (SMB) traffic 2074 (e.g. resource sharing packets), and FTP traffic 2076. The sub-modules may each be assisted by one or more plugins 2082. The network protocol analysis engine 2044 may also include sub-modules for other traffic 2080 (e.g. FTP, Trivial File Transfer Protocol (TFTP), Remote Desktop Protocol (RDP), Internet Message Access Protocol (IMAP), DNS. DHCP, Transparent Network Substrate (TNS), Lightweight Directory Access Protocol (LDAP), etc.). These other sub-modules may analyze traffic for other network protocols, including ones that are currently known and not illustrated here, and ones that will be developed in the future.

The SMTP traffic 2072 sub-module analyzes suspect email. The SMTP traffic 2074 sub-module may, for example, examining email headers to look for patterns known to be associated with malicious email. The SMTP traffic 2074 sub-module may also examine email content to look for malicious attachments and/or links. The SMTP traffic 2074 sub-module may provide a determination to the protocol analysis 2070 that indicates whether some email was malicious or not, or whether it could not make a determination. The determination from the SMTP traffic 2074 sub-module may be based on its own analysis, or on the analysis of one or more plugins 2082, or on a combined analysis.

The SMB traffic 2074 sub-module analyzes packets associated with shared access to files, printers, ports, and miscellaneous communications between devices in a network. SMB packets may also provide an authenticated inter-process communication mechanism. The SMB traffic 2074 sub-module may examine SMB packets and look for unauthorized accesses to shared resources or unauthorized communications. The SMB traffic 2074 sub-module may provide a determination to the protocol analysis 2070 as to whether some SMB traffic was malicious, not malicious, or possibly malicious. The SMB traffic 2074 sub-module's determination may be based on its own analysis, or on the analysis of one or more plugins 2082, or on a combined analysis.

The FTP traffic 2076 module analyzes network traffic associated with the transfer of data using FTP. Communications using FTP typically involve establishing a communication channel between a client machine and a server machine. The client machine can issue commands to the server machine, and upload files to the server machine or download files from the server machine. The FTP traffic 2076 sub-module may analyze FTP-related network traffic, and attempt to determine whether any of the traffic uploaded files that were not authorized to be uploaded or downloaded malicious files. The FTP traffic 2076 module also attempt to determine whether the FTP communication channel was validly established. Some FTP servers may allow users to connect anonymously, while others require a username and password to establish a connection. The FTP traffic 2076 sub-module may provide a determination to the protocol analysis 2070 that indicates whether some FTP traffic was malicious, was not malicious, was harmless, or that the traffic's maliciousness could not be determined. The FTP traffic 2076 sub-module's determination may be based on its own analysis, the analysis of one or more plugins 2082, or a combined analysis.

The protocol analysis 2070 may use the determinations made by the sub-modules and/or their attached plugins 2082 and generate indicators 2090 that describe the other network traffic 2024. These indicators 2090 may be referred to as network indicators. These indicators 2090 may describe the behavior of the other network traffic 2024, may identify network traffic associated with a particular behavior, and/or may indicate whether some network traffic is or is not a threat. For example, the indicators 2090 generated by the other network protocol analysis engine 2044 may include source and destination addresses for the other network traffic 2024, descriptions of any files found in the network traffic, and/or any usernames associated with the network traffic, among other things. In some implementations, the indicators 2090 may indicate that some other network traffic 2024 is or is not a threat. In some implementations, the indicators 2090 may include a weight value that indicates a probability that some other network traffic 2024 is a threat.

FIG. 21 illustrates an example of web-based network protocol analysis engine 2142 implemented in a modular fashion. A modular implementation may provide both flexibility and scalability. Flexibility is provided because the web-based network protocol analysis engine 2142 can be reconfigured based on the web-based network traffic 2122 that is received Scalability is provided because modules for new types of web-based network traffic can be added, in some cases without needing to rebuild the web-based network protocol analysis engine 2142.

In this example, the web-based network protocol analysis engine's 2142 modules are arranged hierarchically. The first level of analysis is protocol analysis 2170. The protocol analysis 2170 gets or receives web-based network traffic 2122. The protocol analysis 2170 may get data (a “push” data model) or fetch data (a “pull” data model). In some implementations, the web-based network traffic 2122 may already be organized into packet streams. A packet stream is a series of related packets that have the same source and destination. For example, the packets that form a video being streamed from a host to a viewer's device would be considered a packet stream.

The protocol analysis 2170 may make an initial examination of the web-based network traffic 2122. Among other things, the protocol analysis 2170 may determine the web-based network protocol that each packet or packet stream is associated with. The protocol analysis 2170 may then invoke the appropriate sub-module for the network protocol type, and direct packets associated with that protocol to the sub-module. In this example, the web-based network protocol analysis engine 2142 has at least three sub-modules: one for HTTP traffic 2172, one for DNS traffic 2174, and one for FTP traffic 2176. The web-based network protocol analysis engine 2142 may have additional sub-modules for other traffic 2180, where these sub-modules are focused on packets that use network protocols not explicitly illustrated here. The functionality of the web-based network protocol analysis engine 2142 can also be expanded by adding more sub-modules for yet more web-based network protocols.

Each of the sub-modules analyze packets associated with their protocol type and attempt to determine whether the packets can cause harm to a network. For example, the HTTP traffic 2172 sub-module may match website addresses against “black lists” and “white lists.” Black lists include lists of websites and/or website content that is known to be malicious, compromised, or are otherwise associated with web content known to cause harm. Black lists may include website domain names, IP addresses, Uniform Resource Locators (URLs), and/or hashes of malicious files. The HTTP traffic 2172 sub-module may also match web site content (such as files and images) against black lists. White lists include lists of websites and/or website content that is known to be safe and uncompromised. Black lists and white lists may change dynamically, as when a previously safe website becomes compromised, or as a compromised website is recovered, or as websites are shut down and removed from the Internet. HTTP traffic associated with a website on a black list may be marked as malicious, while HTTP traffic associated with a white list may be marked as clean.

As another example, the DNS traffic 2174 sub-module may also match domain names against black lists and white lists. DNS traffic typically includes requests to translate domain names to IP addresses. A DNS request may be for a domain that is hosted by the customer network, or may be for a domain that is outside the customer network but that the customer network's DNS server knows about. A malicious DNS request may, for example, be attempting to obtain an IP address for an internal website that is not publicly available. The DNS traffic 2174 sub-module attempts to determine whether suspect DNS requests may be malicious or are acceptable.

As another example, the FTP traffic 2176 sub-module may examine packets that contain website content that were transferred using FTP. FTP provides one way to transfer images, files, and/or multi-media content associated with webpages. The FTP traffic 2176 sub-module may examine web-based FTP traffic and determine whether the traffic includes any malicious content, or whether the content is innocuous.

The functionality of the sub-modules may also be expanded with plugins 2182. A plugin is a module that can be added to or removed from a sub-module without having to rebuild the sub-module and often while the sub-module is running. Here, plugins provide the ability to quickly add functionality to a sub-module. For example, in some implementations, the HTTP traffic 2172 sub-module may be unable to determine whether some packets are malicious or safe. In these implementations, the HTTP traffic 2172 module may invoke one or more plugins 2182, which may each operate on the packet in a different way. For example, one plugin 2182 may access black lists located on the Internet. These black lists may be public black lists, or may be black lists maintained along with off-site analysis engines. As another example, another plugin 2182 may access a public database of known bad websites, such as one hosted by Google®. The DNS traffic 2174 sub-module and FTP traffic 2176 sub-module may also have plugins to expand their functionality. Plugins also provide a way to add new or up-to-date functionality to the sub-modules. The sub-modules can also be updated by providing an updated web-based network protocol analysis engine 2142, which may require rebuilding the web-based network protocol analysis engine 2142. Plugins, however, may provide for faster, less intrusive, and/or intermediate updates between updates of the web-based network protocol analysis engine 2142 itself

The plugins 2182 may each produce a determination of whether a packet or group of packets is malicious or clean. A plugin 2182 may also indicate that it was unable to make a determination. In this example, the sub-modules receive the results from their associated plugins 2182. The sub-modules provide a determination, either their own or one made by their plugins 2182, to the protocol analysis 2170. The protocol analysis 2170 may use the determination from a sub-module to produce indicators 2190. These indicators 2190 may be referred to as network indicators. As noted above, these indicators 2190 may describe and/or identify network traffic associated with a threat. For example, the indicators 2190 generated by the web-based network traffic may include the domain names, URLs, and/or IP addresses of websites accessed, a description of the websites, a description of content downloaded from the websites, and/or the IP address of the computer that requested the website content, among other things. The indicators 2190 may indicate definitively that some network traffic is a threat or may indicate definitively that some network traffic is not a threat. Alternatively or additionally, the indicators 2190 may provide a weight value that indicates the probability that some network traffic is a threat. For example, a weight value of “100” may indicate a 100% probability that some network traffic is a threat, while a weight value of “0” may indicate that the network traffic is not a threat. Furthermore, any weight value between “0” and “100” may indicate the relatively probability that some network traffic is a threat.

FIG. 22 illustrates an example of a file activity analysis engine 2246. The file activity analysis engine 2246 analyzes the result of static analysis of the contents of suspect network activity. For example, the file activity analysis engine 2246 may examine results from opening the contents, applying virus scans to the content, and/or deconstructing the content, among other things. By examining these results, the file activity analysis engine attempts to determine whether the content can cause harm to a network.

This example file activity analysis engine 2246 is also arranged modularly and hierarchically. A file analysis 2270 receives file activity 2226, and may conduct a first stage analysis of the file activity 2226. For example, the file analysis 2270 may include black lists for files known to be malicious. In some implementations, the black lists may store digital signatures of malicious files. These digital signatures may be generated by, for example, the MD5 algorithm, Secure Hash Algorithm 1 (SHA-1), or SHA-2, among others. The file analysis 2270 may compare files found in suspect network traffic against signatures in the black lists. The file analysis 2270 may also check files against white lists. White lists may include files that are known to be safe. White lists may also store digital signatures of files. Files found in suspect network traffic that match signatures in white lists can be assumed to be safe.

The file analysis 2270 may also or alternatively determine the file type for a file extracted from suspect network traffic, and invoke a sub-module for analyzing files of that type. In this example, the file activity analysis engine 2246 includes sub-modules for analyzing portable document format (PDF) files 2272, executable files 2274, and archive files 2276. The sub-modules may each be assisted by one or more plugins 2282. The file activity analysis engine 2246 may include sub-modules for analyzing other files 2280 of types not illustrated here, and also for analyzing activity related to certain files, such as password files and sensitive data files.

The PDF files 2272 sub-module analyzes files formatted in PDF or that appear to be formatted in PDF. PDF is a popular format for transferring documents across networks. Thus sending PDF files in network traffic is fairly common. Hacking tools, however, can be embedded into seemingly innocent PDF files. The PDF files 2272 sub-module may attempt to determine whether a PDF file is malicious or harmless. For example, the PDF files 2272 sub-module may be able to detect malicious obfuscation in a PDF file, and/or whether a PDF file includes a shell script. The PDF files 2272 sub-module may provide its determination, or the determination made by a plugin 2282, or a combined determination, to the file analysis 2270.

The executable files 2274 sub-module analyzes executable files and files that appear to be executable. Executable files are programs that can be run on a computer. Viruses and other malware can be delivered into a network using executable files. Once launched, an executable file may have some privileges to make changes to a computer that it is launched on. Malware may take advantage of these privileges, and once launched, may exploit vulnerabilities in a computer's security infrastructure. The executable files 2274 sub-module may attempt to identify an executable file, and/or identify what an executable file does. Using this and other information, the executable files 2274 sub-module may attempt to determine whether the executable file is malicious. The executable files 2274 sub-module may provide its determination, or a determination of one of or more of its plugins, or a combined determination to the file analysis 2270.

The archive files 2276 sub-module analyzes archive files. Archive files are containers for other files, and provide a convenient way to transfer groups of files and/or large files. The files contained in an archive file may have been compressed and/or encrypted. The archive files 2276 sub-module may attempt to determine what is contained in an archive file, and whether the contents are malicious. The archive files 2276 sub-module may decompress and/or decrypt an archive file. In some cases, the archive files 2276 sub-module may pass the contents of an archive to the file analysis 2270, which may pass the contents to another sub-module. The archive files 2276 sub-module may provide its determination (or that of one or more of its sub-modules) to the file analysis 2270.

The file analysis 2270 may use the determinations made by the sub-modules and/or their attached plugins 2282 to generate indicators 2290 that describe the file activity 2226. These indicators 2290 may be referred to as file indicators. These indicators 2290 may describe and/or identify the analyzed files. For example, the indicators 2290 may include file types, components extracted from files, results from applying virus scanning and other tools to the files, results from opening or executing a file, results from deconstructing and analyzing the deconstructed contents of file, where a file came from and when, and/or a digital signature, which may be used to identify a file. The indicators 2290 may further indicate whether a file is malicious. In some implementations, the indicators 2290 may include a weight value that indicates the probability that a file is malicious.

FIG. 23 illustrates an example of a log file analysis engine 2348. The log file analysis engine 2348 analyzes log files generated by operating systems, applications, and devices in the emulated network. For example, the log file analysis engine 2348 can analyze log files generated by emulated network devices form the emulated network. In various implementations, the emulated network devices can be implemented using virtual machines.

This example log file analysis engine 2348 is also arranged modularly and hierarchically. A log file analysis 2370 receives log files 2328 and may conduct a first stage analysis of the log files 2328. For example, the log file analysis 2370 may sort log files by their type, and invoke an appropriate sub-module for analyzing each log file by its type. In this example, the log file analysis engine 2348 includes sub-modules for analyzing message logs 2372, authentication logs 2374, and user logs 2376. The sub-modules may each be assisted by one or more plugins 2382. The log file analysis engine 2348 may include sub-modules for analyzing other logs 2380, including any of the many logs that may be generated by network devices but that are not illustrated here.

The message logs 2372 sub-module analyzes message logs. Message logs contain global system messages, often including messages that are also found in other message logs, such as mail and authentication logs. Analyzing message logs may provide a comprehensive view of the activity seen by a emulated device in the emulated network. The message logs 2372 sub-module may also analyze message logs based on information provided by other analysis engines. For example, message logs may be searched for activity related to a suspect IP address or username, found through network analysis.

The authentication logs 2374 sub-module analyzes log files related to user authentication. Authentication logs include information such as a history of logins (including usernames, login times, and logout times) and the authentication mechanism used. Examining log files may be useful for finding, for example, repeated login attempts, password scanning (e.g., multiple login attempts with the same username and different passwords), and/or logins using deliberately released usernames and passwords. Authentication logs can also be searched for activity related to, for example, a suspect username or around a specified time. The key words or search strings may be provided by other analysis engines.

The user logs 2376 sub-module analyzes log files that record user-level activity. User logs may capture the actions of one user. For example, a user log may include commands entered by a user, files opened or closed by the user, applications launched by the user, other systems accessed by the user, and so on. Examining user logs may be useful, for example, when an outside actor has gained access to the emulated network using stolen or leaked credentials. Hence, user logs may be examined for information related to a specific user, which may be identified by another analysis engine.

The sub-modules may each make a determination as to whether a log file being analyzed indicates malicious activity. The sub-modules may make this determination with the assistance of one or more attached plugins 2382. The sub-modules may provide their determinations to the log file analysis 2370. The log file analysis 2370 may use the determinations made by the sub-modules to generated indicators 2390 that describe and/or identify activity seen in the log files 2328. These indicators 2390 may be referred to as dynamic indicators. For example, indicators 2390 generated by the log file analysis engine 2348 may include a list of login attempts, usernames associated with log in attempts, commands entered by a user that has infiltrated the emulated network, and/or changes made within the emulated network, among other things. The indicators 2390 may indicate that no malicious activity was found, or that malicious activity was definitely found. In some implementations, the indicators may alternatively or additionally provide a weight value that indicates the probability of malicious activity.

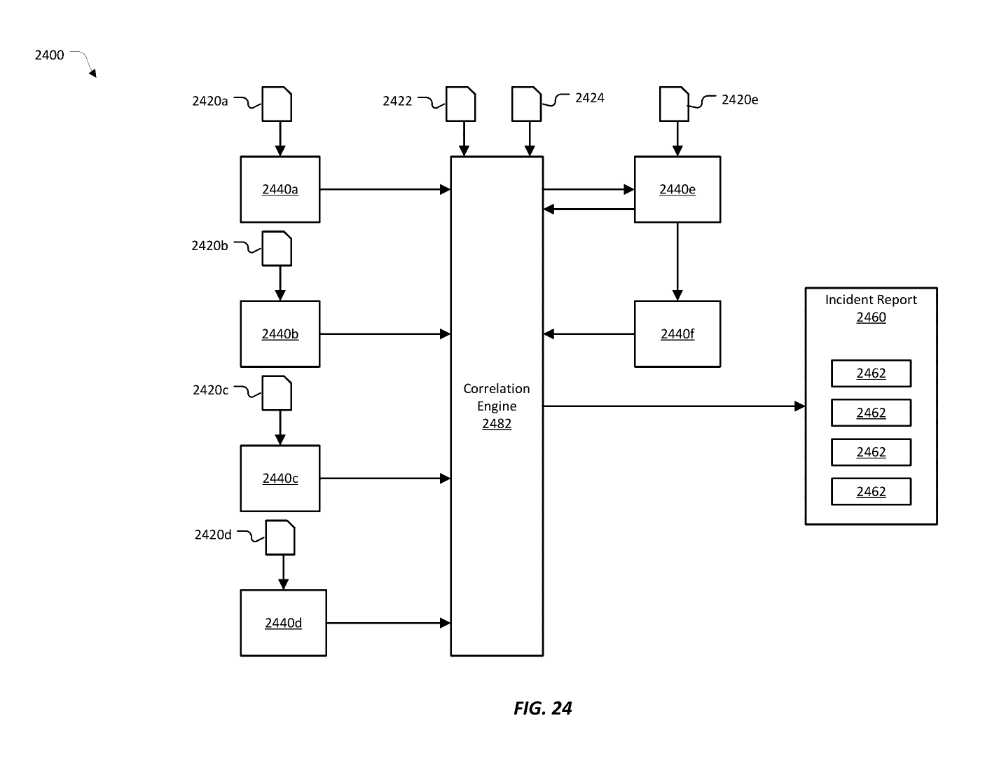

In various implementations, the analysis engines described in FIGS. 20-23 may be launched by the analytic engine in a predetermined sequence. FIG. 24 illustrates an example of the order or sequence in which analysis engines 2440a-2440f can be run, as well as a correlation engine 2482 for correlating the results from the various analysis engines 2440a-2440f. In various implementations, the analytic engine executes the analysis engines 2440a-2440f in a predetermined order, which can be modified. The execution order may be based on current threat intelligence from the network security community. For example, the security community may learn that certain malware has been released on a particular date, or that several websites have suffered denial of service (DoS) attacks. In this example, the threat intelligence engine can be configured to watch particularly for this denial of service attacks that look similar to the attacks seen at those websites. For example, the network protocol analysis engine can be placed first or early in the execution order, so that the network protocol analysis engine can catch streams of packets that appear to be related to a denial of service attack. New threat intelligence may be received once a day or several times a day, and analytic engine may adjust the execution of the analysis engines 2440a-2440f accordingly.

In some implementations, the analytic engine can also determine the order in which to execute the analysis engines from what can be learned from suspect network traffic. For example, an attack may take the form of a large amount of irrelevant or inappropriate email (e.g., spam email) being received by a network. The nature of this email as spam may be identified by the network's security infrastructure, and the analytic engine may use this information to invoke a email analysis engine first. The email analysis engine may conduct an analysis of the headers of the suspicious email, and determine, for example, that the email does not have a valid header (e.g., the sender's email address is invalid or has been spoofed). The result of the email header analysis can be provided to a file analysis engine and/or a log file analysis engine to determine whether attachments included in the suspect email are malicious. In contrast, should the email header analysis engine find nothing wrong with the email, then the file and log file analysis engines need not be run.

In various implementations, the analytic engine may also be able to add new analysis engines to the sequence, remove analysis engines from the sequence, and/or add or remove plugins for an analysis engine. The analytic engine may make these changes to new or different network threats and/or to update the functionality of the analytic engine. In some implementations, updates and changes to the analytic engine can be provided over the Internet. In some implementations, the analytic engine can be updated without needing to shut it down or take it off line.

In the example illustrated in FIG. 24, four analysis engines 2440a-2440d are initially launched in parallel. These four analyses engines 2440a-2440d can be one of the web-based network protocol analysis engine, other network protocol analysis engine, file activity analysis engine, log file analysis engine, or some other analysis engine included in the analytic engine. The four initial analysis engines 2440a-2440d receive as input incident data 2420a-2420d of an appropriate type (e.g., a web-based network protocol analysis engine receives web-based network traffic data; a file analysis engine receives files, etc.) The initial analysis engines 2440a-2440d can be run in parallel or sequentially; in this particular example, there is no requirement that they be run in a specific order. In some cases, there may be a requirement that the result from one analysis engine 2440a-2440d be provided to another analysis engine 2440a-2440d. In various implementations, additional or fewer analysis engines 2440a-2440f can be run initially.

Each of the initial analysis engines 2440a-2440d may produce results. These results may indicate whether a particular piece of data from the incident data 2420a-2420d is malicious, is safe, or has an undetermined status. Results that indicate particular data is safe and some results that indicate an undetermined status may be discarded, or are otherwise set aside. Results that indicate particular data is malicious, and thus very likely related to an actual attack, may be provided to the correlation engine 2482.

The correlation engine 2482 correlates the results from the various analysis engines to produce a report of the incident 2460. One or more of the results may indicate that the site network has, in fact, suffered an attack. For example, one or more servers in the emulated network may have crashed. The correlation engine 2482 attempts to reconstruct the sequence of events that led up to the harm caused by the attack. The analysis engines 2440a-2440f may identify events in the incident data 2420a-2420e that, by themselves, are probably malicious (e.g., downloading of a malware file). Many events in the incident data 2420a-2420e may, alone, appear innocent (e.g., receiving an email). The correlation engine 2482 attempts to connect these events, which may appear to be unrelated, and thereby reconstruct the course of the attack. Furthermore, the correlation engine 2482, in most implementations, has access to all of the data captured for the incident, and thus may be able to relate single events to events that happened both before and after. In many cases, having reconstructed the course of the attack, the report from the correlation engine 2482 can be used to identify malicious activity related to the attack.

For example, one analysis engine 2440a may indicate to the correlation engine 2482 that a malware file was downloaded to a server in the emulated network. Another analysis engine 2440b may indicate that servers in the emulated network crashed because their memory was flooded with garbage data. The correlation engine 2482 may search the incident data 2420a-2420e for a connection between these events. To continue the example, the correlation engine 2482 may find that the malware file launched a process on each of the servers that crashed. The correlation engine 2482 may further find that the servers' memory started to fill once these processes were started.

The correlation engine 2482 can also be in identify and deconstruct attacks that can otherwise be difficult to trace. One example of an attack that is difficult to trace is a “dropper” attack. A dropper is a malware installer that surreptitiously carries viruses, back doors, or other malicious software. A dropper file by itself does not cause harm directly, and cannot be identified by simple checks such as examining its file extension. Once on a computing system, the dropper file can be inadvertently activated by a user attempting to open the file, or may exploit a security vulnerability to activate itself. Once activated, the dropper file unpacks and executes its contents, which is often a malware file.

A dropper can be detected in various ways by correlating the dropper's contents—which, for purposes of the following examples, will be referred to as the contents file—back to the dropper. For example, the contents file may be executed on an emulated network device, and its malicious behavior may be both exposed and captured in log files generated by the emulated network device. As another example, a static scan of the contents file may reveal its malicious nature. As another example, the contents file, once invoked, may make calls to a command and control server located on the Internet. A command and control server (C&C server) is a centralized computer that issued commands to a botnet, and receives reports back from coopted computing systems. This malicious behavior may be captured in log files generate an emulated network device on which the contents file is launched.

In each of the above examples, the correlation engine 2482 may look for the contents file (e.g., by looking for a digital signature generated for the contents file) in other log files, and find it in a log file generated when the dropper file was itself executed. The dropper file's relationship with the contents file will thus cause the otherwise benign-seeming dropper file to be classified as malicious. Additionally, the correlation engine 2482 may be able to identify how the dropper file itself came to be on the network. For example, the correlation engine 2482 may look for the dropper file in email attachments (e.g., using a digital signature generated for the dropper file), and/or may look for the dropper file in network packets that were part of a download from the Internet. In this way, the correlation engine 2482 may be able to trace the events in the dropper attack independently from when the various events in the attack occurred.

Before being able to produce an incident report 2460, the correlation engine 2482 may require additional results for additional analysis engines 2440e-2440f. For example, to continue to previous example, the correlation engine 2482 may have determined that a malware file causes the servers to crash, but so far does know where the malware file came from or how it came to be placed in the network. The analysis engine may, in this example, invoke additional analysis engines 2440e-2440f to obtain more information. For example, one analysis engine 2440e may be invoked to search log files for a time at which the malware file was downloaded. Another analysis engine 2440f may be invoked to search network packets for the malware file. From the results from these analysis engines 2440e-2440f, the correlation engine 2482 may be able to identify where the malware file came from (e.g., an IP address of the sender) and when it was downloaded to the emulated network.

The correlation obtained so far, however, may not yet describe the whole incident. In some cases, the incident data 2420a-2420e may be incomplete. For example, suspect network traffic may be diverted to the emulated network when some network traffic is identified as suspect. The attack on the network, however, may have started before the suspect network traffic is identified, and may have escaped detection. Activity resulting from this network traffic may thus not have been captured in the incident data 2420a-2420e. In some implementations, the correlation engine 2482 thus may also receive additional data 2422, 2424, such as log files, from the site network. This additional data 2422, 2424 may include data 2422 captured by network packet monitors and data 2424 captured by computing systems in the site network, among other data available from the site network. In these implementations, the correlation engine 2482 may correlate events in the incident with events recorded in the additional data 2422, 2424. To continue the previous example, the correlation engine 2482 may learn from the additional data that a user in the site network received an email from a trusted source with an apparently innocent link, and that by following the link to a website, the user triggered downloading of the malware file.

In some implementations, the correlation engine 2482 may be able to iteratively search the incident data 2420a-2420e, repeatedly trying different searches to make connections between different events. In some implementations, the correlation engine 2482 may be able to replay the events in an incident to determine if it has found the events related to the attack, and/or to determine what resulted from a particular series of events. For example, the threat intelligence engine may receive a sequence of events, and may execute each event in the sequence in the r.

Once the correlation engine 2482 has made a best attempt at determining the events in an attack, the correlation engine 2482 may produce an incident report 2460. The incident report 2460 includes one or more indicators 2462, each of which describe an event.

IX. Adversary Trajectory

In the information security industry, it can be difficult to determine where an attack may have occurred on a network. When the attack is discovered, it can be even more difficult to determine the trajectory of the attack. An adversary trajectory engine can be configured to use network flow information of a network to determine the trajectory of an attack. In various implementations, the trajectory of an attack (or attack trajectory), describes the path taken from node to node across a network by malicious network activity, and/or seemingly harmless network activity related to malicious network activity. In some implementations, an adjacency data structure can be generated for a network. The adjacency data structure can include a first machine of the network that has interacted with a second machine of the network, where a machine may be, for example, a network device. In the adjacency data structure, the first machine can be associated with the second machine when an interaction has occurred between the first machine and the second machine. The adjacency data structure can be updated as new interactions occur on the network.

In some implementations, the network can further include one or more deception mechanisms, as described above and herein. A deception mechanism can indicate that an attack is occurring when a machine interacts with the deception mechanism. When, or after, the attack has occurred, an attack trajectory data structure can be generated. In the attack trajectory data structure, an attack trajectory path can be determined. When there are multiple possible attack trajectory paths, a probability can be computed for each attack trajectory path to determine the likelihood that the attack trajectory path is associated with a particular adversary.

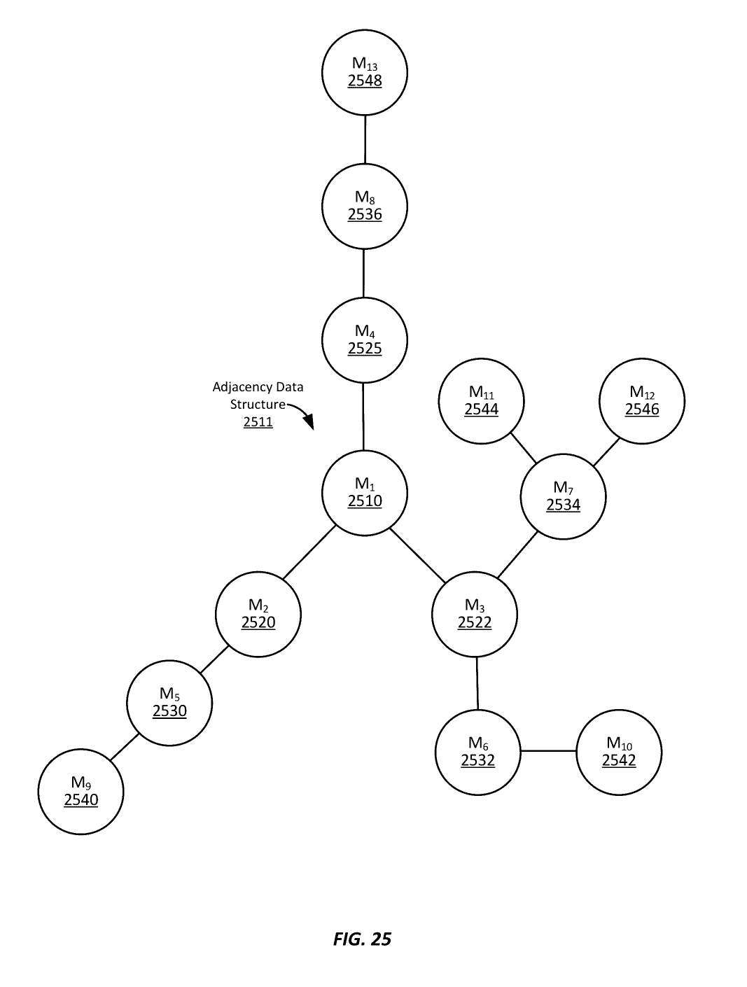

FIG. 25 is an example of an illustration of an adjacency data structure 2511 for a plurality of interactions in a network. In some implementations, the adjacency data structure 2511 can be an adjacency list or an adjacency matrix. In various implementations, the adjacency data structure 2511 can otherwise be any type of data structure that can organize interactions.

The adjacency data structure 2511 can be generated by correlating interactions. In some embodiments, correlating interactions can include establishing a mutual relationship or connection between two or more machines based on interactions in the network. In some embodiments, interactions can be determined by analyzing interaction information and machine information.

The interaction information can include a time stamp of an interaction, a source Internet Protocol (IP) address, a source host name, a user, a destination IP address, a destination host name, an action, a protocol type that was used for an interaction (e.g., Secure Shell, Telnet, etc.), a number of packets sent, or any combination thereof. In some examples, the action can include whether the interaction was a success or a failure. For example, a login attempt to a machine can succeed or fail. A machine can include authentication logs. Authentication logs can report a time of a login attempt, a type of protocol used for a login attempt, a username used for a login attempt, a password used for a login attempt, and any other information associated with logging in and out of the machine.

The machine information can include information associated with a machine. Examples of machine information can include a category of the machine, a city in which the machine is located, a country in which the machine is located, a domain name system (DNS) for the machine, an IP address of the machine, a latitude in which the machine is located, a longitude in which the machine is located, a media access control (MAC) address of the machine, a Microsoft Windows® machine name of the machine (e.g., nt_host), a name of the user who owns or uses the machine, and/or a Peripheral Component Interconnect (PCI) domain of the machine. Examples of a category of a machine can include a domain controller, an active directory, a server machine, and/or an end-user machine. The machine information for a machine can also include authentication logs.

In some implementations, one or more servers (e.g., a deception center) can be in communication with one or more machines on the network. In some implementations, the deception center can be in communication with a machine that is in communication with the one or more machines on the network. The deception center can include an adversary trajectory engine, configured to determine an attack trajectory, as described below. In some implementations, the deception center can coordinate other servers or machines to perform one or more of the techniques described herein.

The deception center can receive, directly or indirectly, the machine information from a machine log forwarder associated with each machine. In particular, a machine log forwarder associated with a machine can send machine information associated with the machine from the machine. The machine log forwarder can send the machine information to the deception center directly. In other embodiments, the machine log forwarder can send the machine information to a security information and event management (SIEM) system or a centralized database. In such implementations, the deception center can communicate with the SIEM or the centralized database to receive the machine information.

The machine information can be used to identify a particular machine in an adjacency data structure. For example, the host names can be used to identify each machine. In FIG. 25, the host names of the machines are in a format of Mₓ, x being a real number. For illustration purposes, a machine is represented as a circle. For example, machine M₁ 2510 can be a laptop computer. In addition, an interaction between two machines is illustrated in FIG. 25 as a line between two machines. Examples of interacts include a laptop computer logging into a desktop computer using a virtual private network.

In the example adjacency data structure 2511, an interaction has occurred between M₁ 2510 and each of M₂ 2520, M₃ 2522, and M₄ 2524. For example, the interaction between M₁ 2510 and M₂ 2520 may have occurred at 9:40 AM, and may have included an email exchange from M₁ 2510 to M₂ 2520 using Simple Mail Transfer Protocol (SMTP). As another example, the interaction between M₁ 2510 and M₃ 2522 may have occurred at 9:45 AM, and may have included a successful login attempt from M₁ 2510 to M₂ 2520 using Secure Shell (SSH). In this example authentication logs associated with M₂ 2520 can include information associated with the successful login attempt. In another example, the interaction between M₁ 2510 and M₃ 2524 may have occurred at 9:50 AM, and may have included a file transfer from M₁ 2510 to M₃ 2524 using File Transfer Protocol (FTP).

The interactions in the example adjacency data structure 2511 further include an interaction between M₂ 2520 and each of M₁ 2510 and M₅ 2530. In this example, the interaction between M₂ 2520 and M₁ 2510 is the same interaction described above as between M₁ 2510 and M₂ 2520. Hence, in this example, the interaction between M₂ 2520 and M₁ 2510 is not illustrated separately. The interaction between M₂ 2520 and M₅ 2530, however is a different interaction. This interaction may have, for example, occurred at 9:35 AM and may have included an email exchange from M₂ 2520 to M₅ 2530 using SMTP.

The interactions in the adjacency data structure 2511 can further include an interaction between M₃ 2522 and each of M₁ 2510, M₆ 2532, and M₇ 2534. Because the interaction between M₁ 2510 and M₇ 2534 is the same interaction described above but shown with respect to M₃ 2522, the adjacency data structure 2511 can forgo including the same interaction. In one illustrative example, the interaction between M₃ 2522 and M₆ 2532 occurred at 9:30 AM and included a file transfer from M₃ 2522 to M₆ 2532 using Secure Copy (SCP). In another example, the interaction between M₃ 2522 and M₇ 2534 occurred at 9:35 AM and included a successful login attempt to M₇ 2534 using SSH. The authentication logs associated M₇ 2534 can include information associated with the successful login attempt.

The interactions in the adjacency data structure 2511 can further include an interaction between M₄ 2524 and each of M₁ 2510 and M₈ 2536. Because the interaction between M₁ 2510 and M₄ 2524 is the same interaction described above but shown with respect to M₄ 2524, the adjacency data structure 2511 can forgo including the same interaction. In one illustrative example, the interaction between M₄ 2524 and M₈ 2536 occurred at 9:40 AM and included connecting M₄ 2524 to M₈ 2536 using hypertext transfer protocol (HTTP).

The interactions in the adjacency data structure 2511 can further include an interaction between M₅ 2530 and each of M₂ 2520 and M₉ 2540. Because the interaction between M₂ 2520 and M₅ 2530 is the same interaction described above but shown with respect to M₅ 2530, the adjacency data structure 2511 can forgo including the same interaction. In one illustrative example, the interaction between M₅ 2530 and M₉ 2590 occurred at 9:30 AM and included an email exchange from M₅ 2530 to M₉ 2590 using SMTP.

The interactions in the adjacency data structure 2511 can further include an interaction between M₆ 2532 and each of M₃ 2522 and M₁₀ 2542. Because the interaction between M₃ 2522 and M₆ 2532 is the same interaction described above but shown with respect to M₆ 2532, the adjacency data structure 2511 can forgo including the same interaction. In one illustrative example, the interaction between M₆ 2532 and M₁₀ 2542 occurred at 9:25 AM and included a file transfer from M₆ 2532 to M₁₀ 2542 using SCP.

The interactions in the adjacency data structure 2511 can further include an interaction between M₇ 2534 and each of M₃ 2522, M₁₁ 2544, and M₁₂ 2546. Because the interaction between M₃ 2522 and M₇ 2534 is the same interaction described above but shown with respect to M₇ 2534, the adjacency data structure 2511 can forgo including the same interaction. In one illustrative example, the interaction between M₇ 2534 and M₁₁ 2544 occurred at 9:10 AM and included a file transfer from M₇ 2534 to M₁₁ 2544 using SCP. In another example, the interaction between M₇ 2534 and M₁₂ 2546 occurred at 9:10 AM and included a successful login attempt from M₇ 2534 to M₁₂ 2546 using SSH. The authentication logs associated with M₁₂ 2546 can include information associated with the successful login attempt.

The interactions in the adjacency data structure 2511 can further include an interaction between M₈ 2536 and each of M₄ 2524 and M₁₃ 2548. Because the interaction between M₄ 2524 and M₈ 2536 is the same interaction described above but shown with respect to M₈ 2536, the adjacency data structure 2511 can forgo including the same interaction. In one illustrative example, the interaction between M₈ 2536 and M₁₃ 2548 occurred at 9:12 AM and included a file transfer from M₈ 2536 to M₁₃ 2548 using FTP.

The example adjacency data structure 2511, after correlating interactions among the different machines, can be described as follows, where arrows illustrate the machines with which a particular machine has had interactions with: M₁→[M₂, M₃, M₄]; M₂→[M₅]; M₅→[M₉]; M₃→[M₆, M₇]; M₆→[M₁₀]; M₇→[M₁₁, M₁₂]; M₄→[M₈]; M₈→[M₁₃]. The adjacency data structure 2511 can include interactions from a source to a destination. In FIG. 25, the interactions from a viewpoint of the destination to the source are omitted. In other implementations, the adjacency data structure can include all interactions, including interactions from the viewpoint of the destination to the source. In such implementations, both M₁→[M₂] and M₂→[M₁] would be included as well as the other destination to source interactions.

Because the number of interactions in a network can become large as time progresses, an adjacency data structure can limit the amount of network flow information from a network that is maintained. In some implementations, the limit can be based on a time frame (e.g., one hour, one day, and one week). The time frame can be some amount of time before the current time. The adjacency data structure can then include all interactions in the time frame. In some implementations, the limit can be a number of machine interactions. The limit can be implemented on a machine. For example, a machine can only store a particular number of limitations between the machine and another machine. In some implementations, the limit can be one or more types of protocols. For example, the adjacency data structure can maintain only interactions that are SSH. In some implementations, the adjacency data structure can maintain interactions of a type of protocol and also interactions of other types of protocols that are similar to the type of protocol. For example, if the adjacency data structure is maintaining interactions that use SSH, the adjacency data structure can also maintain interactions that use Telnet. In some implementations, the adjacency data structure can maintain interactions of a type of protocol and machines that include an interaction of the type of protocol. For example, if a machine used SSH for one interaction and HTTP for another interaction, both interactions can be maintained in the adjacency data structure because of the common SSH use from the machine. In some implementations, the limit can be based on any combination of the factors mentioned above, such as limiting the interactions based on any combination of time frame, number of interactions, and type of protocol.

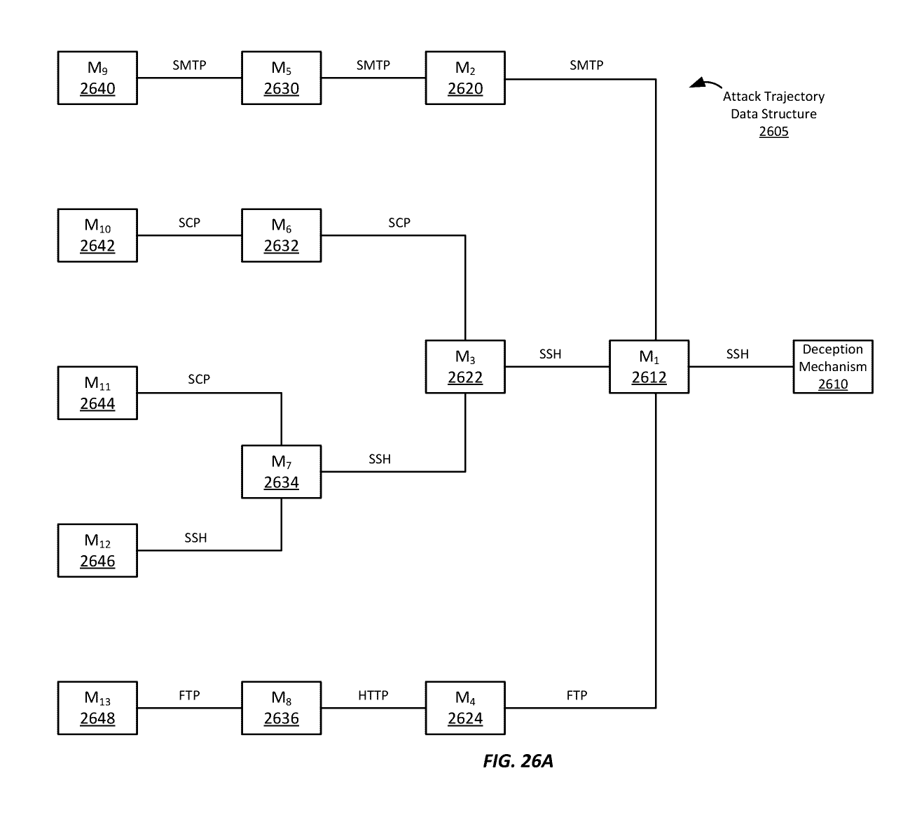

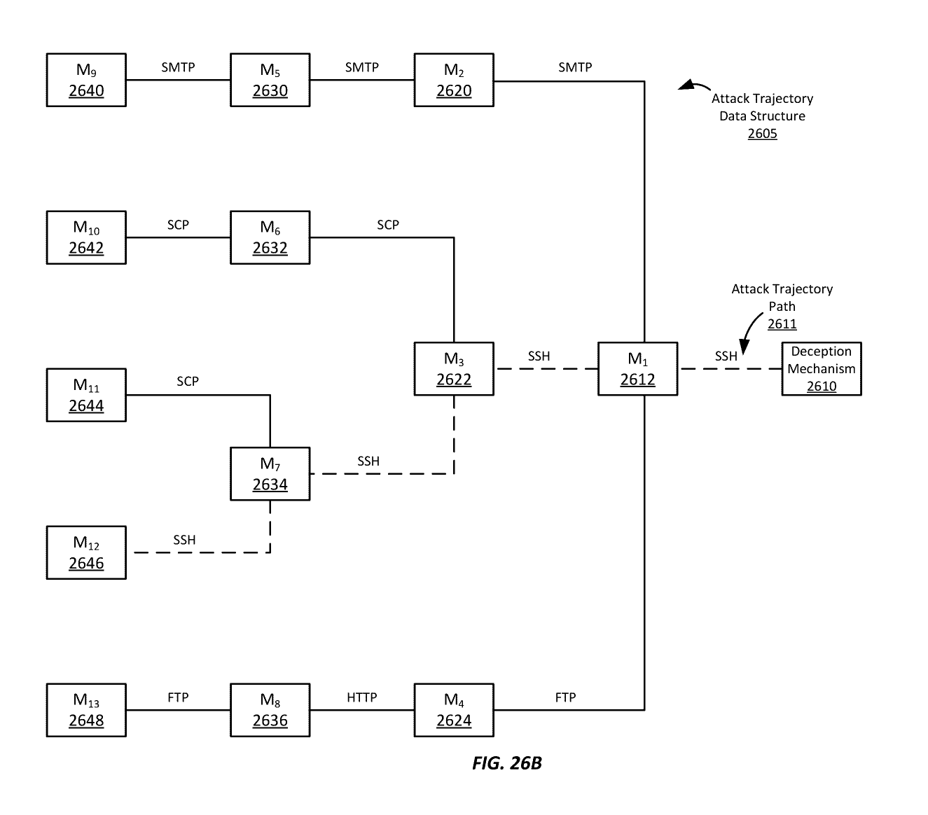

FIG. 26A is an example illustrating an attack trajectory data structure 2605 for a network. The attack trajectory data structure 2605 can be generated using an adjacency data structure (e.g., adjacency data structure 2511) and deception mechanism interaction information.

In the example illustrated in FIG. 26A, the network can include a deception mechanism 2610, as previously discussed. The deception mechanism 2610 can be deployed with an unused IP address, meaning that the deception mechanisms 2610 is assigned an IP address that is not used by any node in the site network being analyzed. In some implementations, because the deception mechanism 2610 is deployed with an unused IP address, normal network traffic would not attempt to access the deception mechanism 2610. The deception mechanism 2610 can emulate a service on a port to lure adversaries to interact with the port. An adversary can be any person, machine, program, or other entity that attacks or attempts to attack a machine or system on a network. In some examples, an adversary can be an individual that is logging into a machine. In some examples, an adversary can be malware. By interacting with the deception mechanism 2610, an interaction by a machine can be identified as being associated with an adversary or attacker because the deception mechanism 2610 would not be accessed otherwise.

In addition, deception mechanism interaction information can be received regarding any interaction with the deception mechanism 2610. The deception mechanism interaction information can be used to determine the trajectory of the adversary. The deception mechanism interaction information can include, for example, machine information, as discussed above, about the machine that interacted with the deception mechanism 2610. The deception mechanisms information can also include information about an interaction. Interaction information can, for example, include a network protocol type, among other things. The deception mechanism information can include other information, such as information that is gathered based on the network protocol type. For example, if the network protocol type is SSH, the deception mechanism interaction information can include a username, a password, and/or number of failed attempts.

The adjacency data structure 2511 of FIG. 25 can be used to generate the attack trajectory data structure 2605 of FIG. 26A. The attack trajectory structure 2605 describes each of the possible paths that can occur, given the adjacency data structure 2511. The attack trajectory data structure 2605 can be generated by following the various paths in the adjacency data structure 2511. In particular, once the deception mechanism 2610 has interacted with by M₁ 2612, an adversary trajectory engine can generate the attack trajectory data structure 2605 by stepping through the adjacency data structure 2511, starting at M₁ 2510, to determine the possible trajectories of the adversary.

In this example, an interaction has occurred between M₁ 2612 and a deception mechanism 2610, where the interaction involved SSH. Referring to the adjacency data structure 2511, the adversary trajectory engine can determine that M₁ 2510 interacted with M₂ 2520, which in turn interacted with M₅ 2530, which in turn interacted with M₉ 2540. Given these interactions, the attack trajectory data structure 2605 this includes a path from M₁ 2612 to M₂ 2620 to M₅ 2630 and ending at M₉ 2640. The attack trajectory structure 2605 may also note that the interactions along this path involved SMTP data exchanges.

Similarly, the adjacency data structure 2511 indicates that M₁ 2510 interacted with M₃ 2522, which interacted with M₆ 2532, which in turn interacted with M₁₀ 2542. The attack trajectory data structure 2605 thus contains a path from M₁ 2612 to M₃ 2622 to M₆ 2632 and terminating at M₁₀ 2642. The attack trajectory data structure 2605 may further indicate that the interaction between M₁ 2612 and M₃ 2622 involved an SSH communication, while the interactions between M₃ 2622, M₆ 2632, and M₁₀ 2642 involved SCP communications.

The adjacency data structure 2511 also indicates that M₃ 2522 interacted with M₇ 2534, which in turn interacted with M₁₁ 2544. The attack trajectory data structure 2605 may thus include a path from M₃ 2622 to M₇ 2634 to M₁₁ 2644. The attack trajectory data structure 2605 may further indicate that the interaction between M₃ 2622 and M₇ 2634 involved SSH, while the interaction between to M₇ 2634 and M₁₁ 2644 involved SCP.

The adjacency data structure 2511 further indicates that M₇ 2534 interacted with M₁₂ 2546. The attack trajectory structure 2605 may thus include a path from M₇ 2634 to M₁₂ 2646. The attack trajectory structure 2605 may further indicate that the interaction between M₇ 2634 and M₁₂ 2646 involved SSH.

The adjacency data structure 2511 also indicates that M₁ 2510 interacted with M₄ 2524, which in turn interacted with M₈ 2536, which in turn interacted with M₁₃ 2548. The attack trajectory structure 2605 may thus include a path from M₁ 2612 to M₃ 2624 to Mg 2636 and ending at M₁₃ 2648. The attack trajectory data structure 2605 can further indicate that the interactions between M₁ 2612, M₃ 2624, M₈ 2636, and M₁₃ 2648 involved FTP communications.

The attack trajectory data structure 2605 can be generated by using a modified depth first search algorithm. The modified depth first search algorithm can analyze all of the machine interactions from each machine before stepping deeper into the adjacency data structure 2511. Other search algorithms can be used, including breadth first search and Monte Carlo tree search.

The adversary trajectory engine can determine an attack trajectory path using an attack trajectory data structure. In some embodiments, the attack trajectory path can be determined based on interaction information between a machine and a deception mechanism. For example, the deception center can determine one or more interactions in the attack trajectory data structure that are connected (directly or indirectly) to the deception mechanism and include one or more common elements to the interaction information between the machine and the deception mechanism. The one or more common elements can include a type of protocol, a common username, a number of login attempts, or a combination thereof

In some embodiments, the attack trajectory path can be determined based on a user-specified machine. The user-specified machine can be a machine in the network that a user determines is a point of origin of an attack. In such an embodiment, the attack trajectory path can be determined from a deception mechanism to the user-specified machine. For example, a user can specify that the attacker accessed the system through an e-mail server. The attack trajectory path can then determine an attack trajectory path from a deception mechanism to the e-mail server. In such an example, the attack trajectory path can illustrate that the attacker accessed the e-mail server, one or more other machines, and the deception mechanism. By providing a user-specified machine, the attack trajectory path can isolate the attack trajectory paths that include the user-specified machined (e.g., an email server, a password database, a database with personal information, a DHCP server, or other user-specified machine).

In some embodiments, the attack trajectory path can be determined from a machine rather than the deception mechanism. For example, a user can specify a machine that is known to include a vulnerability or malware. The adversary trajectory engine can determine an attack trajectory path from that machine as if the machine interacted with a deception mechanism.

FIG. 26B is an example illustrating an attack trajectory path 2611 that is highlighted in the attack trajectory data structure 2605 of FIG. 26A. The adversary trajectory engine can use the attack trajectory data structure 2605 to determine the attack trajectory path 2611 of FIG. 2B. For example, the adversary trajectory engine can search the attack trajectory data structure 2605 for a path that uses a particular protocol. For example, the protocol can include an SSH protocol. In this example, SSH can be used as the protocol because the interaction between M₁ 2612 and the deception mechanism 2610 used SSH, indicating that the adversary used the SSH protocol. In this example, the attack trajectory path 2611 can include M₁ 2612, M₃ 2622, M₇ 2634, and M₁₂ 2646 for the network, as shown in FIG. 26B.

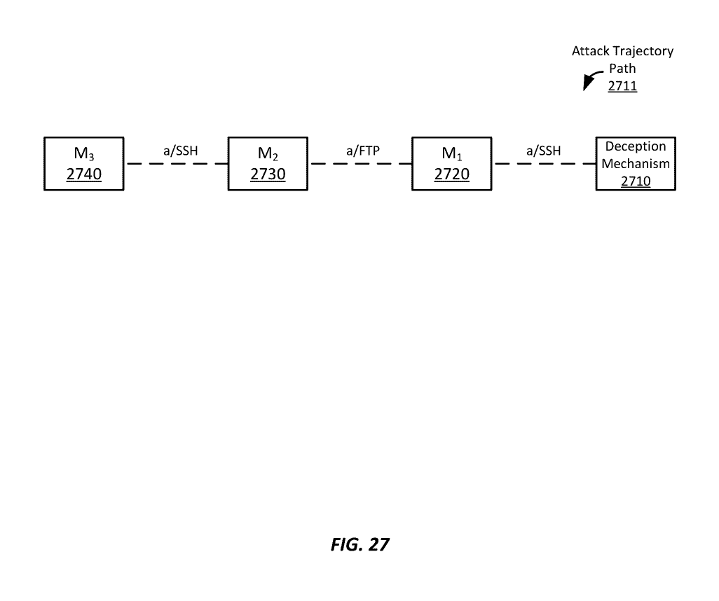

FIG. 27 is an example illustrating an attack trajectory path 2711 using username to determine a path of an adversary in a network. The network can include a deception mechanism 2710, M₁ 2720, M₂ 2730, and M₃ 2740. In one example, a first interaction occurred between the deception mechanism 2710 and M₁ 2720 at 9:00 AM and included a successful login attempt from M₁ 2720 to the deception mechanism 2710 with a username “a,” and using SSH. In another example, a second interaction occurred between M₁ 2720 and M₂ 2730 at 8:50 AM and included a successful login attempt from M₂ 2730 to M₁ 2720 with the username “a,” and using FTP. In another example, a third interaction occurred between M₂ 2730 and M₃ 2740 at 8:40 AM and included a successful login attempt from M₃ 2740 to M₂ 2730 with the username “a,” and using SSH. If the attack trajectory path 2711 is using a common username to determine the path of the adversary, the attack trajectory path 2711 can include M₁ 2720, M₂ 2730, and M₃ 2740.

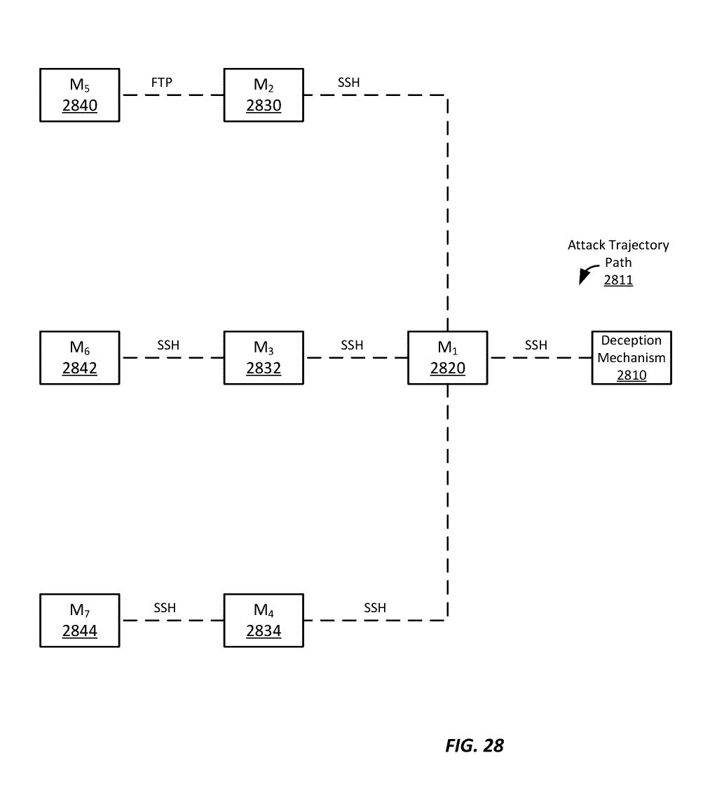

FIG. 28 is another example of illustrating an attack trajectory path 2811 for a network. The network can include a deception mechanism 2810, M₁ 2820, M₂ 2830, M₃ 2832, M₄ 2834, M₅ 2840, M₆ 2842, and M₇ 2844. In this example, M₁ 2820 and M₃ 2832 can be end-user machines; M₂ 2830, M₄ 2834, and M₅ 2840 can be server machines; M₆ 2842 can be an active directory; and M₇ 2844 can be a domain controller. In one example, a first interaction occurred between the deception mechanism 2810 and M₁ 2820 at 9:00 AM and included a successful login attempt from M₁ 2820 to the deception mechanism 2810 with a username “a,” and using SSH. In another example, a second interaction occurred between M₁ 2820 and M₂ 2830 at 8:50 AM and included a successful login attempt from M₂ 2830 to M₁ 2820 with the username “a,” and using SSH. In another example, a third interaction occurred between M₁ 2820 and M₃ 2832 at 8:49 AM and included a successful login attempt from M₃ 2832 to M₁ 2820 with a username “b,” and using SSH. In another example, a fourth interaction occurred between M₁ 2820 and M₄ 2834 at 8:48 AM and included a successful login attempt from M₄ 2834 to M₁ 2820 with the username “b,” and using SSH. In another example, a fifth interaction occurred between M₂ 2830 and M₅ 2840 at 8:40 AM and included a successful login attempt from M₅ 2840 to M₂ 2830 with the username “a,” and using FTP. In another example, a sixth interaction occurred between M₃ 2820 and M₆ 2842 at 8:39 AM and included a successful login attempt from M₆ 2842 to M₃ 2820 with the username “b,” and using SSH. In another example, a seventh interaction between M₄ 2820 and M₇ 2844 at 8:38 AM and included a successful login attempt from M₇ 2844 to M₄ 2820 with the username “b,” and using SSH.

For the network of FIG. 28, the attack trajectory path 2810 can include three at least partially separate paths. A first separate path can include M₁ 2820, M₂ 2830, and M₅ 2840. A second path can include M₁ 2820, M₃ 2832, and M₆ 2842. A third path can include M₁ 2820, M₄ 2834, and M₇ 2844. Each separate path can include a probability that an attack used each of the particular paths. One way to compute the probability includes summing the weight of each machine in the path, multiplied by a weight of each protocol used in the interactions between the machines. In some implementations, a path weight can be computed using the following equation:

$$PathWeight ( M ( x ) -> M ( y ) ) = MWeight ( M ( 1 ) ) + {\sum }_{i = 2}^{n} [ MWeight ( i ) * PWeight ( M ( i ) -> M ( i - 1 ) ) ]$$

In the above equation, MWeight(x) is a function that returns a number based on the machine information of Mₓ. In some implementations, the function for MWeight(x) can be based on the category of the machine. Each category can have a predetermined weight value. For example, a domain controller can be defined as having a weight of 4; an active directory can be defined as having a weight of 3; a server machine can be defined as having a weight of 2; and an end-user machine can be defined as having a weight of 1. Alternatively or additionally, the function for MWeight(x) can be based on one or more elements of machine information. The function for MWeight(x) can also be based on number of failed attempts at some action by one or more machines. The function for MWeight(x) can also be based on the number of file system changes or malware installations on the machine.

In the above equation, PWeight(x→z) is a function that returns a number based on a protocol type used for an interaction between machines. In some implementations, the number returned by PWeight(x→z) is a predetermined weight value. For example, SSH can be defined as having a weight of 5 and FTP can be defined as having a weight of 2. The PathWeight value can then be converted into a probability by dividing each PathWeight by the total number of PathWeights.

Using the PathWeight equation above for FIG. 28 and the example weight values provide above, the path weight for each of the three example paths can be computed as follows:

PathWeight(M(1)→M(5))=MWeight(M1)+MWeight(M(2))*PWeight(M(2)→M(1))+MWeight(M(5))*PWeight(M(5)→M(2))=1+2*5+2*2=15;

PathWeight(M(1)→M(6))=17; and

PathWeight(M(1)→M(7))=31.

The PathWeight can then be converted into a probability. Using the example values above, the results are: Probability of M₁→M₅=15/63=0.238; probability of M₁→M₆=17/63=0.269; and probability of M₁→M₇=31/63=0.492. In some implementations, after computing the probabilities, the adversary trajectory engine can remove the paths that are below a specified threshold. Alternatively or additionally, the adversary trajectory engine can remove all paths except for the highest probability path. In some implementations, the adversary trajectory engine can keep all the paths along with the associated probability for presenting the results.

In various implementations, other functions can be used to compute the PathWeight. In some implementations, the PathWeight can be based on the weights of machines (e.g., MWeight(x)). For example, PathWeight(M(1)→M(5))=MWeight(M1)+MWeight(M(2))+MWeight(M(5)). In some implementations, the PathWeight can be based on a number of login failures. For example, PathWeight(M(1)→M(5))=LoginFailures(M1)+LoginFailures (M(2))+LoginFailures (M(5)). In some implementations, the PathWeight can be based on most suspicious number of login failures. These implementations can modify LoginFailures(x) to ignore login failures that may not be suspicious. For example, login failures that end in a success within less than three tries can be determined not to be suspicious and able to be ignored by LoginFailures(x).

X. Similarity Engine

As discussed above, a behavioral analytics engine in a deception center may include an adversary trajectory engine and/or a similarity engine. The behavioral analytics engine may receive indicators from a threat analysis engine, where these indicators describe an incident captured by the deception center. In various implementations, the indicators may describe network device emulated in the emulated network that were affected by a network attack. In various implementations, the similarity engine may provide a system for identifying similar machines in a site network.

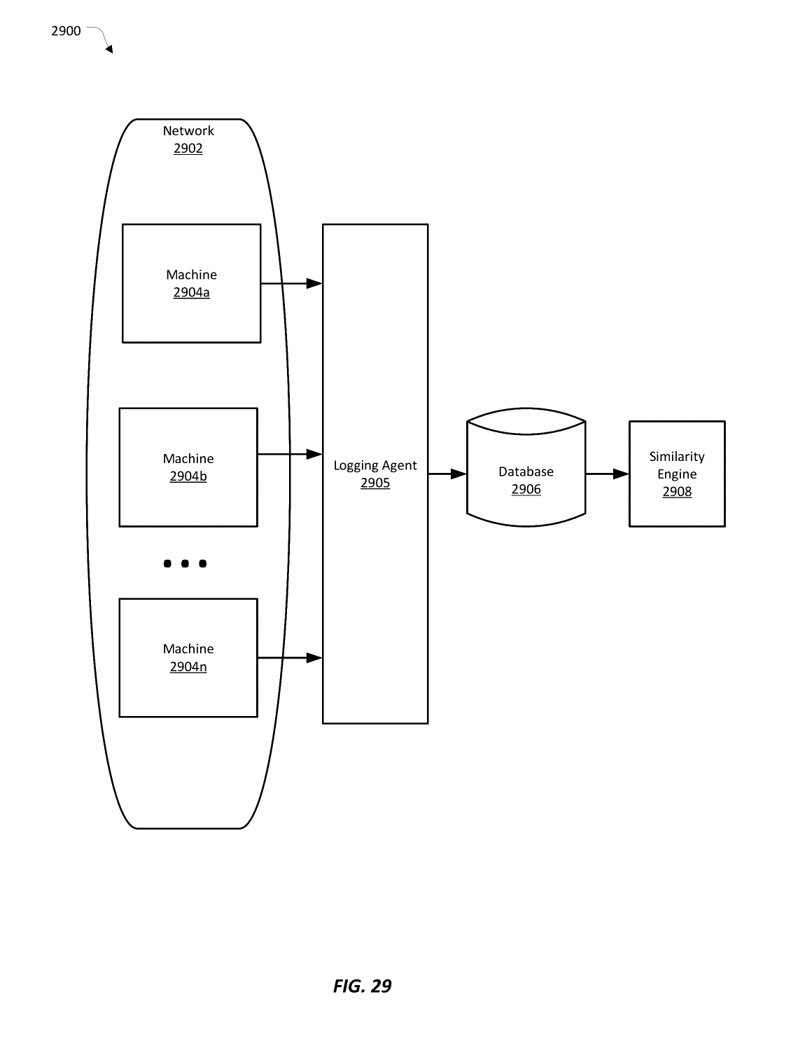

FIG. 29 illustrates an example of a system 2900 for identifying similar machines. System 2900 includes a plurality of machines 2904a-2904n on a network 2902, a logging agent 2905, a database 2906, and a similarity engine 2908. The plurality of machines 2904a-2904n may include a query item (e.g., a compromised machine or population centroid of a plurality of compromised machines), as well as one or more candidate items to be compared to the query item. Although illustrated as having three machines 2904a-2904n on network 2902, it is contemplated that any number n of machines may be present on the network 2902. Further, although illustrated as existing outside of the network 2902, it is contemplated that the logging agent 2905, database 2906, and/or similarity engine 2908 may also reside on the network 2902. In various implementations, the network 2902 may be, for example, a site network and/or an emulated network.

In this example, each of the machines 2904a-2904n is in communication with a logging agent 2905. In some implementations, the logging agent 2905 is in a scanner (not shown), and all of the data collected by the scanner is stored in a database. The logging agent 2905 monitors the machines 2904a-2904n and creates logs of collected data from the machines 2904a-2904n. The logs are stored in database 2906. The collected data may include any data regarding the machines 2904a-2904n, such as attribute data. Attribute data may include machine data, vulnerability data, malware data, authentication data, file system changes, and/or intrusion detection data, as described further herein.

Attribute data collected by the logging agent 2905 and stored in the database 2906 may be provided to the similarity engine 2908. The similarity engine 2908 uses the attribute data of a query item of the machines 2904a-2904n and compares it to the attribute data of one or more candidate items of the machines 2904a-2904n to identify similar items, as described further below.

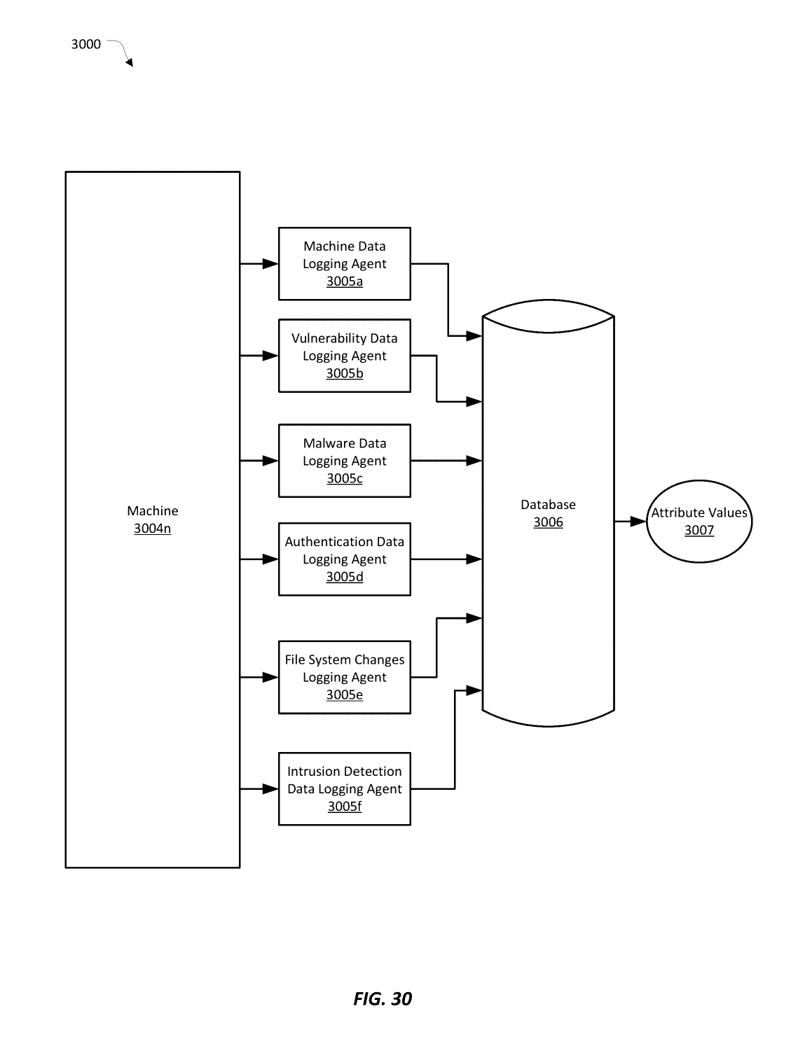

Although illustrated as being separate from the machines 2904a-2904n, it is contemplated that a logging agent can instead be present internally on each of the machines 2904a-2904n. Further, although a single logging agent 2905 is illustrated, it is contemplated that multiple similar or different logging agents can be present externally from or internally on each machine 2904a-2904n. An example of one such implementation is described with respect to FIG. 30.

FIG. 30 illustrates an example of a machine 3004n in a system 3000 for identifying similar machines. The machine 3004n may be similar to any or all of the machines 2904a-2904n of FIG. 29. The machine 3004n may be, for example, a network device. The machine 3004n is in communication with logging agents 3005a-3005f. The logging agents 3005a-3005f may be similar to the logging agent 2905 of FIG. 29.

The machine 3004n of FIG. 30 provides a plurality of attribute data 3010a-3010f relating to the machine 3004n to the logging agents 3005a-3005f For example, the machine 3004n may provide machine data to a machine data logging agent 3005a; vulnerability data to a vulnerability data logging agent 3005b; malware data to a malware data logging agent 3005c; authentication data to an authentication data logging agent 3005d; file system change data to a file system changes logging agent 3005e; and/or intrusion detection data to a intrusion detection logging agent 3005f. Although shown and described as having six types of logging agents 3005a-3005f for six types of data, it is contemplated that any number of types and combinations of attribute data may be provided by the machine 3004n to any number of types and combinations of logging agents, including additional types of attribute data and/or logging agents that are not shown. Further, it is contemplated that the logging agents 3005a-3005f may be combined into fewer or broken down into a greater number of logging agents. Although illustrated as being separate from the machine 3004n, it is contemplated that the logging agents 3005a-3005f can instead be present internally on the machine 3004n.

Machine data provided to the machine data logging agent 3005a can include information associated with the machine 3004n. Examples of machine data include a category of the machine, a type of operating system of the machine, a city in which the machine is located, a country in which the machine is located, a domain name system (DNS) for the machine, an IP address of the machine, a latitude in which the machine is located, a longitude in which the machine is located, a media access control (MAC) address of the machine, a Microsoft Windows® machine name of the machine (e.g., nt_host), a name of the user who owns or uses the machine, a host name associated with the machine, and a Peripheral Component Interconnect (PCI) domain of the machine. Examples of a category of a machine can include a domain controller, an active directory, a server machine, and an end-user machine.

Vulnerability data provided to the vulnerability data logging agent 3005b can include information associated with detected the vulnerabilities of machine 3004n. Exemplary types of vulnerability data include a category of a detected vulnerability and a severity of a detected vulnerability. Examples of attributes within a category of a detected vulnerability can include DOS and hardware. Examples of attributes within severity of a detected vulnerability can include critical, high and informational.

The following table provides examples of attribute values that could represent the number of times the associated vulnerability attributes were detected on the machine 3004n.

| Vulnerability Attribute | Attribute Value |
|---|---|
| DOS | 12 |
| Hardware | 4 |
| Critical | 8 |
| High | 3 |
| Informational | 5 |

Thus, the vulnerability data of machine n 3004n could be represented as:

| | DOS | Hardware | Critical | High | Informational |
|---|---|---|---|---|---|
| Machine n | 12 | 4 | 8 | 3 | 5 |

Malware data provided to the malware data logging agent 3005c can include information associated with detected malware on the machine 3004n. Examples of malware data include a signature (i.e., a name of the malware infection detected) and an action (i.e., an action taken by the machine in response to the malware). Examples of signatures can include key logger and LeakTest. Examples of actions can include allowed, blocked, and deferred.

The following table provides examples of attribute values that could represent the number of times the associated malware attributes were detected on the machine 3004n.

| Malware Attribute | Attribute Value |
|---|---|
| Allowed | 12 |
| Blocked | 4 |
| Deferred | 8 |
| Key Logger | 18 |
| LeakTest | 6 |

Thus, the malware data of machine n 3004n could be represented as:

| | Allowed | Blocked | Deferred | Key Logger | LeakTest |
|---|---|---|---|---|---|
| Machine n | 12 | 4 | 8 | 18 | 6 |

Authentication data provided to the authentication data logging agent 3005d can include information regarding log-in and log-out activities involving the machine 3004n. Examples of authentication data include an action (i.e., the action performed on the resource on the machine), app (i.e., the application involved in the activity), src (i.e., the source machine involved in the authentication), and dest (i.e., the destination machine involved in the authentication). Examples of actions can include success, failure and unknown. Examples of apps include ssh and splunk.

The following table provides an example of attribute values that could represent the number of times the associated authentication attributes were detected on the machine 3004n.

| Authentication Attribute | Attribute Value |
|---|---|
| Success | 5 |
| Failure | 6 |
| Unknown | 4 |
| ssh | 10 |
| Splunk | 5 |

Thus, the authentication data of the machine 3004n could be represented as:

| | Success | Failure | Unknown | ssh | Splunk |
|---|---|---|---|---|---|
| Machine n | 5 | 6 | 4 | 10 | 5 |

File system changes provided to the file system changes logging agent 3005e can include information associated with file system changes on the machine 3004n. Examples of file system changes can include actions and change types. Examples of actions can include created, read, modified, and deleted. Examples of change types can include filesystem and AAA.

The following table provides examples of attribute values that could represent the number of times the associated file system change attributes were detected on the machine 3004n.

| File System Change Attribute | Attribute Value |
|---|---|
| Created | 5 |
| Read | 6 |
| Modified | 3 |
| Deleted | 8 |
| filesystem | 17 |
| AAA | 5 |

Thus, the file system change data of the machine 3004n could be represented as:

| | Created | Read | Modified | Deleted | filesystem | AAA |
|---|---|---|---|---|---|---|
| Machine n | 5 | 6 | 3 | 8 | 17 | 5 |

Intrusion detection data provided to the intrusion detection logging agent 3005f can include information associated with detected attacks on machine 3004n. Intrusion detection data may be gathered by one or more applications on the machine 3004n, or may be gathered by other network monitoring devices. Examples of intrusion detection data can include intrusion detection system type (i.e., the type of intrusion detection system that generated the event) and severity. Examples of intrusion detection system types can include network, host and application. Examples of severity include critical, high, medium and low.

The following table provides examples of attribute values that could represent the number of times the associated intrusion detection attributes were detected on the machine 3004n.

| Intrusion Detection Attribute | Attribute Value |
|---|---|
| Network | 12 |
| Host | 4 |
| Application | 8 |
| Critical | 8 |
| High | 7 |
| Medium | 5 |
| Low | 4 |

Thus, the intrusion detection data of the machine 3004n could be represented as:

| | | | Appli- | | | | |
|---|---|---|---|---|---|---|---|
| | Network | Host | cation | Critical | High | Medium | Low |
| Machine n | 12 | 4 | 8 | 8 | 7 | 5 | 4 |

As described further herein, the attribute data including machine data, vulnerability data, malware data, authentication data, file system changes, and intrusion detection data is collected by the logging agents 3005a-3005f Logging agents 3005a-3005f store the attribute data in a database 3006. The database 3006 can be accessed by the similarity engine (not shown) to obtain attribute values 3007.

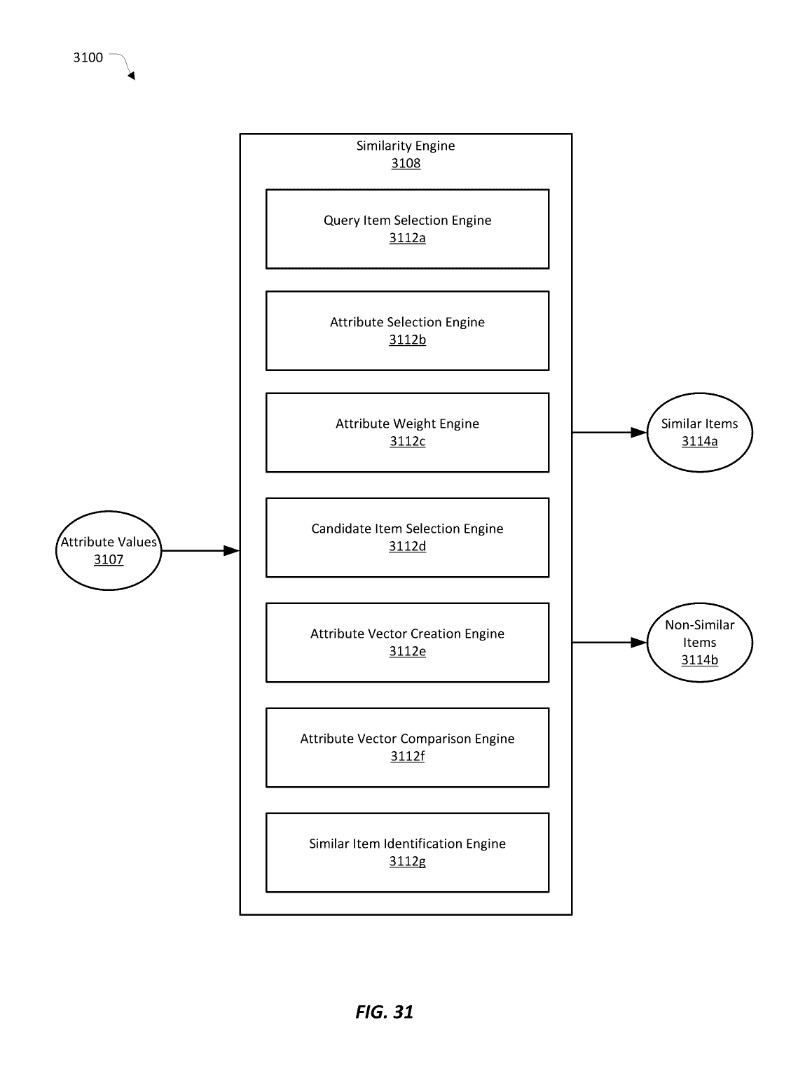

FIG. 31 illustrates an example of a similarity engine 3108 in a system 3100 for identifying a similar item 3114. The similarity engine 3108 may be similar to similarity engine 2908 of FIG. 29. The similarity engine 3108 of FIG. 31 receives attribute values 3107. The attribute values 3107 may be similar to the attribute values 3007 of FIG. 30. Similarity engine 3108 of FIG. 31 outputs similar items 3114a and/or non-similar items 3114b.

The similarity engine 3108 includes a plurality of engines 3112a-3112g for determining the similar items 3114a. The engines include a query item selection engine 3112a, an attribute selection engine 3112b, an attribute weight engine 3112c, a candidate item selection engine 3112d, an attribute vector creation engine 3112e, an attribute vector comparison engine 3112f, and a similar item identification engine 3112g. Although shown and described as having seven engines 3112a-3112g, it is contemplated that any number and combination of engines may be provided by the similarity engine 3108, including additional engines performing additional functions that are not shown. It is contemplated that the engines 3112a-3112g may be implemented on one or multiple servers associated with the similarity engine 3108. Further, it is contemplated that some or all of the data needed to perform the functions of the engines 3112a-3112g may be provided or determined automatically by the similarity engine 3108, or may be specified by a user.

The query item selection engine 3112a is configured to determine a query item from which to compare candidate items to determine if they are similar. The query item is associated with a compromised machine of a plurality of machines. In some implementations, the query item may be a compromised machine. In other implementations, the query item may not be a particular machine, but may be an item defined by a set of attributes associated with one or more compromised machines. In other implementations, the query item may be a population centroid of a plurality of compromised machines.

The attribute selection engine 3112b is configured to select one or more attributes associated with the query item for comparison to similar attributes of candidate items. Any or all of the attributes of the query item may be selected for comparison. In the implementations in which the query item is associated with more than one compromised machine, the selected attributes may be common attributes across multiple or all compromised machines. For example, if a majority of compromised machines of a population centroid were running an application that detected a critical intrusion, the “application” and “critical” attributes of the intrusion detection data (e.g., intrusion detection data described with respect to FIG. 30) may be selected for comparison. In some implementations, the attribute selection engine 3112b of FIG. 31 selects attributes based on domain knowledge. The attribute selection engine 3112b may update or change the selected attributes for future iterations as similar items are characterized and confirmed.

The attribute weight engine 3112c is configured to assign initial attribute weights to the one or more attributes, and to update the attribute weights for future iterations as similar items are characterized and confirmed. The attribute weights assigned may be any value (e.g., between 0 and 1, between 0 and 100, etc.). In some implementations, the attribute weight engine 3112c assigns attribute weights equally, and updates the attribute weights after similar items are determined. In some implementations, the attribute weight engine 3112c assigns attribute weights based on domain knowledge. For example, if the selected attributes include both an operating system type (e.g., in machine data described with respect to FIG. 30) and a deleted file in the file system (e.g., in file system changes), it may be determined that the “deleted” attribute of the file system change data is more significant than the “OS” attribute of the machine data. This may be, for example, because the operating system type may not be as critical to the attack, because the same deleted file attack has occurred across multiple different operating systems, etc. Thus, in this example, the “deleted” attribute may be assigned a weight (e.g., 0.75) that is higher than the weight assigned to the “OS” attribute (e.g., 0.25).

The attribute weight engine 3112c of FIG. 31 is configured to weigh the received attribute values 3107 (for both a query item and candidates items) according to their assigned weights, for example, by multiplying the attribute value by its associated attribute weight. The attribute weight engine 3112c is also configured to update the attribute weights for future comparisons of the query item to candidate items, as similar items are characterized and confirmed (e.g., through feedback).

The candidate item selection engine 3112d is configured to select one or more candidate items (e.g., machines on a network) with which to compare the determined query item. The candidate items may include all of the machines on a network, a subset of machines on the network, or a single machine on the network. A subset of machines may be selected as candidate items randomly or by using domain knowledge. For example, a subset of machines may be selected as candidate items based on their colocation with the query item within the network.

The attribute vector creation engine 3112e is configured to construct attribute vectors for the one or more selected attributes using the attribute values 3107. The attribute vector creation engine 3112e constructs the vectors for both the query item and the one or more candidate items. For example, if the “success”, “failure”, “unknown”, “ssh”, and “splunk” attributes of authentication data described with respect to FIG. 30 are selected, an attribute vector, U, may be created as follows:

U={u₁,u₂,u₃,u₄,u₅}={u_{success},u_{failure},u_{unknown},uₛₛₕ,uₛₚₗᵤₙₖ}

By assigning each of these attributes the exemplary attribute values discussed above with respect to FIG. 30, the following vector would result:

U={5,6,4,10,5}

The attribute vector creation engine 3112e of FIG. 31 may further be configured to normalize the attribute vector to remove the bias from high or low attribute values. In some implementations, this is accomplished by converting the values in the vector to values between 0 and 1. In one example, the values may be converted to a scale between 0 and 1 by dividing each attribute value by the total number of logged events for a given attribute type. For the authentication attribute type in the example above, fifteen authentication events were logged (i.e., five successes, six failures, and four unknowns; ten involving the “ssh” application, and five involving the “splunk” application). Thus, the normalized attribute vector would be as follows:

U={(5÷15),(6÷15),(4÷15),(10÷15),(5÷15)}={0.33,0.4,0.27,0.67,0.33}

In some implementations, individual attribute values of this vector would further be weighted by the attribute weight engine 3112c before being compared by the attribute vector comparison engine 3112f.

The attribute vector comparison engine 3112f is configured to determine a distance between the attribute vector of a query item and a random vector (“query item distance”), to determine a distance between the attribute vector or one or more candidate items and the random vector (“candidate item distance”), and to determine a distance between the query item distance and the candidate item distance (“comparison value”). In some implementations, a hash function is applied to the attribute vectors to determine Euclidian distances between those vectors and the random vector. The random vector may be of the same dimension as the attribute vectors. In some implementations, the query item distance is compared to each candidate item distance to generate a comparison value.

In various implementations, the hash function computation is performed on many or all of the candidate items to generate their candidate item distances, before comparing them to the query item distance. The candidate item distances are used to create buckets of candidate items based on their candidate item distances as compared to the query item distance. The individual candidate item distances of the candidate items in the bucket closest to the query item distance can be compared to the query item distance to generate comparison values.

The similar item identification engine 3112g is configured to determine whether the comparison values are within a threshold value. If they are within a threshold value, those candidate items may be characterized as similar items 3114a to the query item. Other candidate items not within the threshold value may be characterized as non-similar items 3114b. The threshold value may be selected randomly or based on domain knowledge. Once similar items 3114a are identified, one or more can be used as a host for deception mechanisms, can be taken off the network as being likely compromised or likely to become compromised, or can be quarantined.

XI. Sensor

As discussed above, a deception center may be in communication with one or more sensors that have been installed in a site network. In various implementations, a sensor may be a hardware and/or software appliance that can be installed as a node in a site network. For example, a desktop computer, a laptop computer, a blade computer, or a mini computer (such as a Raspberry Pi) can be configured as a sensor. As another example, a sensor can be an application running on a network device, such as a server, router, or computer.

Typically, a sensor is assigned to a specific deception center. In various implementations, sensors provide its assigned deception center with visibility into, and presence on, a site network. For example, because a sensor is a node one a network, using its connection to the sensor, the deception center may be able to transmit queries to other nodes on the same network, while the deception center itself is located on another network. As another example, the deception center may be able to present or project emulated network devices on the network to which a sensor is connected. In some implementations, sensors may provide a deception center with visibility and presence in more than one site network.

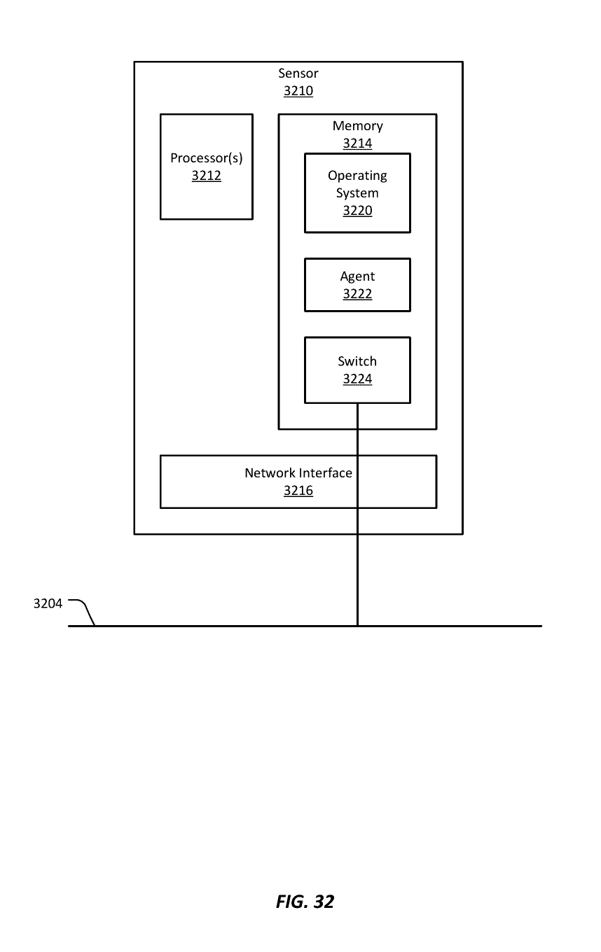

FIG. 32 illustrates an example implementation of a sensor 3210 implemented in a combination of hardware and software. In this example, the example sensor 3210 may be a computing device that includes one or more processors 3212, a memory 3214, and a network interface 3216. In other implementations, the sensor 3210 may be implemented using an Application Specific Integrated Circuit (ASIC), Field Programmable Gate Array (FPGA), or System-on-a-Chip (SoC) configured to perform the operations described below.

The sensor 3210 is typically connected to a network 3204. The network 3204 is one of possibly multiple networks that is being monitored and protected by a deception center. The network 3204 may be, for example, a subnetwork in a site network. The deception center itself may be connected to the same network 3204, or may be connected to a different network that can communicate with the illustrated network 3204.

In various implementations, the memory 3214 on the sensor 3210 may store code for an operating system 3220, an agent 3222, and a switch 3224. In various implementations, the operating system 3220 may be a fully functional operating system, a minimized or reduced size operating system, or a custom operating system. For example, the operating system 3220 can be a Linux-based operating system. When executing, the operating system 3220 may manage basic functionality for the sensor 3210, such as network operations. For example, the operating system 3220 may manage connecting the sensor 3210 to a network 3204, including, for example, learning the subnet address of the network 3204, obtaining an IP address 3204 for the sensor 3220, and/or learning about other network devices on the network 3204.

In various implementations, the agent 3222 may manage communications with and instructions from the deception center. The agent 3222 may be an application running, for example, in the kernel or user space of the operating system 3220. The agent 3222 may manage operations such as obtaining the network location of a deception center for the network 3204, establishing a communication channel with the deception center, and/or (as discussed further below) hiding the IP address of the sensor 3210. In some implementations, the functions and operations of the agent 3222 may be included in the operating system 3220.

To obtain the network location of its assigned deception center, the agent 3222 may automatically communicate with, for example, a security services provider. The security services provider may have a registry of deception centers and the sensors assigned to each deception center. Alternatively or additionally, the agent 3222 may obtain the network location of the deception center from information pre-programmed into the memory, such as for example from a configuration file. Alternatively or additionally, the agent 3222 may be manually configured, for example by a network administrator, with the location of its deception center.

Establishing a communication channel with the deception center may include, for example, configuring a network tunnel. The network tunnel may provide a private and/or secure communication channel, over the network 3204 and possibly other intervening networks, between the sensor 3210 and its deception center. The agent 3222 may be configured to use one of various tunneling protocols, such as HTTP, ICMP, SSH, GRE, or a similar tunnel protocol.

The agent 3222 may be assisted in establishing and managing a tunnel to the deception center by a switch 3224. In various implementations, the switch 3224 may be a hardware device. In this example, the switch 3224 is a software switch. For example, the switch 3224 may be an Open vSwitch (OVS) distributed multi-layer switch. A software switch may provide the same functionality as is provided by a hardware switch, including connecting computing devices (including virtual computing devices) to a network. In this example, the switch 3224 uses the sensor's 3210 network interface 3216 to connect to the network 3204. In various implementations, the switch 3224 may host the endpoint for the tunnel to the deception center. For example, the switch 3224 may include a Virtual eXtensible LAN (VXLAN) tunnel endpoint (VTEP).

Once the agent 3222 has established a communication channel with the deception center, the switch 3224 may then act as a portal between the network 3204 and the deception center. For example, through the switch 3224, the deception center can present or project emulated network devices as deception mechanisms on the network 3204. The deception center may host a number of emulated network devices. These emulated network devices may include as few as a handful of servers or desktops, or may include entire networks of devices. The emulated network devices may include address deceptions mechanisms, low-interaction deception mechanisms, and/or high-interaction deception mechanisms, or a combination of deception mechanisms. The emulated network devices are intended to serve as decoys on the network 3204, where the emulated network devices can distract and/or divert possible attacks away from the actual devices on the network 3204.

To make the emulated network devices appear on the network 3204, the endpoint of the tunnel may be connected in the deception center to a emulated network in the deception center, where the network emulated hosts the emulated network devices. In some implementations, the emulated network may include a switch, which may be a software switch, that is able to host the tunnel endpoint. In some applications, network tunnels provide a way to transparently connect network devices and/or networks together, so that the network devices and/or network function as one seamless network. Thus, once the tunnel is connected between the sensor 3210 and the deception center, the emulated network devices hosted by the deception center may seamlessly appear on the network 3204. Stated another way, the emulated network devices are presented as if they are devices on the network 3204. Stated yet another way, the emulated network devices are projected through the tunnel and onto the network 3204.

Once the presence of the emulated network devices have been established on the network 3204, the tunnel may act as a portal between the site network and the emulated network devices. For example, packets addressed to the emulated network devices may be received by the sensor's 3210 switch 3224, and be automatically sent over to the tunnel to the deception center. Similarly, any network traffic originated by the emulated network devices may be automatically sent over the tunnel to devices attached to the network 3204.

In reality, however, network traffic directed to the emulated network devices is received by the sensor 3210. Should an attacker on the network 3204 be able to detect the sensor's 3210 presence on the network 3204, the attacker may be able to determine that the emulated network devices are only decoys, and not real network devices. In order to hide the presence of the sensor, the agent 3222 and/or the switch 3224 may be configured to prevent the sensor 3210 from responding to both specific and routine network packets. Specific packets may include, for example, network traffic addressed to the sensor's 3210 own IP address. Routing packets may include multicast and broadcast network traffic, such as address resolution protocol requests, domain host configuration packets, or routing table updates. By not responding to any packets, it may appear that the sensor 3210 is not present on the network.

XII. Deception Center Example

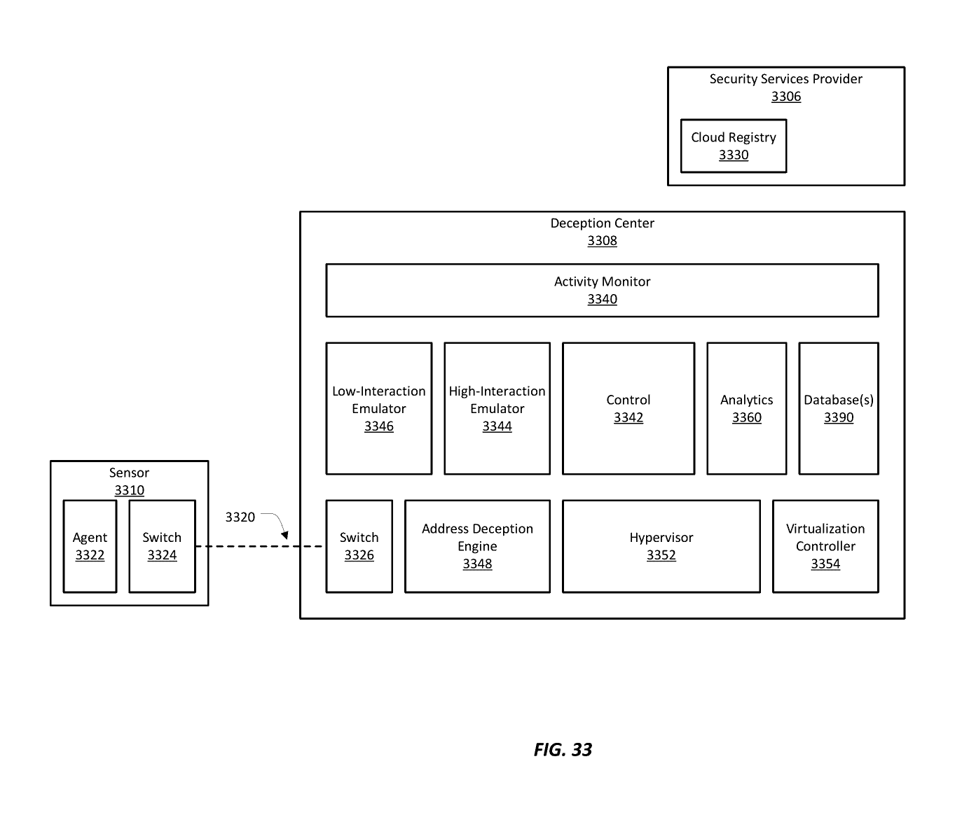

FIG. 33 illustrates an example implementation of a deception center 3308. As discussed above, a deception center may include various engines for profiling a site network, monitoring threats to the site network, analyzing threats that have been allowed to proceed within an emulated network, determine the trajectory of an attack, and/or to locate network devices similar to those that may have been affected by an attack. The deception center 3308 of FIG. 33 illustrates an example of hardware and/or software that may be used to implement these engines. In various implementations, the deception center 3308 may include systems and services, including hardware and/or software systems and services, configured to support communication with a sensor 3310, to support emulation of network devices, for control and analytics, and to store data.

In various implementations, to communicate with one or more sensors 3310, the deception center 3308 may include a switch 3326. The switch 3326 may be a software or a hardware switch. For example, the switch 3326 may be implemented using OVS. In various implementations, the switch 3326 may host an endpoint for a tunnel 3320 to the sensor 3310. For example, the switch 3326 may include a VTEP. In various implementations, the switch 3310 may have a corresponding switch 3324. The switch 3324 on the sensor 3310 may host the other endpoint for the tunnel 3320. The sensor 3310 may also have a hardware and/or software agent 3322 that may manage the tunnel for the sensor 3310.

To establish the tunnel between the deception center 3308 and the sensor 3310, in various implementations the deception center 3308 an the sensor 3310 may be in communication with a security services provider 3306. The security services provider 3306 may be co-located with either the sensor 3310, the deception center 3308, or both the sensor 3310 and the deception center 3308, where “co-located” means in the same geographic location and/or in the same network. Alternatively, the security services provider 3306 may be located at a different geographic location and on a different network from either the sensor 3310 or the deception center 3308. The security services provider 3330 may include a cloud registry 3330, which may be used to track the sensors that are assigned to each of possibly multiple deception centers. The deception center 3308 and the sensor 3310 may communicate with the security services provider 3306. Using the cloud registry 3330, the security services provider 3306 may inform the sensor 3310 of the network location of its assigned deception center 3308. The security services provider 3306 may also inform the deception center 3308 of the network location of each of its assigned sensors 3310. Once the deception center 3308 and sensor 3310 have each other's network location, the deception center 3308 and sensor 3310 can establish the network tunnel 3320.

In various implementations, the sensor 3310 and/or deception center 3308 do not communicate with the security services provider 3306, In these implementations, the deception center 3308 and the sensor 3310 may learn of each other's network location in some other manner. For example, the deception center 3308 and the sensor 3310 may send queries into their local network. Alternatively or additionally, the deception center 3308 and the sensor 3310 may be provided with a configuration file. Alternatively or additionally, the deception center 3308 and the sensor 3310 may be configured by a network administrator.

In various implementations, to support the emulation of network devices, the deception center 3308 may include an address deception engine 3348, one or more a low-interaction emulators 3346, and one or more high-interaction emulators 3344. To supported the address deception engine 3348, low-interaction emulators 3346, and high-interaction emulators 3344, the deception center 3308 may also include a hypervisor 3352, and a virtualization controller 3354.

The address deception engine 3348 may host one or more address deceptions. For example, the address deception engine 3348 may include an address resolution protocol (ARP), and may be capable of responding to requests for address information originating in the network where the sensor 3310 is located.

The low-interaction emulators 3346 may host one or more low-interaction deceptions. For example, each low-interaction emulator 3346 may host one or more virtual machines, where each virtual machine is configured as a low-interaction deception. In this example each virtual machine may include a guest operating system, various emulated services, a virtual network interface, and/or an agent configured to manage deception operations. In various implementations, the guest operation system may be a basic installation of an operating system that can be found in the site network that is being monitored by the deception center 3308. The emulated services may mimic the kind of services that may be provided by network devices in the site network that are running a variation of the guest operating system. The virtual network interface may be configured with multiple IP addresses, where each IP address is associated with a distinct MAC address. Using the IP and MAC address pairs, the virtual machine may be able to emulate multiple network devices, each of which can be projected through the sensor 3310 into a site network.

The high-interaction emulators 3344 may host one or more high-interaction deceptions. For example, each high-interaction emulator 3344 may host one or more virtual machines, where each virtual machine is configured as a high-interaction deception. In this example, each virtual machine may include a specific variation of a guest operating system and a virtual network interface. The guest operating system may, in a high-interaction deception, include specific patches, libraries, services, or update, among other variations, that may be found in a specific network device in the site network. Because a high-interaction deception is intended to provide only one deception mechanism, the virtual network interface is typically configured with one IP and one MAC address. In various implementations, the virtual machine may also have a unique identifier that helps the virtual machine to look like a production network device. For example, the virtual machine may have a distinct network name, serial number, or network tag, among other things. Generally, the virtual machine for a high-interaction deception can be quickly reconfigured to resemble a distinct network device in the site network, and/or to resemble a specific network device in the site network. The network device being emulated can be projected through the sensor 3310 into site network.

To support the virtual machines being hosted by the low-interaction emulator 3346 and the high-interaction emulator 3344, the deception center 3308 may include a hypervisor 3352 and a virtualization controller 3354. A hypervisor is a piece of computer software, firmware, or hardware that creates and runs virtual machines. Hypervisors may manage virtual machines' access to the hardware resources of the host system (which here is the deception center 3308). The virtualization controller 3354 is a service (such as a daemon) and management tool for managing computer hardware virtualization. Computer hardware virtualization is the virtualization of computers as complete hardware platforms, certain logical abstractions of their componentry, or only the functionality required to run various operating systems. Virtualization hides the physical characteristics of a computing platform from the user applications, presenting instead another abstract computing platform.

To manage the operations of the deception center 3308, the deception center 3308 may include a control module 3342. The control module 3342 may manage operations such as messaging between the various components of the deception center 3308 and/or between the deception center 3308 and the sensors 3310; configuration of the deception center 3308 and its components, scheduling of the various activities of the deception center 3308; orchestration of the operations of the deception center 3308; administration of the hardware and/or software operations of the deception center 3308; and/or the operation of one or more web servers.

For network threat detection and analysis, in various implementations the deception center 3308 may include an analytics module 3360 and a database 3390. The analytics module 3360 may conduct operation such as detecting possible attacks, determine which deceptions are needed, and/or analyzing data captured by the low-interaction emulator 3346 and the high-interaction emulator 3344. Data captured by the low-interaction emulator 3346 and the high-interaction emulator 3344 may be stored in the database 3390. In various implementations, the database 3390 may also store information such as threat intelligence, and/or information about the site network, such as the configuration of the site network and the various network devices in the site network.

To oversee the operations of the deception center 3308 and its various sensors 3310, the deception center 3308 may include an activity monitor 3340. In various implementations, the activity monitor 3340 may maintain a global view of the operations of the deception center 3308 and its sensors 3310. For example, the activity monitor 3340 may track communications between the deception center 3308 and the sensors 3310, may track the status of the tunnel 3320 (e.g., disconnects and/or reconnects), and/or the activity level of the deception center 3308 (e.g. the number and/or type of attacks detected, idle time and busy time, uptime and downtime, etc.).

XIII. Detecting Security Threats Using Deception Systems and Data Science

In various implementations, the systems and methods discussed above can be used to implement a dynamic network threat detection system. Generally, deception-based security mechanisms, such as honeypots, honey tokens, honey nets, and others, are statically or predictably configured, and are statically placed into a network. As a result, deception-based security mechanisms can be easy to locate and avoid. Thus, in various implementations, a network threat detection system can use deception-based security mechanisms in a targeted and dynamic fashion. By reacting to data received from a network, or by predicting possible future network behavior, the network threat detection system can modify, add, or remove deception mechanisms to attract or divert threats to a network. The deception mechanisms can further be used to confirm a potential threat as an actual threat. In various implementations, the deception mechanisms can also be used to analyze a threat, and produce indicators that describe and/or identify the threat. These indicators can then be used to improve the security of a network.

In various implementations, a network threat detection system can also use data science techniques to analyze network data. Examples of data science techniques include clustering network systems with similar features, statistical analysis that relates network activity to known attack patterns, scoring models that indicate a probability of a threat affecting particular parts of a network, predictive analysis that determines probable future network behavior, and correlation of an attack pattern to known attack patterns. Other data science techniques include data mining, machine learning, and game theory.

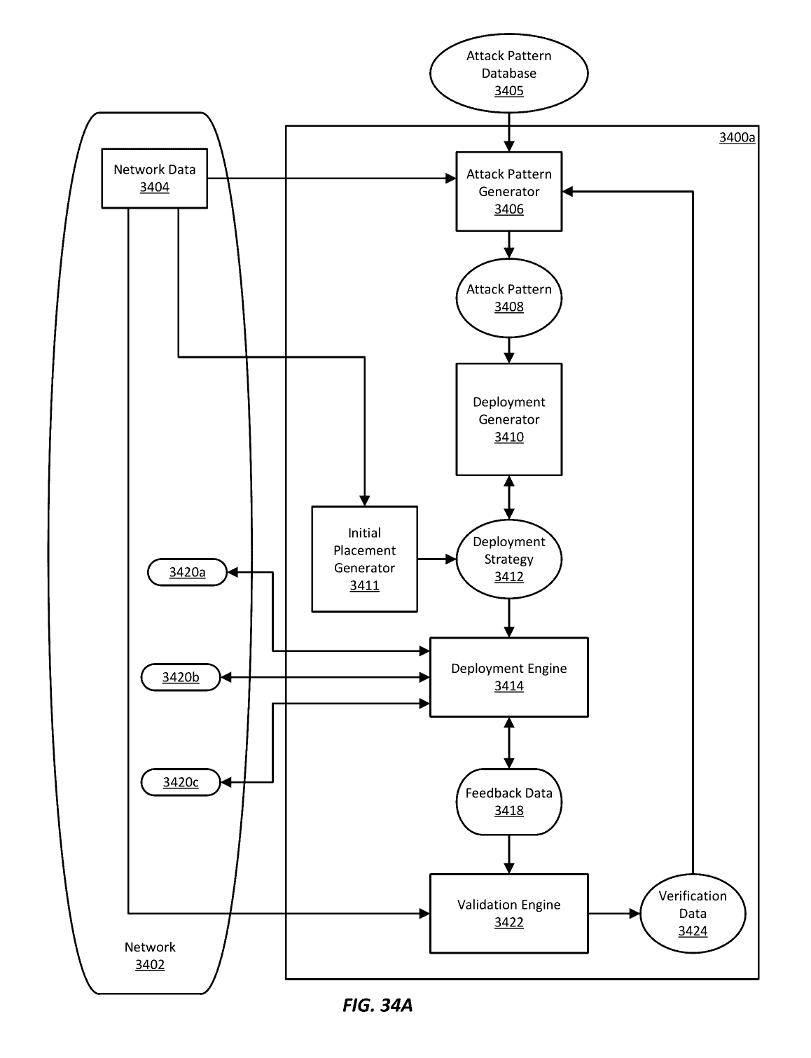

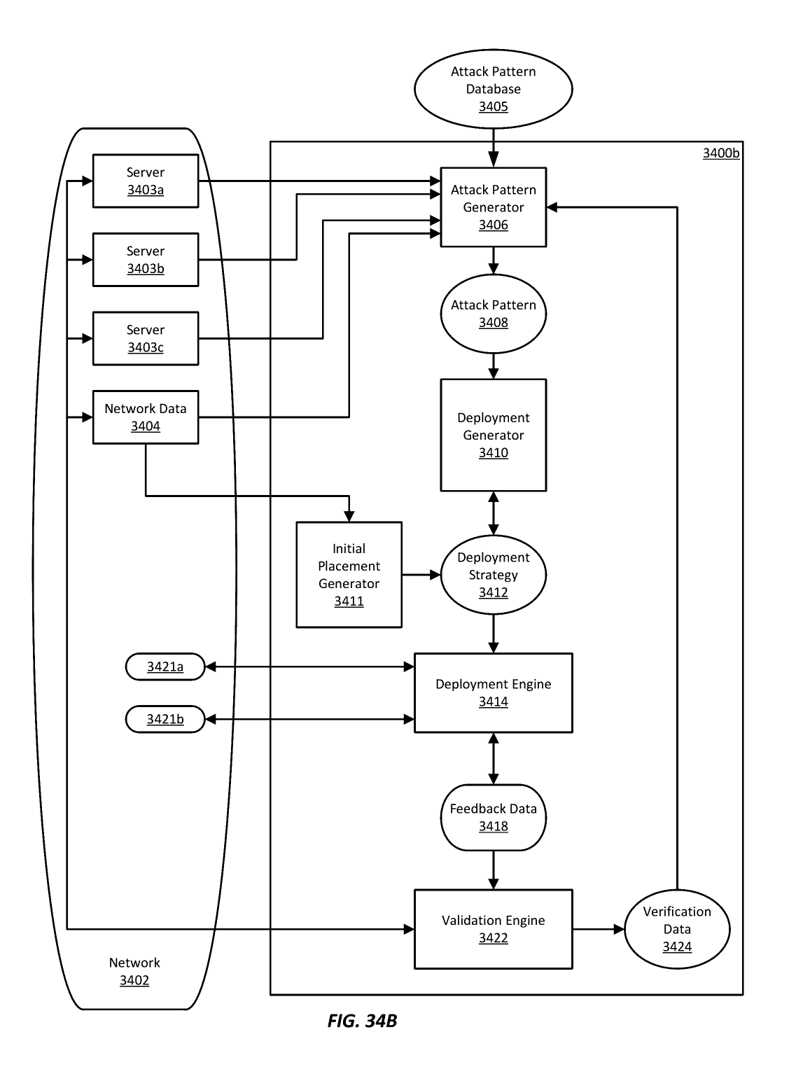

FIGS. 34A-34B illustrate examples of network threat detection systems 3400a, 3400b that use static and/or dynamic security mechanisms to locate, identify, and confirm a threat to a network 3402. The various components of the threat detection systems 3400a, 3400b may be implemented as discreet hardware components, as software components executing on different computing systems, as software components executing on one computing system, or as a combination of hardware components and software components in one or multiple computing systems. The threat detection systems 3400a, 3400b can be implemented to monitor an enterprise network, a cloud network, or a hybrid network that includes local network resources and network resources in the cloud.

The threat detection system 3400a of FIG. 34A may be monitoring a network 3402, which can be a customer network. The threat detection system 3400a can include an initial placement generator 3411 and an attack pattern generator 3406, which can collect network data 3404 from the network 3402. As discussed further below, this network data 3404 may come from various sources in the network 3402, such as production servers, virtual machines, and network infrastructure devices. These devices can provide log files, network packets, email, files, links, and other information. Additional network data 3404 can be provided by network security systems, such as perimeter defense systems, deception-based systems, intrusion detection systems, data science systems, and SIEM systems.

In various implementations, the network data 3404 may be structured or unstructured. Unstructured data is information that does not adhere to a pre-defined data model, or is not organized in a pre-defined manner. Unstructured data files often include text and/or multimedia content. Examples of unstructured data files include email messages, word processing documents, videos, photos, audio files, presentations, webpages, and other kinds of business documents. Though these files may have an internal structure, the data that they contain is considered “unstructured” because the data is not in an easily indexable format. In contrast, structured data generally resides in a readily indexable structure, such as a relational data base or a table. In various implementations, the network data 3404 may be stored locally to the threat detection system 3400a, for example in local storage drives. Alternatively or additionally, the network data 3404 can be stored remotely, for example in remote storage drives, or in a cloud storage system.

The network data 3404 can include information about network devices in the network. For example, the network data 3404 can include the number of network devices in the network 3402, the type of each device in the network 3402 (e.g., a desktop computer, a laptop computer, a tablet computer, a file server, a compute server, a router, a switch, etc.), identification information for a network device (e.g., an IP address, a MAC address, a manufacturer's identifier, a network name, etc.), a hardware configuration for the network device (e.g., a CPU type, a memory size, a hard drive size, the number and type of peripheral devices, a number of network ports, etc.), or a software configuration (e.g., an operating system type and/or version, installed applications, enabled services or ports, etc.), among other information about network devices.

In various implementations, the network data 3404 can include information about data included in the network 3404. For example, the network data 3404 can include types of various data (e.g., user data, customer data, human resources data, financial data, database data, etc.), locations in the network of data (e.g., file systems, databases, storage arrays, etc.), access privileges for data (e.g., who can read, write, and/or modify the data), or a value of the data (e.g., a monetary value, a privacy value, a secrecy value, or a combination of values), among others.

In various implementations, the network data 3404 can include information about a structure of the network. For example, the network data 3404 can include the location of network infrastructure devices (e.g., routers, switches, hubs, gateways, firewalls, etc.), the configuration of subnets within the network (e.g., the subnet address of a subnet, the relationship between one subnet and another, etc.), or the configuration of one or more VLANs in the network (e.g., what parts of the network are associated with each VLAN, which VLANs are on the same trunk, the addresses of each VLAN, etc.), among information about the structure of the network.

In various implementations, the network data 3404 can include network security information. For example, the network data 3404 can include information provided by network firewalls, anti-virus tools, IDS and IPS systems, and SIEM systems, among others. The information provided by these network security systems can include alerts, which may or may not reflect an actual threat to the network.

Using the network data 3404, the initial placement generator 3411 can make an initial selection and placement of security mechanisms in the network. The selection and placement, at this stage, is based primarily on the network data 3404, while later deployment of security mechanisms may be based on network data 3404 and data received from previously deployed security mechanisms.

In various implementations, the initial placement generator 3411 selects and configures security mechanisms that are appropriate for the particular network 3402. For example, the security mechanisms can be made to resemble the computing devices commonly found in the network 3402, including for example the type of a computing device (e.g., personal computers or rack-mounted server computers), the manufacturer of the computing device, the operating system run by the computing device, and/or the services available on the computing device.

In various implementations, the initial placement generator 3411 determines locations for the security mechanisms based on the configuration and use of the network 3402, as indicated by the network data 3404. In various implementations, the initial placement generator 3411 may distribute security mechanisms across the network 3402, and/or may concentrate security mechanisms in key points in the network 3402. For example, the initial placement generator 3411 can place security mechanisms at gateways or other entry points to the network 3404. Alternatively or additionally, the initial placement generator 3411 can place security mechanisms at common vulnerability points, such as where users can be found.

In various implementations, the initial placement generator 3411 may use a variety of data science techniques to generate a deployment strategy 3412. For example, the initial placement generator 3411 may build and implement a scoring model. In this example, the initial placement generator 3411 may take various network data 3404 as input, including network traffic patterns (e.g., a density of the network traffic, whether any of the network traffic is or is not encrypted, source and destination addresses, etc.), the value of assets such as hardware resources, data, and so on in in the network, previous attack patterns, and current alerts from network security devices, among others. A scoring model can be built based on some or all of these inputs. For example, a high score can be assigned to particularly valuable or vulnerable assets, and a low score can be assigned to less valuable or vulnerable assets. In various implementations, the model can be used to determine the number, position, and configuration of security mechanisms to deploy. The scoring model may be revised periodically based on new or modified inputs and the effectiveness of the previous deployment strategy 3412.

As another example, the initial placement generator 3411 may build and implement a probabilistic model. In this example, the initial placement generator 3411 may build correlation statistics, for example, between traffic patterns, asset types (and numbers), and the previous attack patterns, either in the same network 3402 or from threat intelligence gathered from the greater network security community. For example, when threat intelligence indicates malware has been released that exploits a particular operating system vulnerability, the initial placement generator 3411 can determine a correlation between the manner and methods of the malware and the systems and assets in the network 3402. The correlation can indicate a likelihood that the network 3402 can be affect by the threat, and possibly also which systems can be affected. For example, correlation statistics may to determine the probability of an attack in different subnets, the type of target that may be affected, and a pattern that may be followed by the threat. These probabilities may be used to determine the placement of the static security mechanisms.

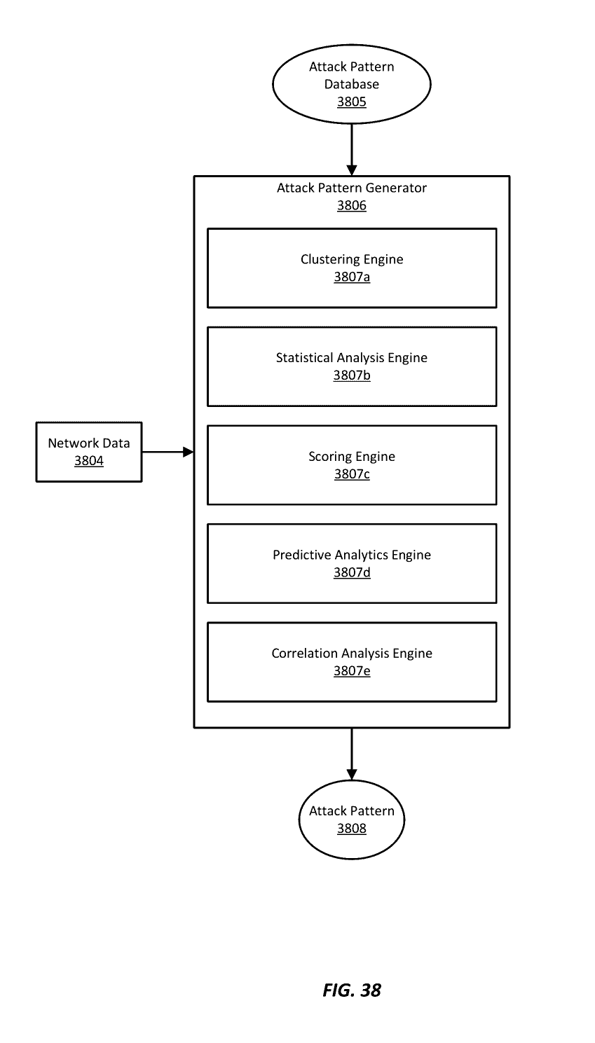

The attack pattern generator 3406 may monitor and/or analyze the network data 3404 in conjunction with previous attack pattern data in a database of known attack patterns 3405. In various implementations, the attack pattern generator can use this information to determine whether a network abnormality has occurred or is occurring. In various implementations, the attack pattern generator 3406 can use data science techniques to analyze the network data 3404, as described further with respect to FIG. 38. An identified network abnormality may fall within acceptable network usage, or may indicate a potential network threat. In these cases, the attack pattern generator 3406 may identify or isolate the pattern of network behavior that describes the network abnormality. This pattern of behavior may be provided as a suspected attack pattern 3408 to a deployment generator 3410.

The deployment generator 3410 may analyze the suspected attack pattern 3408. For example, the deployment generator 3410 may use the suspected attack pattern 3408 to identify within the network data 3404 all identifiable movements and interactions of an attack with the network 3402. The deployment generator 310 may further determine what should be done to confirm that an attack occurred or is in progress. The deployment generator 3410 may have access to various security mechanisms, such as are described in further detail below. The deployment generator 3410 may determine which of the security mechanisms are most likely to be attractive to potential threats. The deployment generator 3410 may further determine how and where in the network 3402 to use or deploy one or more security mechanisms. The deployment generator 3410 may produce one or more deployment strategies 3412 that each include one or more security mechanisms to deploy, as well as how and where in the network 3402 those security mechanisms should be deployed.

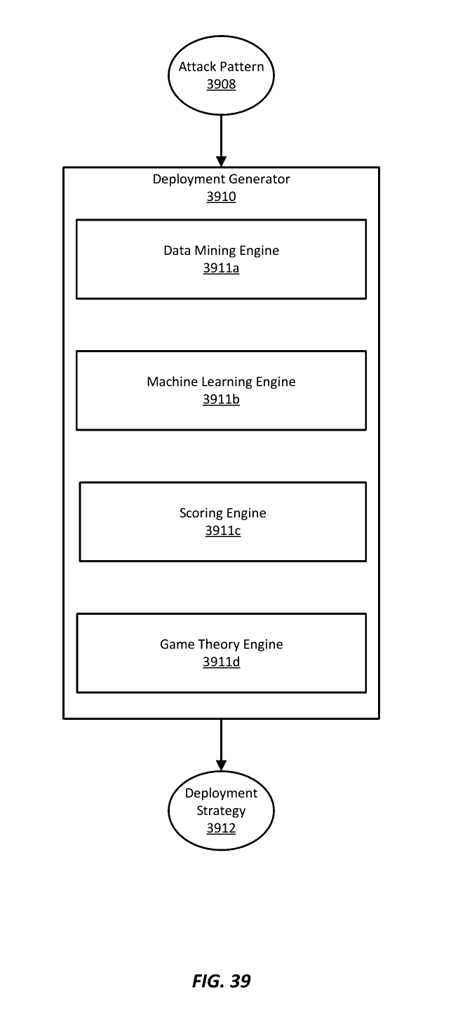

In various implementations, the deployment generator 3410 may employ one or more of a variety of data science techniques to analyze the attack pattern 3408 and adjust the deployment strategy 3412, as described further herein with respect to FIG. 39. These adjustments may be directed towards establishing more attractive traps for the particular potential threat, and/or towards obtaining more information about the particular potential threat. For example, the deployment generator 3410 may call for dynamically adjusting or changing the nature of a previously deployed security mechanism 3420a-3420c. Alternatively or additionally, the deployment generator 3410 may determine that a security mechanism 3420a-3420c can be disabled or removed from the network 3402. Alternatively or additionally, the deployment generator 3410 may cause different security mechanisms to be deployed. Alternatively or additionally, the deployment generator 3410 may change the deployment locations of the security mechanisms. These changes may be reflected in the deployment strategy 3412, and may be implemented by the deployment engine 3414.

The deployment strategy 3412 may be provided to a deployment engine 3414. The deployment engine may deploy one or more security mechanisms 3420a-3420c into the network 3402 in accordance with the deployment strategy 3412. The deployment strategy 3412 may call for placing the security mechanisms 3420a-3420c at locations in the network 3402 where the security mechanisms 3420a-3420c are most likely to attract the attention of potential threats. For example, the security mechanisms 3420a-3420c could be placed in high traffic areas of the network 3402, or portions of the network 3402 having high value or sensitive assets, as indicated by network data 3404.

Once placed in the network 3402, the security mechanisms 3420a-3420c may begin collecting data about activity or interactions related to them. For example, the security mechanisms 3420a-3420c may record each time that they are accessed, what was accessed, and, with sufficient information, who accessed them (i.e., the source of the access or interaction). The security mechanisms 3420a-3420c may provide this data to the deployment engine 3414.

The deployment engine 3414 may provide feedback data 3418 from the security mechanisms 3420a-3420c to a validation engine 3422. Feedback data 3418 represents the data about interactions related to the security mechanisms 3420a-3420c. The validation engine 3422 may analyze the feedback data 3418 from the security mechanisms 3420a-3420c in conjunction with the network data 3404 to identify network abnormalities and to determine whether any actual attacks have occurred or are in progress. In some cases, network abnormalities on the network 3402 may be legitimate activity. For example, a network bot (e.g., an automated system) may be executing a routine walk of the network. In this example, the network bot may be accessing each Internet Protocol (IP) address available, and thus may also access a security mechanism deployed to resemble a network device using a specific IP address. In other cases, however, a network abnormality may be a port scanner that is attempting to collect IP addresses for illegitimate purposes. The validation engine 3422 may use the feedback data 3418 in conjunction with the network data 3404 to confirm that the activity is malicious. The validation engine 3422 may provide verification data 3424, which may include confirmed attacks in some embodiments. Thus, the verification data 3424 may, in some cases, confirm that an attack has occurred or is occurring, and may include some or all of feedback data 3418. In other cases, the verification data 3424 may indicate that no attack has happened, or that more information is needed.

The validation engine 3422 may use one or a variety of data science techniques to analyze network data 3404 and data received from the deployed security mechanisms 3420a-3420c. For example, the validation engine 3422 may implement statistical analysis with pattern matching to generate an attack signature if one or more interactions are part of a new confirmed threat, or may use an existing attack signature to confirm one or more interactions as a threat. Specifically, the validation engine 3422 may determine a digital signature for files, network sources, network traffic, processes, or other information extracted from the network data 3404 or feedback data that is associated with an attack pattern. Specifically, when an attack is identified, certain data may be gathered to determine the particular combination of network packets and services accessed, payloads delivered, files changed on the server, etc. From the activities on the network and on the server, statistical analysis may be used to identify the anomalous activity that belongs to this attack. The signature of the attack pattern can represent the minimal activity that identifies the threat. For example, the activity may be the payload contained in one network packet. In another example, the activity may be the changes to the registry on the server. In still another example, the activity may be a user access.

The validation engine 3422 may alternatively or additionally include a data mining engine. In various implementations, the data mining engine can trace an attack pattern through the network 3402 using attack data, such as who tried to access which service at what port and at what time. For example, if an access is noticed at a security mechanism 3420a-3420c, certain data may be gathered, such as a user identifier associated with the access, the time of the access, the machine from where the access occurred, the type of service accessed, and so on. The data mining engine may then trace back the user access pattern from the network device where the access occurred. The data mining engine may also determine if the accessed machine, as well as other machines, have been compromised.

The validation engine 3422 may alternatively or additionally include a pattern matching engine that may be used in conjunction with big data analysis to analyze the entire network to determine whether the attack pattern or signature is observed anywhere else in the network. The network traffic and host data may be quite large, such as for example in the gigabytes or terabytes range. Big data analysis comprises a set of computational methods to analyze data of such large volume. The signature may be developed by statistical analysis in one embodiment, as described above. In one embodiment, the network may be analyzed along the time axis.

The verification data 3424 may be provided to the attack pattern generator 3406. The attack pattern generator 3406 may analyze the verification data 3424 to adjust the suspected attack pattern 3408 provided to the deployment generator 3410. The threat detection system 3400a may continue monitoring the network 3402 until one or more conditions are satisfied. For example, the threat detection system 3400a may continue monitoring the network 3402 until it is explicitly stopped or paused by a user. If no active threats are detected by the threat detection system 3400a, the initial placement generator 3411 may place and activate new static security mechanisms, and further monitoring may be paused until an interaction has occurred with one of the placed security mechanisms. Monitoring of the network 3402 may also be paused or minimized based on the load on the threat detection system 3400a and network 3402. For example, the priority threshold of the suspected attacks, for which the security mechanisms are deployed, may be adjusted up or down so as to not affect the regular operation of the network 3402.

FIG. 34B illustrates another example of a threat detection system 3400b. The threat detection system 3400b of FIG. 34B may be monitoring a network 3402, which can be a customer network. A initial placement generator 3411 can determine a selection and placement of static security mechanisms in network 3402, such as an initial selection and placement, using network data 3404, and provides that selection and placement as a deployment strategy 3412, as discussed further with respect to FIG. 34A. In the example of FIG. 34B, an attack pattern generator 3406 can receive port scanning alerts from multiple servers 3403a-3403c on the network 3402, as well as other network data 3404. A port scanning alert can indicate that the ports on a server 3403a-3403c have been scanned by a port-scanning tool. Port scanning tools can be used by network attackers to probe networks for information, such as the services provided by the servers 3403a-3403c. This information may indicate vulnerabilities in the network 3402 that can potentially be exploited by an attacker.

Using clustering techniques that categorize data according to similarity, in various implementations, the attack pattern generator 3406 can determine that servers 3403a-3403c that sent scanning alerts have the same application (A1) installed. The application (A1) may offer a particular service (S1) on a particular port (P1). Using predictive analytics with network data and previous attack patterns from attack pattern database 3405 as inputs, the attack pattern generator 3406 can determine the part of the network 3402 where the scan will take place next as part of its attack pattern 3408. For example, database servers in a subnet (SN1) may have been scanned by a user. Based on this previous pattern of scans by the user, predictive analytics may determine that the database servers in a different subnet (SN2) will be accessed next by the user. The attack pattern generator 3406 may use the attack pattern 3408 to identify within the network data movements and interactions of the source of the scan with the network 3402. The attack pattern generator 3406 can further determine whether the same or similar scan happened on any other servers within the network 3402. The latter can be accomplished across the network 3402 using pattern matching techniques. The pattern of behavior may be developed using all of the available information and provided as an attack pattern 3408 to the deployment generator 3410.

The deployment generator 3410 may use this information to develop a deployment strategy 3412. For example, the deployment strategy 3412 may specify the deployment of two server deception systems 3421a, 3421b, in network 3402, configured to emulate the service (S1) offered by the application (A1) on the same port (P1). The emulated service at one server deception system 3421a may have the same authentication as the production servers 3403a-3403c. Should this server deception system 3421a be accessed using this authentication, then it is possible that the production servers 3403a-3403c have previously been broken into. The emulated service at the second server deception system 3421b may be made vulnerable, such as for example by being configured with weak authentication, no authentication, or with a default username and password.

The deployment strategy 3412 may be provided to a deployment engine 3414. The deployment engine may deploy the server deception systems 3421a, 3421b into the network 3402 in accordance with the deployment strategy 3412.

Once placed in the network 3402, the server deception systems 3421a, 3421b may begin collecting detailed data about activity or interactions related to them. For example, the server deception systems 3421a, 3421b may record each time that they are accessed, what was accessed, and, with sufficient information, who accessed them (i.e., the source of the access or interaction). The server deception systems 3421a, 3421b may provide this data to the deployment engine 3414.

The deployment engine 3414 may provide feedback data 3418 from the server deception systems 3421a, 3421b to a validation engine 3422. Feedback data 3418 represents the data about interactions related to the server deception systems 3421a, 3421b. The validation engine 3422 may analyze the feedback data 3418 from the server deception systems 3421a, 3421b in conjunction with other network data 3404, including detailed network traffic logs and data from servers 3403a-3403c, to identify network abnormalities and to determine whether any actual attacks have occurred or are in progress.

From this data, the validation engine 3422 may, for example, determine that both server deception systems 3421a, 3421b have been scanned, and that the second server deception system 3421b, having weak authentication, was accessed. Thus, in this example, the validation engine 3422 may confirm the threat as an attack inside the network 3402 targeting the application (A1), but note that the attacker does not have the proper credentials to break into the application (A1) yet. In other words, the attacker cannot yet access the first server deception system 3421a, which is configured with strong authentication. The validation engine 3422 may provide this information in the form of verification data 3424.

The verification data 3424 may be provided to the attack pattern generator 3406. The attack pattern generator 3406 may analyze the verification data 3424 to adjust the suspected attack pattern 3408 provided to the deployment generator 3410. Corrective action may then be taken. For example, the deployment generator 3410 may use the verification data 3424 to dynamically adjust the deployment strategy 3412, as described further above with respect to FIG. 34A. Further, network traffic log collection may be initiated in the parts of the network 3402 where the application (A1) has been deployed, if logs are not currently being collected at those locations.

The threat detection systems 3400a, 3400b illustrated in FIGS. 34A-34B may, using the components and data described above, determine whether a network abnormality is an acceptable and legitimate use of the networks 3402 and 3402, or whether the network abnormality is an actual threat to the networks 3402 and 3402. In some implementations, the threat detection systems 3400a, 3400b may also be able to take action to stop perceived threat.

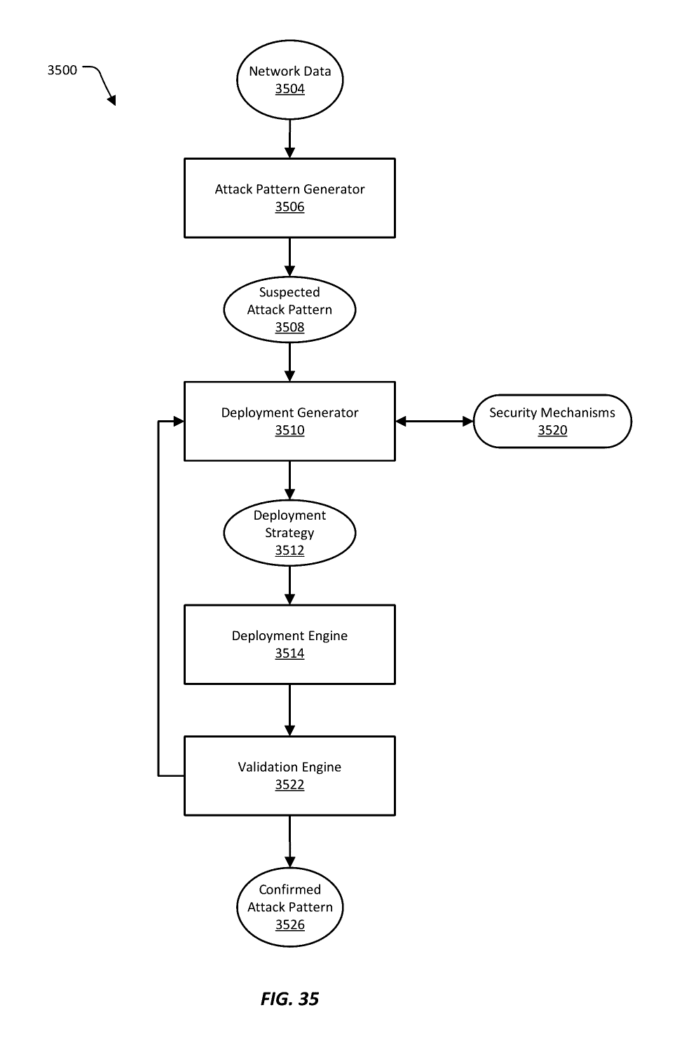

FIG. 35 illustrates an example of a process 3500 for confirming a network abnormality as an actual threat. In the process 3500, network data 3504 can be provided to an attack pattern generator 3506. The network data 3504 may include alerts and raw log files, and/or other data from a network, as discussed further below. The attack pattern generator 3506 can analyze the network data 3504 and provide a suspected attack pattern 3508. The suspected attack pattern 3508 can describe a pattern of behavior that may indicate that a network abnormality may be a threat. For example, the network data 3504 can include a large amount of data, produced by network devices and network security devices on the network. In various implementations, the attack pattern generator 3506 may be able to extract from all of this data a pattern of behavior that is specifically related to a network abnormality. The pattern of behavior can include, for examples, login attempts, network scans, systematic movement around the network, and uses of particular IP addresses, among others. The extracted pattern of behavior can be provided as the suspected attack pattern 3508.

The suspected attack pattern 3508 may be provided to a deployment generator 3510. The deployment generator 3510 may have access to a number of deployed and un-deployed security mechanisms 3520. In various implementations, the un-deployed security mechanisms 3520 can be provided as descriptions of the security mechanisms (e.g., a computer type, operation system version, and data set), or a snapshot of a security mechanism (e.g., data for a populated database), among others. The deployment generator 3510 can use the suspected attack pattern 3508 to generate a deployment strategy 3512. The deployment strategy 3512 can include one or more security mechanisms 3520, as well as information about how, where, and/or when the security mechanisms 3520 should be deployed into a network. The deployment strategy 3512 may further include the sequence in which the security mechanisms 3520 should be deployed.

The deployment strategy 3512 may be provided to a deployment engine 3514. The deployment engine 3514 may be responsible for deploying security mechanisms into a network. The deployment engine 3514 may also receive data from deployed security mechanisms (not illustrated). This data may provide information about a network abnormality, which can inform the deployment generator 3514 where to place security mechanisms, and/or how to configure the security mechanisms to be more attractive to the threat that may be posed by the network abnormality. The deployment engine 3522 may provide this and other data, such as the deployment strategy 3512, to a validation engine 3522.

The validation engine 3522 can analyze the data from deployed security mechanisms to determine whether the network is threatened, or is merely experiencing unusual but allowed activity. The validation engine 3522 may provide feedback to the deployment generator 3510 to dynamically adjust the deployment strategy 3512. Upon determining that a network abnormality is a threat or attack, the validation engine 3522 may produce a confirmed attack pattern 3526. The confirmed attack pattern 3526 may describe a pattern of network behavior that has now has been identified as a threat or attack.

An abnormal pattern of behavior seen in a network may be confirmed as an attack pattern by using security mechanisms selected and deployed to attract the attention of the actor or entity that is causing the abnormal network activity. For example, the security mechanisms can appear to be legitimate network resources or data, but in reality are not, and thus are not expected to be accessed by a user or entity that is using the network legitimately. Some accesses to security mechanisms are routing or incidental. For example, the security mechanisms may receive broadcast network packets, such as requests for address information. These types of accesses are routine and are generally expected, thus are do not trigger alerts from the security mechanisms. Access other than these routine and expected accesses, however, may indicate a threat.

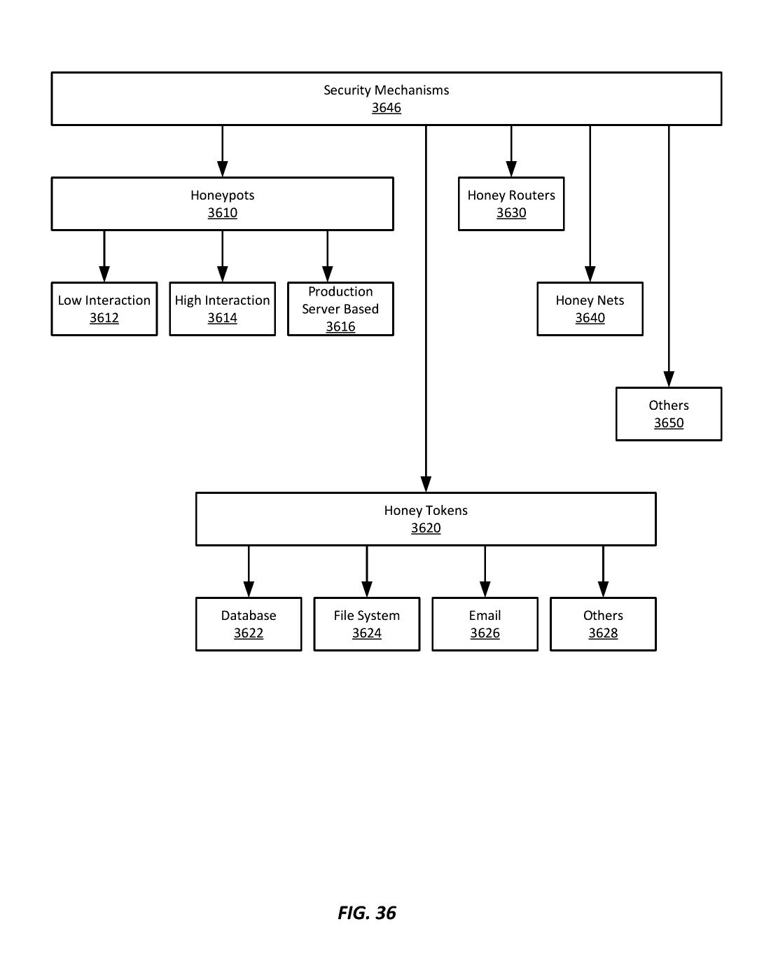

FIG. 36 illustrates examples of security mechanisms 3646 that may be deployed into a network to entrap a potential threat. The security mechanisms 3646 described here may generally be described as deception-based systems. Other security mechanisms, not described here, may also be used to entrap threats to a network.

A first group of security mechanisms 3646 are “honeypots” 3610 or deceptive systems. Some honeypots 3610 may be low interaction 3612. Low interaction honeypots 3610 include network services or processes, such as processes run to provide email, file transfer protocol (FTP), webservers, and so on. Low interaction 3612 honeypots may also include software deployed around a normal network resource that may mask and/or monitor the resource. Other honeypots 3610 may be high interaction 3614. High interaction 3614 honeypots include a full server system or systems. These full server systems may be integrated into a network, but are generally not part of the regular operation of the network. Another group of honeypots 3610 include production server-based 3616 honeypots. Production server-based 3616 honeypots include servers that are part of the regular operation of a network, but that are taken over to be a trap.

A second group of security mechanisms are “honey tokens” 3620 or deceptive data. Honey tokens 3620 may be placed in a network to resemble real data. Types of honey tokens 3620 include databases 3622, file systems 3624, email 3626, and other data 3628, such as files that contain or appear to contain images, social security numbers, health records, intellectual property or trade secrets, or other potentially confidential and non-public information. In some cases, honey tokens 3620 may be pre-generated. In other cases, honey tokens 3620 may be dynamically generated. In some cases, signatures or beacons may be embedded into honey tokens 3620. Signatures may be used to identify a honey token 3620 after it has been extracted from the network. Beacons may send signals a designated listener, or may announce themselves when activated, or may leave markers as a file is moved across a network.

Additional security mechanisms include honey routers 3630, honey nets 3640, and others 3650. Honey routers 3630 are false routers placed into a network. Honey nets 3640 are false networks or sub-networks (subnets) attached to a network.

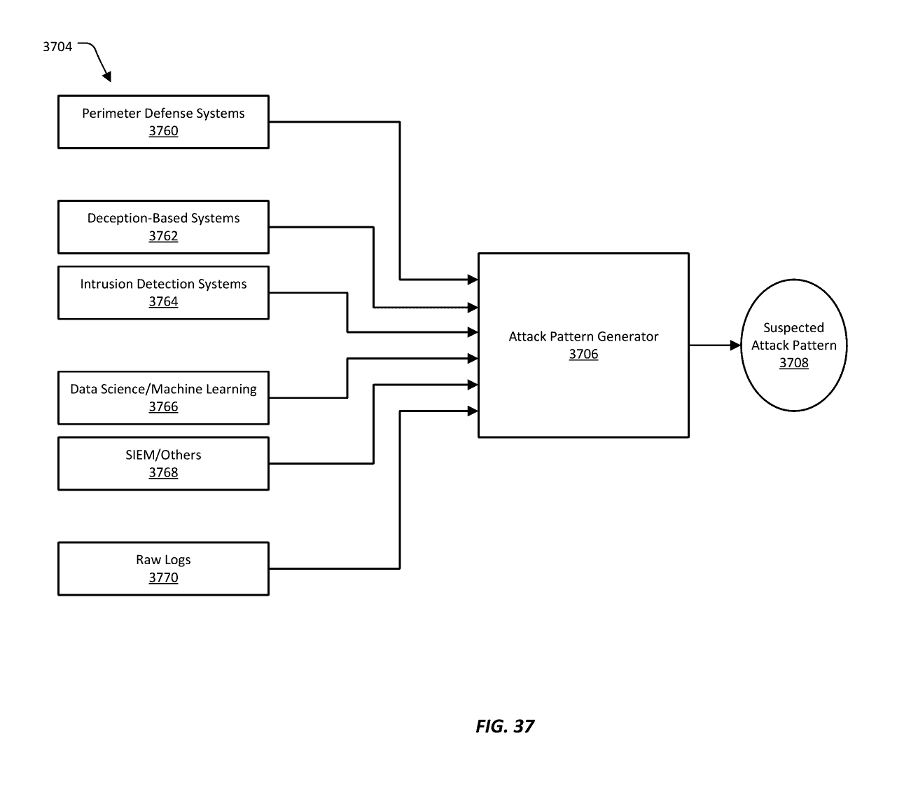

Identifying a pattern of behavior that may be a threat begins by analyzing network data from many points in a network that is being monitored. FIG. 37 illustrates examples of various data sources 3704 that may provide data that is collected by a dynamic threat detection system. These data sources 3704 may include network and client devices that are part of the network, as well as sources outside of the network. The data sources 3704 may also include be hardware or software or combined hardware and software systems configured specifically for monitoring the network, collecting data from the network, and/or analyzing network activity. Examples of systems for monitoring a network include network security tools. The data provided by the data sources 3704 may be collected from many points in an enterprise, hybrid, or cloud network and stored locally or in the cloud. Alternatively or additionally, the data provided by the data sources 3704 may be provided outside of the network. The data may further be updated continuously and/or dynamically.

The data may be provided to an attack pattern generator 3706. The attack pattern generator 3706 may analyze the data, and, upon determining that a network abnormality may be a threat, produce a suspected attack pattern 3708. The suspected attack pattern 3708 may describe the activity that may be an attack.

A first example of data sources 3704 are perimeter defense systems 3760. Perimeter defense systems 3760 include hardware and/or software systems that monitor points of entry into a network. Examples of perimeter defense systems 3760 include firewalls, authentication servers, blocked ports, and port monitors, among others. Perimeter defenses systems 3760 may raise an alert when an unauthorized access is detected.

Another example of data sources 3704 are deception-based systems 3762. Deception-based systems 3762 include “honeypots” or similar emulated systems intended to be attractive to a network threat. Some deception-based systems 3762 may be statically configured as part of a network. These deception-based systems 3762 may raise an alert when anyone, or anyone who is not expected (e.g., network administrators may be listed as expected) accesses a deception-based system 3762. Some deception-based systems 3762 may be analytic, and may be configured to analyze activity around them or that affect them. These deception-based systems 3762 may raise alerts when any suspicious activity is seen.

Another example of data sources 3704 are intrusion detection systems 3764. An intrusion detection system 3764 is a device or software application that monitors the network for malicious activities or network policy violations. Some intrusion detection systems 3764 may be configured to watch for activity originating outside of a network. Other intrusion detection systems 3764 may be configured to watch for activity inside of a network; that is, by users authorized to use the network. In some cases, an intrusion detection system 3764 may monitor and analyze data in real time, while in other cases an intrusion detection system 3764 may operate on stored data. Intrusion detection systems 3764 may record observed events and produce reports. They may also raise an alert when they determine that an event may be a threat. In some cases, intrusion detection systems 3764 may be configured to respond to threat and possibly attempt to prevent the threat from succeeding.

Another example of data sources 3704 are data science and machine learning engines 3766. Data science can describe processes for extracting knowledge or insight from large volumes of structure and/or unstructured data. Machine learning may describe software processes configured to learn without being explicitly programmed. Machine learning processes may be designed to teach themselves and change when exposed to new data. Machine learning is related to data mining, in that both search through data to look for patterns. Machine learning differs from data mining in that, instead of extracting data from human comprehension, a machine learning system uses the data to improve its own understanding. Data science and machine learning may be implemented in engines or processes executing on servers in a network. Data science and/or machine learning algorithms may be public or proprietary.

Another example of data sources 3704 are Security Information and Event Management (SIEM) 3768 and similar systems. SIEM describes systems for security information management and security event management. SIEM may be provided as a software product, an appliance, a managed service, or a combination of these systems. Security information management may include long term storage, analysis, and reporting of data logged by a network. Security event management may include real-time monitoring of a network, correlation of events, notifications, and views into the data produced from these activities. SIEM may describe products capable of gathering, analyzing and presenting information from network and security devices; applications for identity and access management; vulnerability management and policy compliance tools; operating system, database and application logs; and external threat data. SIEM products attempt to monitor and help manage user and service privileges, directory services and other system configuration changes; as well as providing log auditing and review and incident response.

An additional example of data sources 3704 are raw logs 3770. Network and client devices typically record and store, to a log file, activity the network devices experience in the normal course of operation. For example, these log files may contain a record of users who have logged into a system and when, commands executed on a system, files accessed on a system, applications executed, errors experienced, traffic patterns, and so on. This data may be stored in text files or binary files, and may be encrypted. Data sources 3704 may further include intelligence derived from analyzing raw logs 3770 (not shown).

Data sources 3704 may still further include security information from active directories outside of the network (not shown). For example, data sources 3704 may include threat feeds received from other compromised networks.

A variety of data sources 3704 may be provided to the deployment generator 3710, so that the deployment generator 3710 may have a comprehensive view of activity in a network. A comprehensive view, and a large amount of data, may best enable the deployment generator 3710 to develop an effective deployment strategy 3716.

In various implementations, attack pattern generator can use data science techniques to analyze network data, such as the data from the various data sources discussed above. FIG. 38 illustrates an example of an attack pattern generator 3806 that uses data science techniques to analyze network data 3804 and determine patterns of network behavior in the network data 3804. The attack pattern generator 3806 may employ one or more data science engines to analyze network data 3804. In some implementations, the attack pattern generator 3806 can also access or receive data from an attack pattern database 3805. The attack pattern generator 3806 may also employ one or more data science techniques to develop an attack pattern 3808 from patterns of network behavior. These data science engines may include a clustering engine 3807a, a statistical analysis engine 3807b, a data mining engine 3807c, a pattern matching engine 3807, and/or a correlation analysis engine 3807e.

The clustering engine 3807a may use clustering techniques to categorize patterns of network behavior according to similarity. For example, when network behavior affects a particular group of network systems and/or deception mechanism, clustering engine 3807a can identify features network systems or deception mechanisms in the group. Features can include, for example, the type of the network system or being emulated by the deception mechanism (e.g., desktop computer laptop computer, tablet computer, etc.), identification information associated with the network system or deception mechanism (e.g., an IP address, a MAC address, a computer name, etc.), a hardware configuration of the network system or being emulated by the deception mechanism (e.g., a number of processors, a amount of memory, a number of storage devices, the type and capabilities of attached peripheral devices, etc.), and/or a software configuration of the network system or being emulated by the deception mechanism (e.g., an operating system type and/or version, operating system patches, installed drivers, types and identities of user applications, etc.). The clustering engine 3807a can further use clustering techniques to identify similar features among the group of affected network systems and/or deception mechanisms. For example, the clustering engine 3807a can determine that each affected network system and/or deception mechanism have the same operating type and version. Similarities such as these can be used as part of developing an attack pattern 3808.

The statistical analysis engine 3807b can compare generate a digital signature based patterns of network behavior that appear to be related to a threat, and can compare this digital signature to digital signatures for known attack patterns. For example, the statistical analysis engine 3807b can generate a digital signature from log file data, files, emails, network packets, processors, and/or possible source addresses associated with a threat. The statistical analysis engine 3807b can be provided with digital signatures for known attack patterns from the attack pattern database 3805. In various implementations, the statistical analysis engine 3807b can find full and partial matches between the generated digital signature and signatures for known attack patterns. The matching known attack patterns can provide data to be used in the attack pattern 3808 being developed by the attack pattern generator 3806.

The scoring engine 3807c can use a scoring model to prioritize patterns of network behavior that could be threats. For example, the scoring model may assign values to the hardware, software, and/or data assets in the network 3804. Using this model, the scoring engine 3807c can weigh network data 3804 against the values of the assets, and determine a likelihood that a threat has affected more valuable assets. As another example, the scoring model may model the cost to the network from a particular threat. This model may be a function of the value of the hardware, software, and/or data assets in the network. In this example, network data 3804 affecting high-value assets may be given higher priority than network data 3804 affecting lower-value assets. The high-priority network data 3804 may be included in the attack pattern 3808.

The predictive analytics engine 3807d can use patterns of network behavior in the network data 3804 to determine the direction of an threat, and/or the next possible threat type and/or location in the network that may be affected by the next threat. Predictive analytics is a branch of data mining concerned with the prediction of future probabilities and trends. The predictive analytics engine 3807d can use one or more predictor(s), such as the network data 3804, which may be measured and combined into a predictive model to predict future behavior. Once the predictive model is created, the predictive analytics engine 3807d may validate or revise the predictive model as additional data becomes available. For example, if database servers in a subnet (SN1) have been scanned by a user, the previous patterns of the scans by the user may be used by the predictive analytics engine 3807d to determine that database servers in another subnet (SN2) will be accessed next.

The correlation analysis engine 3807e can patterns of network behavior patterns within the network data 3804 and/or to known attack patterns in the attack pattern database 3805. For each comparison of network behavior to another data pattern (e.g., from the network data or from the attack pattern data base 3805), the correlation analysis engine 3807e can assigns a correlation coefficient to each particular comparison. The correlation coefficient is a measure of linear association between the network behavior and the other data pattern. For example, values of the correlation coefficient can be between −1 and +1, inclusive. In this example, a correlation coefficient value of −1 indicates that the two patterns are perfectly related in a negative linear sense (e.g., they are exact opposites), and a correlation coefficient value of +1 indicates that the two patterns are perfectly related in a positive linear sense (e.g., they are exactly the same). A correlation coefficient value of 0 indicates that there is no linear relationship between the two patterns.

The other patterns within the network data 3404 may each be assigned a correlation coefficient and may be sorted by their correlation coefficients. A threshold may be selected (e.g., absolute value of the correlation coefficient is greater than 0.9), such that correlation coefficients that are above the threshold indicate patterns of network behavior that may be associated with a threat, and should be added to the attack pattern 3808.

In various implementations, attack patterns from an attack pattern generator can be provided to a deployment generator, to be used to adjust the deployment of security mechanisms in a network. In various implementations, the deployment generator can use data science techniques to analyze the attack patterns and produce a deployment strategy. FIG. 39 illustrates an example of a deployment generator 3910 that uses data science techniques to determine a selection of security mechanisms to deploy, and placement of the security mechanisms in a network. The deployment generator 3910 may employ one or more data science engines to determine a deployment strategy 3912. The deployment generator 3910 may also employ one or more data science engines to choose between alternate deployment strategies or determine the sequence of security mechanisms to deploy. These data science engines may include a data mining engine 3911a, a machine learning engine 3911b, a scoring engine 3911c, and/or a game theory engine 3911d.

The data mining engine 3911a can use the attack pattern 3908 to predict whether a particular attack source would respond to a particular security mechanism and/or a particular location for a security mechanism. For example, a data mining database may be built of previous or historical network threats, previous or historical interactions with security mechanisms by network threats, and source information (e.g., IP address of the attack source, etc.) for previous threats. The data mining database may be used to predict whether a particular threat or threat class would respond to a particular type and/or location of security mechanism.

The machine learning engine 3911b can determine the vulnerabilities in the network 3402. These vulnerabilities can be used to specify locations to deploy security mechanisms. For example, the machine learning engine 3911b can implement clustering techniques to categorize or group data according to similarity. These clustering techniques can be used to categorize the type of servers being attacked or to model the changes made to the attacked servers, among other things. For example, the biggest attack cluster (i.e., the cluster having the most amount of attack data points) around a particular server may indicate that that server is particularly vulnerable.

The scoring engine 3911c can use the attack pattern 3908 to produce a deployment strategy 3912. For example, the network data 3404 may be combined with the previous attack pattern data in the attack pattern database 3805 to form a scoring database. The scoring engine 3911c can using the scoring data base to, for example, identify locations on the network to deploy the security mechanisms, the type of security mechanisms to deploy, the number of security mechanisms to deploy, and so on.

In one example, locations on the network 3402 to deploy the security mechanisms may be identified. In this example, each of the various locations on the network 3402, identified in the scoring database, may be assigned a score value between 0 and 1 representing the probability that a threat will affect that location. The score value may be assigned using a predictive model built by data mining. Predictive modeling is a process used in predictive analytics to create a statistical model of future behavior using input data, such as past behavior. Nearly any regression model can be used for prediction purposes. Once the score values are assigned, the locations may then be sorted by the score value, and a threshold may be selected (e.g., highest score value, top ten highest score values, values greater than 0.75, etc.). Security mechanisms may then be deployed at locations within the threshold.

In another example, types of security mechanisms to deploy on the network 3402 may be identified. In this example, each of the various types of security mechanisms, identified in the scoring database, may be assigned a score value between 0 and 1 representing the probability that a threat will affect that type of security mechanism. The score value may be assigned using a predictive model built by data mining. The types of security mechanisms may then be sorted by the score value, and a threshold may be selected (e.g., highest score value, top ten highest score values, values greater than 0.75, etc.). The types of security mechanisms within the threshold may then be deployed.

In another example, the number of security mechanisms to deploy on the network may be identified. In this example, various numbers of security mechanisms, identified in the scoring database, may be assigned a score value between 0 and 1 representing the probability of detecting a threat with that number of security mechanisms. The score value may be assigned using a predictive model built by data mining. The numbers of security mechanisms may then be sorted by the score value, and a threshold may be selected (e.g., highest score value). The number of security mechanisms having the highest score value may then be deployed.

The scoring model may be revised periodically based on new or updated data within the scoring database (e.g., new collected data and/or new attack pattern data) and based on the effectiveness of previously implemented deployment strategies. For example, the predictive model assigning score values may be changed, and/or the threshold may be changed.

The game theory engine 3911d can use game theory (or similar techniques) to choose between alternate security mechanisms or alternate deployment strategies, and/or to determine the sequence of security mechanisms to be deployed in a deployment strategy. For example, the game theory engine 3911d can develop a decision tree, with each level representing a move by a threat. For example, based on a threat's response to a deployed security mechanism, the next security mechanism may be determined according to the tree by the game theory engine 3911d, and be deployed in advance of movement by the threat. The newly deployed security mechanism should serve as a lure and diversion to the threat.

The deployment generator 3910 can use the outputs of these engines 3911a-3911d to adjust the deployment strategy 3912 to be implemented.

A deployment engine (not shown) may further employ data science techniques to perform its described functions. For example, the deployment engine may follow the decision tree provided by the game theory engine 3911d of the deployment generator 3910 in determining the sequence of security mechanisms to be deployed.

In an additional or alternative embodiment, the deployment engine (not shown) may implement machine learning techniques. In this embodiment, the deployment generator 3910 may determine multiple deployment strategies for confirming a single attack pattern 3908. The deployment engine may use machine learning techniques to dynamically determine which of the multiple deployment strategies is best for a given action.

As an example, an attack pattern 3908 may consist of attacks on databases. If the suspected attacker accessed a subnet with SQL servers deployed, then a deployment strategy 3912 of SQL server deceptions may be deployed. If the suspected attacker accesses a subnet with more Oracle databases deployed, then a deployment strategy 3912 of deploying Oracle database deceptions may be followed. In a subnet with no databases, a deployment strategy 3912 to deploy both database deception types may be implemented.

Specific details were given in the preceding description to provide a thorough understanding of various implementations of systems and components for network threat detection and analysis. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for network threat detection and analysis.

What is claimed is:

1. A method, comprising:
collecting, by a network security device on a network, network data from the network;
determining a selection of one or more deception mechanisms using the network data, wherein a deception mechanism represents a resource available on the network, and wherein a deception mechanism is separate from normal operation of the network;
determining, using the network data, one or more locations to deploy the one or more deception mechanisms, wherein the locations include locations within the network;
identifying a potential threat to the network, wherein the potential threat is identified using a deception mechanism from the one or more deception mechanisms;
determining an additional deception mechanism using information provided by the deception mechanism; and
using the additional deception mechanism to facilitate an action on the network.

2. The method of claim 1, wherein network data includes information about network devices in the network, and wherein the information includes an amount of network devices, types of network devices, identification information for a network device, a hardware configuration for a network device, or a software configuration for a network device.

3. The method of claim 1, wherein network data includes information about data included in the network, and wherein the information includes a type of the data, a location in the network of the data, an access privilege of the data, or a value of the data.

4. The method of claim 1, wherein network data includes information about a structure of the network, wherein the structure of the network includes one or more of a location of network infrastructure devices, a configuration of one or more subnets, or a configuration of one or more virtual local area networks.

5. The method of claim 1, wherein network data includes information about network traffic in the network.

6. The method of claim 1, wherein network data includes network security information, and wherein the network security information includes a current security state of the network.

7. The method of claim 1, wherein identifying the potential threat includes:
determining that the deception mechanism has been accessed.

8. The method of claim 1, wherein identifying the potential threat includes:
comparing data received from the one or more deception mechanisms to a known network threat.

9. The method of claim 1, wherein the action includes analyzing the potential threat, and wherein analyzing the potential threat includes allowing the potential threat to proceed.

10. The method of claim 1, wherein the action includes building a profile of the potential threat.

11. The method of claim 1, wherein the action includes determining a new deception mechanism using information provided by the additional deception mechanism.

12. A network device, comprising:
one or more processors; and
a non-transitory computer-readable medium including instructions that, when executed by the one or more processors, cause the one or more processors to perform operations including:
collecting network data from the network;
determining a selection of one or more deception mechanisms using the network data, wherein a deception mechanism represents a resource available on the network, and wherein a deception mechanism is separate from normal operation of the network;
determining, using the network data, one or more locations to deploy the one or more deception mechanisms, wherein the locations include locations within the network;
identifying a potential threat to the network, wherein the potential threat is identified using a deception mechanism from the one or more deception mechanisms;
determining an additional deception mechanism using information provided by the deception mechanism; and
using the additional deception mechanism to facilitate an action on the network.

13. The network device of claim 12, wherein the instructions for identifying the potential threat include instructions that, when executed by the one or more processors, cause the one or more processors to perform operations including:
determining that the deception mechanism has been accessed.

14. The network device of claim 12, wherein the action includes analyzing the potential threat, and wherein analyzing the potential threat includes allowing the potential threat to proceed.

15. The network device of claim 12, wherein the action includes building a profile of the potential threat.

16. The network device of claim 12, wherein the action includes determining a new deception mechanism using information provided by the additional deception mechanism.

17. A computer-program product tangibly embodied in a non-transitory machine-readable storage medium, including instructions that, when executed by one or more processors, cause the one or more processors to:
collect network data from the network;
determine a selection of one or more deception mechanisms using the network data, wherein a deception mechanism represents a resource available on the network, and wherein a deception mechanism is separate from normal operation of the network;
determine, using the network data, one or more locations to deploy the one or more deception mechanisms, wherein the locations include locations within the network;
identify a potential threat to the network, wherein the potential threat is identified using a deception mechanism from the one or more deception mechanisms;
determine an additional deception mechanism using information provided by the deception mechanism; and
use the additional deception mechanism to facilitate an action on the network.

18. The computer-program product of claim 17, wherein the instructions for identifying the potential threat include instructions that, when executed by the one or more processors, cause the one or more processors to:
determine that the deception mechanism has been accessed.

19. The computer-program product of claim 17, wherein the action includes analyzing the potential threat, and wherein analyzing the potential threat includes allowing the potential threat to proceed.

20. The computer-program product of claim 17, wherein the action includes building a profile of the potential threat.
